(19) United States
(12) Patent Application Publication
(10) Pub. No.: US 2022/0412603 A1
(43) Pub. Date: Dec. 29, 2022

(54) AIR CONDITIONER

(71) Applicant: LG ELECTRONICS INC., Seoul (KR)

(72) Inventors: Changkyum KIM, Seoul (KR); Seokho CHOl, Seoul (KR); Hyungho PARK, Seoul (KR); Hoojin KIM, Seoul (KR); Jieun CHOI, Seoul (KR); Changhoon LEE, Seoul (KR); Jaehyuk JUNG, Seoul (KR); Juhyun KIM, Seoul (KR); Yongmin KIM, Seoul (KR); Chiyoung CHOI, Seoul (KR)

(21) Appl. No.: 17/779,443

(22) PCT Filed: Nov. 27, 2020
(86) PCT No.: PCT/KR2020/017112

§ 371 Date: May 24, 2022

(30) Foreign Application Priority Data
Nov. 28, 2019 (KR) 10-2019-0155450
Jun. 2, 2020 (KR) 10-2020-0066278
Jun. 2, 2020 (KR) 10-2020-0066279
Jun. 2, 2020 (KR) 10-2020-0066280
Jun. 15, 2020 (KR) 10-2020-0072336
Sep. 23, 2020 (KR) 10-2020-0123153

(51) Int. Cl. F24F 13/20; F24H 3/10; F04D 25/08; F04D 29/28; F04D 29/70

(52) U.S. Cl. CPC F24F 13/20; F24H 3/102; F04D 25/08; F04D 29/281; F04D 29/703; F24F 2221/28; F24F 2221/34

(57) ABSTRACT

An air conditioner of the present disclosure includes a base case configured to include a suction port through which air is sucked and accommodate a filter therein, a tower case configured to be disposed above the base case and to include a discharge port through which the air sucked from the suction port is discharged, and a heater configured to be disposed inside the tower case to heat the air.

### TECHNICAL FIELD

The present disclosure relates to an air conditioner including a heater for heating air discharged through the Coanda effect.

### BACKGROUND ART

In general, a blower is a mechanical device which drives a fan to cause a flow of the air. In the related art, a blower has a fan which rotates about a rotation axis, and a motor rotates the fan to generate wind.

A fan of the related art using an axial fan has an advantage of providing wind in a wide range, but there is a problem in that the fan cannot provide wind intensively in a narrow region.

Japanese Patent No. 2019-107643 discloses a fan which provides wind to a user using the Coanda effect.

In a case of a fan of the related art, a technique for controlling a path of air discharged through the Coanda effect or changing a shape of the discharged air is not disclosed. Therefore, in a case of a fan of the related art, there is a problem in that a flow velocity of the discharged air is very slow, a direction of the discharged air cannot be changed, and it is difficult for the discharged air to reach a distant user.

In addition, Korean Patent No. 2003-0053400 discloses a plate-shaped heat-radiating plate structure which transfers heat by mechanical contact with tight contact and welding between a straight sheath heater and a square radiating fin. The prior art has the plate-like structure, and thus, it takes up a lot of space to be disposed inside a case, and there is a limit to shape conversion.

In addition, the straight sheath heater of the related art can perform heat exchange in only one direction and use a welding method only on a local surface. Therefore, there is a reliability (lifetime) problem due to external impact, heat, or oxidation.

### DISCLOSURE OF INVENTION

### Technical Problem

The present disclosure provides a fan device for a conditioner capable of a temperature of air discharged through a discharge port to a temperature desired by a user.

The present disclosure also provides an air conditioner capable of guiding flowing air toward the discharge port while reducing a space occupied by a heater heating discharged air.

The present disclosure also provides an air conditioner in which a heater for heating air has a resistance to heat, shock, and oxidation.

The present disclosure also provides an air conditioner capable of discharging air discharged through a discharge port in various directions and in various forms.

The present disclosure also provides an air conditioner which can tightly couple a cover and a main body without gap, and can easily separate the main body and the cover from each other by applying an external force to a cover separation unit when separating the cover and the main body from each other.

### Solution to Problem

The present disclosure includes a plurality of heat-radiating pins connected to two heat-radiating tube.

Specifically, according to the present disclosure, there is provided an air conditioner including: a base case configured to include a suction port through which air is sucked and accommodate a filter therein; a tower case configured to be disposed above the base case and to include a discharge port through which the air sucked from the suction port is discharged; and a heater configured to be disposed inside the tower case to heat the air, in which the heater includes a heat-radiating tube configured to include a first heat-radiating tube and a second heat-radiating tube disposed to be parallel to each other, and a third heat-radiating tube configured to connect one end of the first heat-radiating tube and one end of the second heat-radiating tube to each other, and a plurality of heat-radiating pins configured to be coupled to the first heat-radiating tube and the second heat-radiating tube, and the first heat-radiating tube extends in a first direction, and the heat-radiating pin forms a heat-radiating surface intersecting the first direction.

The third heat-radiating tube may have a curvature.

The heat-radiating pin may include a first tube hole into which the first heat-radiating tube is inserted, and a second tube hole into which the second heat-radiating tube is inserted.

The heat-radiating surface of the heat-radiating pin may be a widest surface of the heat-radiating pin.

The heat-radiating surface of the heat-radiating pin may define a surface perpendicular to the first direction.

The heat-radiating pins are arranged to be spaced apart from each other in the first direction.

A pitch of the plurality of heat-radiating pins may be smaller than a separation distance between the first heat-radiating tube and the second heat-radiating tube.

The discharge port may extend in the first direction, and the heat-radiating pin may change a direction of the sucked air to guide the air to the discharge port.

A material of the heat-radiating pin and A material of the heat-radiating tube may be different from each other.

The heater may further include a top heat-radiating member coupled to the third heat-radiating tube.

The top heat-radiating member may include a connector into which at least a portion of the third heat-radiating tube is inserted, and a plurality of top heat-radiating pins configured to be connected to the connector and to have a large surface area than that of the connector.

The air conditioner may further include a protective cover configured to prevent a heater from coming into contact with an outside and causes air to flow to the heater.

The protective cover may be formed to be spaced from the heat-radiating pin to surround at least the heat-radiating pin, and include a cover inlet into which air flows and a cover discharge port through which air inside the cover is discharged.

A line connecting a center of the cover inlet and a center of the cover discharge port to each other may extend in a direction intersecting the first direction.

The protective cover may include a first protective cover which is formed of a heat-resistant material and a second protective cover which is disposed between the first protective cover and the heater and formed of an insulation material.

The heater further may include a fastening plate to which the protective cover is coupled, and the fastening plate may be coupled to the first heat-radiating tube and the second heat-radiating tube.

The fastening plate may be coupled to the tower case.

One end of the heat-radiating pin may be disposed closer to the discharge port than the other end of the heat-radiating pin, and the one end of the heat-radiating pin may be located higher than the other end of the heat-radiating pin.

According to another aspect of the present disclosure, there is provided an air conditioner including: a base case configured to include a suction port through which air is sucked and accommodate a filter therein; a tower case configured to be disposed above the base case and to include a first tower and a second tower which each have an air flow path therein and are formed to be spaced apart from each other; a blowing space configured to be formed between the first tower and a second tower; a first discharge port configured to be formed in the first tower and to discharge the sucked air to the blowing space; a second discharge port configured to be formed in the second tower and to discharge the sucked air to the blowing space; and a heater configured to be disposed inside the tower case and to be disposed adjacent to at least one of the first discharge port and the second discharge port, in which the heater includes a heat-radiating tube configured to include a first heat-radiating tube and a second heat-radiating tube disposed to be parallel to each other, and a third heat-radiating tube configured to connect one end of the first heat-radiating tube and one end of the second heat-radiating tube to each other, and a plurality of heat-radiating pins configured to be coupled to the first heat-radiating tube and the second heat-radiating tube, and the first heat-radiating tube extends in a first direction, and the plurality of heat-radiating pins form a heat-radiating surface intersecting the first direction.

According to still another aspect of the present disclosure, there is provided an air conditioner including: a base case configured to include a suction port through which air is sucked and accommodate a filter therein; a tower case configured to be disposed above the base case and to include a first tower and a second tower which each have an air flow path therein and are formed to be spaced apart from each other; a blowing space configured to be formed between the first tower and a second tower; a first discharge port configured to be formed in the first tower and to discharge the sucked air to the blowing space; a second discharge port configured to be formed in the second tower and to discharge the sucked air to the blowing space; and a heater configured to be disposed inside the tower case and to be disposed adjacent to at least one of the first discharge port and the second discharge port, in which the heater includes a heat-radiating tube configured to include a first heat-radiating tube and a second heat-radiating tube disposed to be parallel to each other, and a third heat-radiating tube configured to connect one end of the first heat-radiating tube and one end of the second heat-radiating tube to each other, and a plurality of heat-radiating pins configured to be coupled to the first heat-radiating tube and the second heat-radiating tube, and the first discharge port and the second discharge port extend in a first direction, and the heat-radiating pin has an inclination smaller than 45 with respect to a reference surface perpendicular to the first direction.

### Advantageous Effects of Invention

The air conditioner according to the present disclosure has one or more of the following effects.

According to the present disclosure, by using the heater, it is possible to control the temperature of the air discharged through the discharge port to the desired temperature by the user and guide the air flowing in the case to the discharge port through the heat-radiating pin, and thus, a separate guide can be omitted within the case.

In addition, according to the present disclosure, since the plurality of heat-radiating pins are connected to two heat-radiating tubes, the heat-radiating pins are firmly fixed, and there is a strong resistance against external shock, heat and oxidation.

In addition, according to the present disclosure, since the plurality of heat-radiating pins are arranged in the length direction of the heat-radiating tube, the space occupied by the heater is small, and the heat transfer between the heat-radiating tube and the heat-radiating pin is excellent.

In addition, according to the present disclosure, it is possible to tightly couple the cover and the main body to each other without a gap, aesthetics of the user can be improved in a state where the cover and the main body are coupled to each other. Moreover, when the cover and the main body are separated from each other, an external force is applied to the cover separation unit so that the main body and the cover can be easily separated from each other.

In addition, according to the present disclosure, the air discharged from the first tower and the air discharged from the second tower induce the Coanda effect, and then, are joined to each other and discharged. Therefore, it is possible to increase the straightness and the reach distance of the discharged air.

By disposing the heat-radiating pin between the first and second heat-radiating plates, the heat-radiating pin is prevented from being exposed to the outside, and accordingly, a highly reliable heater assembly which is not deformed even by an external shock can be provided.

In addition, since the heat-radiating pin is constituted by a wavy fin forming a corrugated portion, it is easy to manufacture the heat-radiating pin and increase heat dissipation performance thereof.

In addition, the first and second heat-radiating plates and the heater are coupled to each other by using a fastening device including a fastening member and a spring. Accordingly, it is possible to increase a coupling force of a heater assembly and minimize a fatigue life of a component.

In addition, since the fastening device is configured to be detachable through the separation of the fastening member, replacement or repair of components constituting the heater assembly may be facilitated.

In addition, by providing an adhesive portion between the heater and the first heat-radiating plate, it is possible to eliminate a gap between the heater and the first heat-radiating plate and improve the heat conduction.

Effects of the present disclosure are not limited to the effects mentioned above, and other effects not mentioned will be clearly understood by those skilled in the art from descriptions of claims.

### BRIEF DESCRIPTION OF DRAWINGS

FIG. 1 is a perspective view of an air conditioner according to an embodiment of the present disclosure.

FIG. 2 is an exemplary operation view of FIG. 1.

FIG. 3 is a front view of FIG. 2.

FIG. 4 is a plan view of FIG. 3.

FIG. 5 is a right cross-sectional view of FIG. 2.

FIG. 6A is a front cross-sectional view of FIG. 2.

FIG. 6B is a view illustrating a heater and a discharge port of FIG. 6A.

FIG. 6C is a plan view of a heat-radiating pin of the heater illustrated in FIG. 6B.

FIG. 6D is a perspective view illustrating a state where a protective cover is coupled to the heater of the present disclosure.

FIG. 6E is an exploded perspective view of FIG. 6D.

FIG. 6F is a perspective view according to another embodiment of the present disclosure.

FIG. 7 is a partially exploded perspective view illustrating an inside of a second tower of FIG. 2.

FIG. 8 is a right cross-sectional view of FIG. 7.

FIG. 9 is a perspective view when the air conditioner of FIG. 1 is viewed in another direction.

FIG. 10 is a perspective view illustrating a state where a filter is separated from a case of FIG. 9.

FIG. 11 is a cross-section perspective view taken along line A-A′ of FIG. 9.

FIG. 12 is a view illustrating an operation state of FIG. 11.

FIG. 13 is a view illustrating an operation of FIG. 9 in a state where the cover and the case are coupled to each other.

FIG. 14 is a plan cross-sectional view taken along line IX-IX of FIG. 3.

FIG. 15 is a bottom cross-sectional view taken along line IX-IX of FIG. 3.

FIG. 16 is a perspective view illustrating a first state of an airflow converter.

FIG. 17 is a perspective view illustrating a second state of the airflow converter.

FIG. 18 is an exploded perspective view of the airflow converter.

FIG. 19 is a front view illustrating a state where a space board is removed from the airflow converter.

FIG. 20 is a front view illustrating a state where the space board is installed in FIG. 19.

FIG. 21 is a side cross-sectional view of the airflow converter.

FIG. 22 is a view illustrating a rear surface of the space board of the airflow converter.

FIG. 23 is a plan cross-sectional view schematically illustrating a flow direction of air according to a position of the space board.

FIG. 24 is a front view of FIG. 2 according to another embodiment of the present disclosure.

FIG. 25 is a partially exploded perspective view illustrating an inside of a second tower of FIG. 24.

FIG. 26 is a right cross-sectional view of FIG. 25.

FIG. 27 is an exemplary view illustrating a horizontal airflow of the air conditioner according to the present disclosure.

FIG. 28 is an exemplary view illustrating an ascending airflow of the air conditioner according to the present disclosure.

FIG. 29 is a perspective view illustrating a fan of the present disclosure.

FIG. 30 is an enlarged view illustrating a portion of a leading edge of FIG. 29.

FIG. 31 is a cross-sectional view taken along line C1-C1′ of FIG. 30.

FIG. 32 is a view illustrating a flow of air passing through a notch portion of the leading edge in FIG. 29.

FIG. 33 is an experimental data comparing sharpness according to an air volume in an example and a comparative example.

FIG. 34 is an experimental data comparing noises according to an air volume in an example and a comparative example.

FIG. 35 is a plan cross-sectional view illustrating an airflow converter according to another embodiment of the present disclosure.

FIG. 36 is a perspective view of the airflow converter illustrated in FIG. 35.

FIG. 37 is a perspective view when the airflow converter is viewed from a side opposite to FIG. 36.

FIG. 38 is a plan view of FIG. 36.

FIG. 39 is a bottom view of FIG. 36.

FIG. 40 is a front cross-sectional view for explaining another air guide according to still another embodiment of the present disclosure.

FIG. 41 is a view for explaining the air guide of FIG. 40.

FIG. 42 is a right cross-sectional view of an air conditioner according to another embodiment of the present disclosure.

FIG. 43 is a perspective view of a heat assembly according to an embodiment of the present disclosure.

FIG. 44 is an exploded perspective view of the heat assembly according to the embodiment of the present disclosure.

FIG. 45 is a cross-sectional view taken along line 45-45′ of FIG. 43.

FIG. 46 is a front view of the heat assembly according to the embodiment of the present disclosure.

FIG. 47 is a perspective view illustrating a flow of air in the heater assembly according to the embodiment of the present disclosure.

FIG. 48 is a view illustrating a configuration of an air conditioner having the heater assembly according to the embodiment of the present disclosure.

### MODE FOR THE INVENTION

Advantages and features of the present disclosure, and a method of achieving them will be apparent with reference to embodiments described below in detail with the accompanying drawings. However, the present disclosure is not limited to the embodiments disclosed below, but may be implemented in a variety of different forms, and the embodiments are provided only to ensure that the disclosure of the present disclosure is complete, and to fully inform the scope of the invention to those of ordinary skill in the technical field to which the present disclosure belongs, and the present disclosure is only defined by the scope of the claim. The same reference numerals refer to the same components throughout the specification.

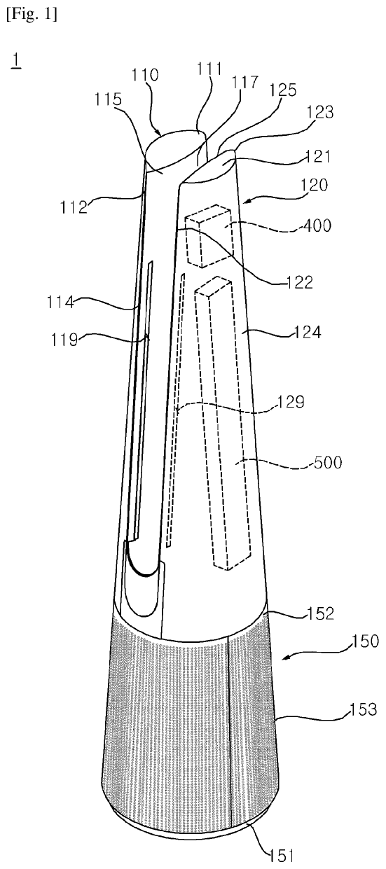

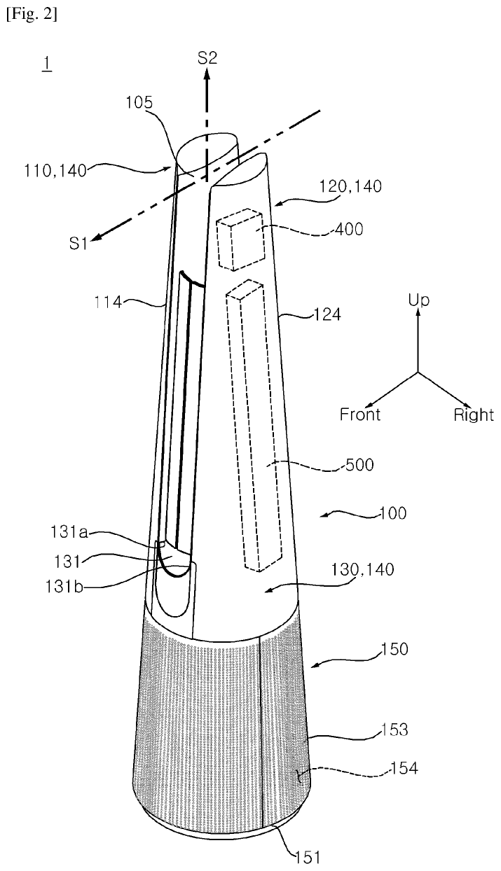

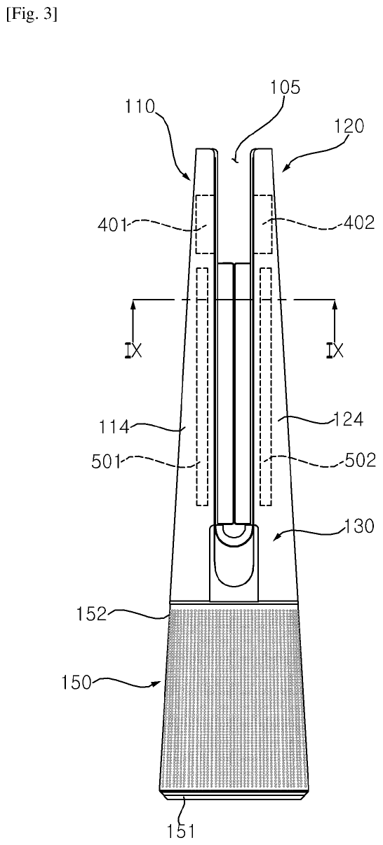

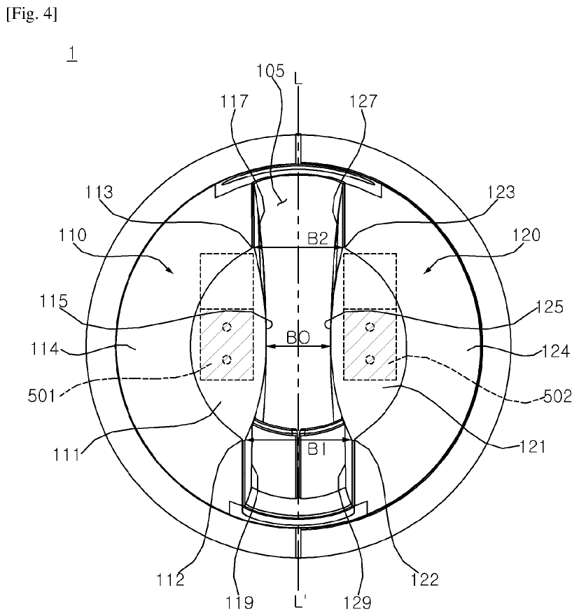

FIG. 1 is a perspective view of an air conditioner according to an embodiment of the present disclosure, FIG. 2 is an exemplary operation view of FIG. 1, FIG. 3 is a front view of FIG. 2, and FIG. 4 is a plan view of FIG. 3.

With reference to FIGS. 1 to 4, an air conditioner 1 according to an embodiment of the present disclosure includes a case 100 providing an appearance. The case 100 includes a base case 150 in which the filter 200 is installed, and a tower case 140 for discharging air through the Coanda effect.

In addition, the tower case 140 includes a first tower 110 and a second tower 120 which are divided and disposed in the form of two columns. In the present embodiment, the first tower 110 is disposed on a left, and the second tower 120 is disposed on a right.

In this specification, an up-down direction is defined as a direction parallel to a direction of a rotation axis of a fan 320. An upper direction (vertical direction) refers to a direction in which the tower case 140 is located in the case 100, and a lower direction refers to a direction in which the base case 150 is located in the case 100.

The first tower 110 and the second tower 120 are spaced apart from each other, and a blowing space 105 is formed between the first tower 110 and the second tower 120.

In the present embodiment, front, rear and upper sides of the blowing space 105 are open, and gaps of upper and lower ends of the blowing space 105 are the same as each other.

The tower case 140 including the first tower, the second tower and the blowing space is formed in a truncated cone shape.

Discharge ports 117 and 127 disposed in the first tower 110 and the second tower 120 respectively discharge air into the blowing space 105. When it is necessary to distinguish the discharge port, the discharge port formed in the first tower 110 is referred to as a first discharge port 117, and the discharge port formed in the second tower 120 is referred to as a second discharge port 127.

The first discharge port and the second discharge port are disposed within a height of the blowing space, and a direction intersecting the blowing space 105 is defined as an air discharge direction.

Since the first tower 110 and the second tower 120 are disposed left and right, the air discharge direction in the present embodiment may be formed in a front-rear direction and an up-down direction.

That is, the air discharging direction intersecting the blowing space 105 includes a first air discharging direction S1 disposed in a horizontal direction and a second air discharging direction S2 disposed in the up-down direction.

Air flowing in the first air discharge direction S1 is referred to as a horizontal airflow, and air flowing in the second air discharge direction S2 is referred to as an ascending airflow.

It should be understood that the horizontal airflow does not mean that the air flows only in the horizontal direction, but that a flow rate of air flowing in the horizontal direction is larger. Likewise, it should be understood that the ascending airflow does not mean that the air flows only upward, but that a flow rate of air flowing upward is larger.

In the present embodiment, an upper end gap and a lower end gap of the blowing space 105 are formed to be the same as each other. Unlike the present embodiment, the upper end gap of the blowing space 105 may be formed narrower or wider than the lower end gap thereof.

By forming a right-left width of the blowing space 105 to be constant, a flow of air flowing in front of the blowing space can be formed more uniformly.

For example, when a width of the upper side and a width of the lower side are different, a flow velocity of the wider side may be formed low, and a deviation of the velocities may occur based on the up-down direction. When the velocity deviation of the air occurs in the up-down direction, an air reaching length may vary.

After the air discharged from the first discharge port and the second discharge port are joined to each other in the blowing space 105, the joined air may flow to the user.

That is, in the present embodiment, discharged air of the first discharge port 117 and discharge air of the second discharge port 127 do not individually flow to the user, but the discharged air of the first discharge port 117 and the discharged air of the second discharge port 127 are joined to each other in the blowing space 105, and then, the joined air is provided to the user.

The blowing space 105 may be used as a space where discharged air is joined to each other and mixed. In addition, air behind the blowing space may also flow into the blowing space by the discharge air discharged to the blowing space 105.

Since the discharged air of the first discharge port 117 and the discharged air of the second discharge port 127 are joined to each other in the blowing space, straightness of the discharged air may be improved. In addition, by joining the discharged air of the first discharge port 117 and the discharged air of the second discharge port 127 to each other in the blowing space, air around the first tower and second tower can also indirectly flow in the air discharge direction.

In the present embodiment, the first air discharge direction S1 is formed from the rear to the front, and the second air discharge direction S2 is formed from the lower side to the upper side.

An upper end 111 of the first tower 110 and an upper end 121 of the second tower 120 are spaced apart from each other for the second air discharge direction S2. That is, the air discharged in the second air discharge direction S2 does not cause interference with the case of the air conditioner 1.

Moreover, for the first air discharge direction S1, a front end 112 of the first tower 110 and a front end 122 of the second tower 120 are spaced apart from each other, and a rear end 113 of the first tower 110 and a rear end 123 of the second tower 120 are also spaced apart from each other.

In each of the first tower 110 and the second tower 120, a surface facing the blowing space 105 is referred to as an inner surface, and a surface not facing the blowing space 105 is referred to as an outer surface.

An outer wall 114 of the first tower 110 and an outer wall 124 of the second tower 120 are disposed in directions opposite to each other, and an inner wall 115 of the first tower 110 and an inner wall 125 of the second tower 120 face each other.

When it is necessary to distinguish the inner walls 115 and 125, the inner surface of the first tower is referred to as a first inner wall 115, and the inner surface of the second tower is referred to as a second inner wall 125.

Similarly, when it is necessary to distinguish the outer walls 114 and 124, the outer surface of the first tower is referred to as a first outer wall 114, and the outer surface of the second tower is referred to as a second outer wall 124.

The first outer wall 114 is formed on an outer side of the first inner wall 115. The first outer wall 114 and the first inner wall 115 form a space through which air flows. The second outer wall 124 is formed on an outer side of the second inner wall 125. The first outer wall 124 and the first inner wall 125 form a space through which air flows.

The first tower 110 and the second tower 120 are formed in a streamlined shape with respect to the flow direction of air.

Specifically, each of the first inner wall 115 and the first outer wall 114 is formed in a streamlined shape in the front-rear direction, and each of the second inner wall 125 and the second outer wall 124 is formed in a streamlined shape in the front-rear direction.

The first discharge port 117 is disposed on the first inner wall 115, and the second discharge port 127 is disposed on the second inner wall 125.

A shortest distance between the first inner wall 115 and the second inner wall 125 is referred to as B0. The discharge ports 117 and 127 are located on the rear side than the shortest distance B0.

A separation distance between the front end 112 of the first tower 110 and the front end 122 of the second tower 120 is referred to as a first separation distance B1, and a separation distance between the rear end 113 of the first tower 110 and the rear end 123 of the second tower 120 is referred to as a second separation distance B2.

In the present embodiment, B1 and B2 are the same as each other. Unlike the present embodiment, any one of B1 or B2 may be longer than the other thereof.

The first discharge port 117 and the second discharge port 127 are disposed between

B0 and B2.

Preferably, the first discharge port 117 and the second discharge port 127 are disposed closer to the rear end 113 of the first tower 110 and the rear end 123 of the second tower 120 than B0.

As the discharge ports 117 and 127 are disposed closer to the rear ends 113 and 123, it is easier to control airflow through the Coanda effect described later.

The inner wall 115 of the first tower 110 and the inner wall 125 of the second tower 120 directly provide the Coanda effect, and the outer wall 114 of the first tower 110 and the outer wall 124 of the second tower 120 indirectly provide the Coanda effect.

The inner walls 115 and 125 directly guide the air discharged from the discharge ports 117 and 127 to the front ends 112 and 122. That is, the inner walls 115 and 125 provide the air discharged from the discharge ports 117 and 127 as the horizontal airflow.

Due to an air flow in the blowing space 105, an indirect air flow occurs in the outer walls 114 and 124 as well. The outer walls 114 and 124 induce a Coanda effect with respect to the indirect air flow, and guide the indirect air flow to the front ends 112 and 122.

A left side of the blowing space is blocked by the first inner wall 115, and a right side of the blowing space is blocked by the second inner wall 125, but an upper side of the blowing space 105 is opened.

An airflow converter to be described later can convert the horizontal airflow passing through the blowing space into the ascending airflow, and the ascending airflow can flow to the open upper side of the blowing space. The ascending airflow suppresses the direct flow of discharged air to the user and can actively convective indoor air.

In addition, a width of discharged air can be adjusted through the flow rate of air joined in the blowing space. By setting an up-down length of the first discharge port 117 and the second discharge port 127 much longer than the right-left widths B0, B1, and B2 of the blowing space, the discharged air of the first discharge port and the discharge air of the second discharge port can be induced to be joined to each other in the blowing space.

Referring to 1 to 3, the case 100 of the air conditioner 1 according to the embodiment of the present disclosure includes the base case 150 in which the filter is detachably installed, and the tower case 140 which is installed above the base case 150 and supported by the base case 150.

The tower case 140 includes the first tower 110 and the second tower 120. In the present embodiment, a tower base 130 connecting the first tower 110 and the second tower 120 to each other is disposed, and the tower base 130 is assembled to the base case 150. The tower base 130 may be manufactured integrally with the first tower 110 and the second tower 120.

Unlike the present embodiment, the first tower 110 and the second tower 120 may be directly assembled to the base case 150 without the tower base 130 or may be manufactured integrally with the base case 150.

The base case 150 forms a lower portion of the air conditioner 1, and the tower case 140 forms an upper portion of the air conditioner 1.

The air conditioner 1 may suck ambient air through the base case 150 and discharge air filtered by the tower case 140. The tower case 140 may discharge air from a higher position than the base case 150.

The air conditioner 1 is a column shape of which a diameter decreases upward. The air conditioner 1 may have a shape of a cone or a truncated cone as a whole.

Unlike the present embodiment, the air conditioner 1 may include a form in which two towers are disposed. In addition, unlike the present embodiment, it is not necessary to have a shape of which a cross section becomes narrower upward.

However, as in the present embodiment, if the cross section becomes narrower upward, the center of gravity is lowered and a risk of inversion due to an external force is reduced. For convenience of assembly, in the present embodiment, the base case 150 and the tower case 140 are separated from each other and manufactured.

Unlike the present embodiment, the base case 150 and the tower case 140 may be integrated with each other. For example, the base case and tower case can be manufactured in the form of a front case and a rear case which are integrally manufactured, and then assembled with each other.

In the present embodiment, the base case 150 is formed to gradually decrease in diameter toward the upper end. The tower case 140 is also formed to gradually decrease in diameter toward the upper end.

The outer surfaces of the base case 150 and the tower case 140 are formed continuously. In particular, the lower end of the tower base 130 and the upper end of the base case 150 are in close contact with each other, and the outer surface of the tower base 130 and the outer surface of the base case 150 form a continuous surface.

To this end, a diameter of the lower end of the tower base 130 may be the same or slightly smaller than a diameter of the upper end of the base case 150. The tower base 130 distributes filtered air supplied from the base case 150 and provides the distributed air to the first tower 110 and the second tower 120.

The tower base 130 connects the first tower 110 and the second tower 120 to each other, and the blowing space 105 is disposed above the tower base 130. In addition, discharge ports 117 and 127 are disposed above the tower base 130, and the ascending airflow and horizontal airflow are formed above the tower base 130.

In order to minimize a friction with air, an upper surface 131 of the tower base 130 is formed in a curved surface. In particular, the upper side is formed as a curved surface which is concave downward, and is formed to extend in the front-rear direction. One side 131a of the upper surface 131 is connected to the first inner wall 115, and the other side 131b of the upper surface 131 is connected to the second inner wall 125.

Referring to FIG. 4, when viewed from a top view, the first tower 110 and the second tower 120 are symmetrical right and left with respect to a center line L-L′. In particular, the first discharge port 117 and the second discharge port 127 are disposed to be symmetrical right and left with respect to the center line L-L′.

The center line L-L′ is an imaginary line between the first tower 110 and the second tower 120, and is disposed in a front-rear direction in the present embodiment, and is disposed to pass through the upper surface 131.

Unlike the present embodiment, the first tower 110 and the second tower 120 may be formed in an asymmetric shape. However, it is more advantageous to control horizontal airflow and ascending airflow that the first tower 110 and the second tower 120 are disposed symmetrically with respect to the center line L-L′.

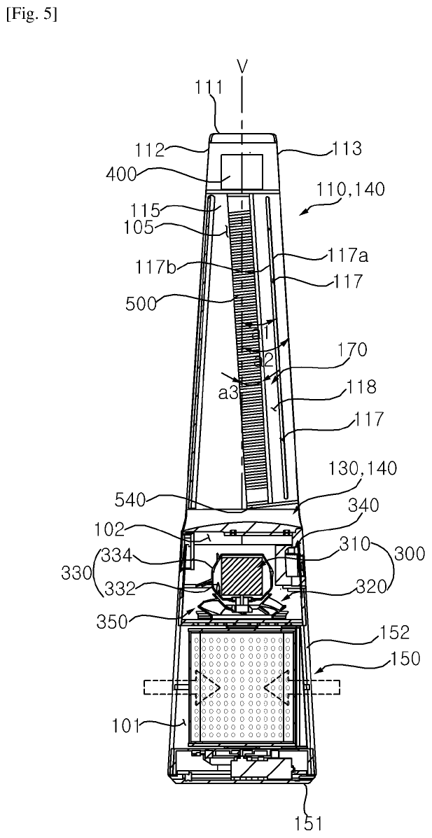

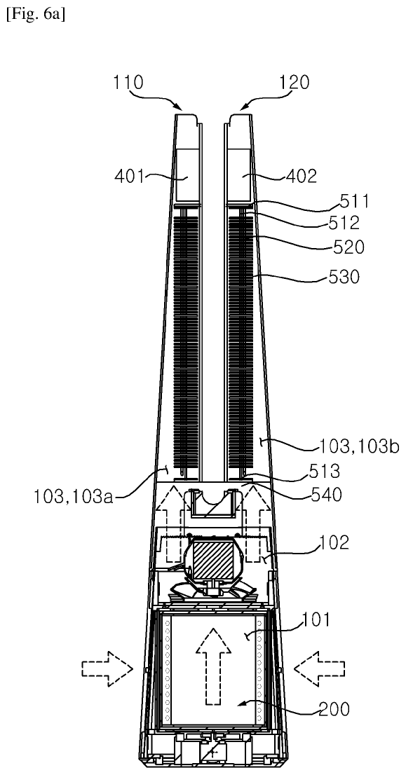

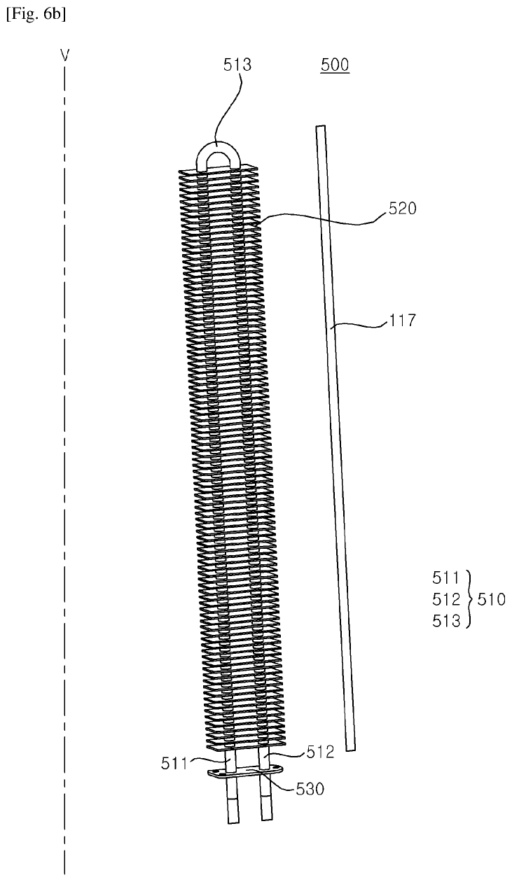

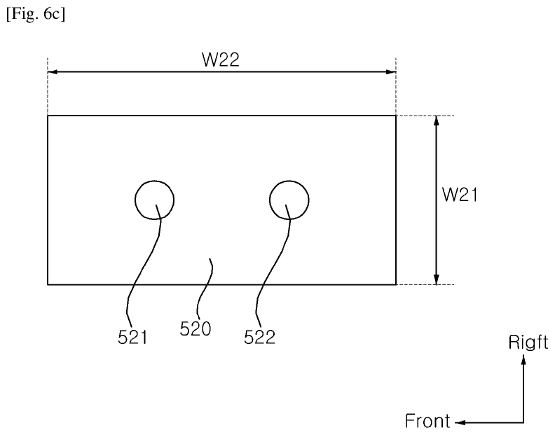

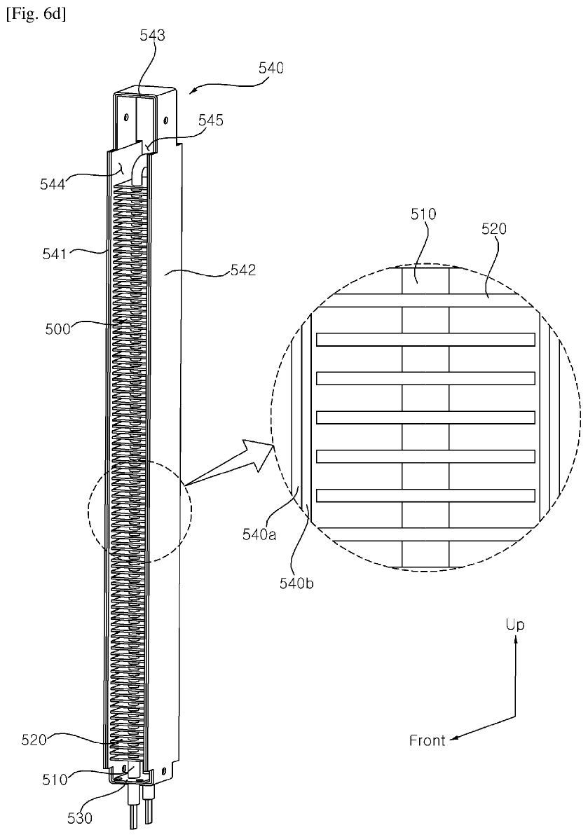

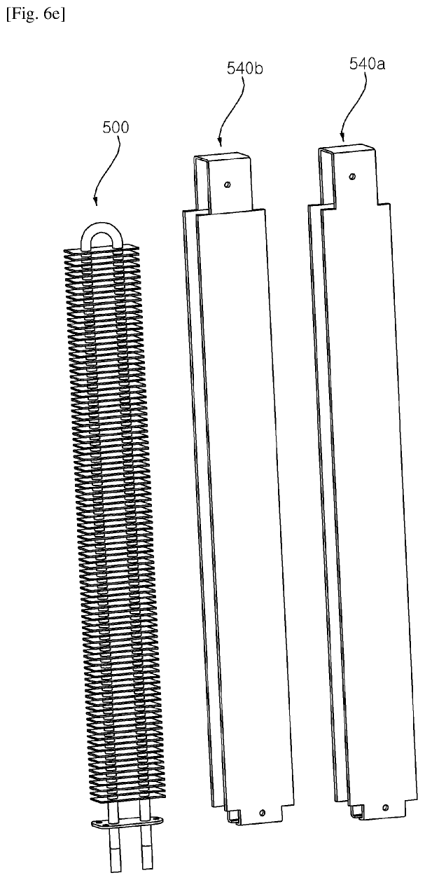

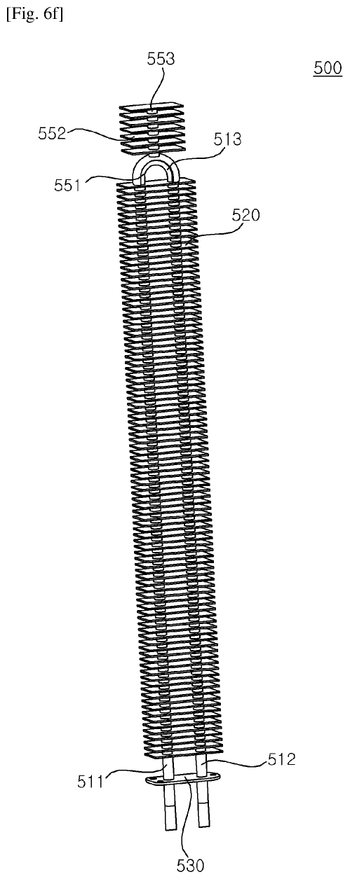

FIG. 5 is a right cross-sectional view of FIG. 2 and FIGS. 6A to 6F are front cross-sectional views of FIG. 2.

Referring to FIG. 1, 5, or 6A to 6F, the air conditioner 1 includes a filter 200 which is disposed inside the case 100, and a fan device which is disposed inside the case 100 and causes air to flow to the discharge ports 117 and 127.

In the present embodiment, the filter 200 and the fan device 300 are disposed inside the base case 150. The base case 150 is formed in a truncated cone shape, and an upper side thereof is open in the present embodiment.

The base case 150 includes a base 151 which is seated on the ground, a base outer 152 which is coupled to an upper side of the base 151 and includes a space formed therein and a suction port 155 formed therein.

When viewed from a top view, the base 151 is formed in a circular shape. The shape of the base 151 may be variously formed.

The base outer 152 is formed in a truncated cone shape having open upper and lower sides. In addition, a portion of a side surface of the base outer 152 is formed by opening. The open portion of the base outer 152 is referred to as a filter insertion port 154.

The case 100 further includes a cover which shields the filter insertion port 154 or/and the suction port. The cover 153 may be assembled detachably from the base outer 152. In the present embodiment, the cover 153 shields the filter insertion port 154 and the suction port together.

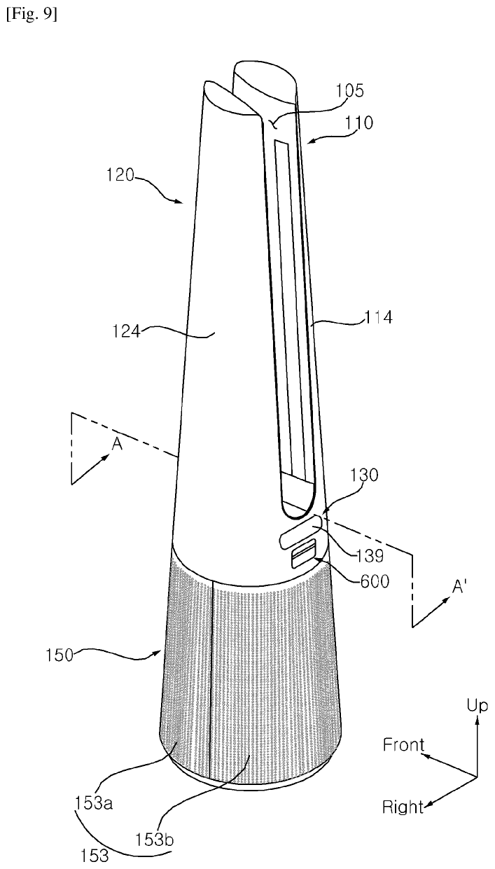

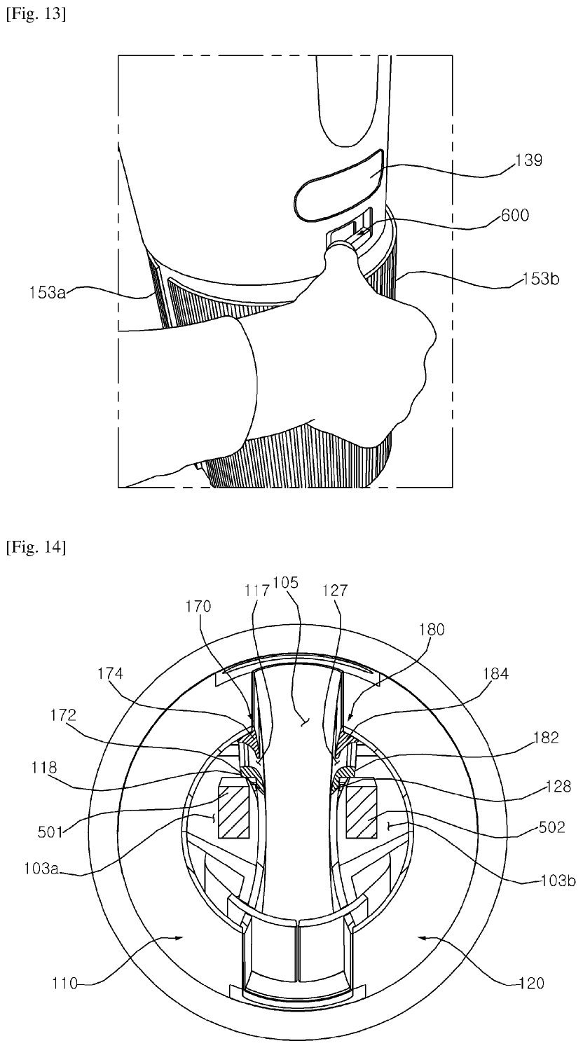

The user may remove the cover 153 and take the filter 200 out of the case 100. The present disclosure may further include a cover separation unit separating the cover 153. The cover separation unit will be described in detail in FIGS. 9 to 13.

The suction port 155 may be formed in at least one of the base outer 152 and the cover 153. In the present embodiment, the suction port 155 is formed in both the base outer 152 and the cover 153, and can suck air from all directions of 360 around the case 100.

In the present embodiment, the suction port 155 is formed in a hole shape, and the suction port 155 may have various shapes.

The filter 200 is formed in a cylindrical shape which is hollow in the up-down direction therein. An outer surface of the filter 200 faces the suction port 155.

Indoor air passes through and flows an outside of the filter 200 to an inside thereof, and in this process, foreign substances or harmful gases in the air may be removed.

The fan device 300 is disposed above the filter 200. The fan device 300 may cause air which has passed through the filter 200 to flow to the first tower 110 and the second tower 120.

The fan device 300 includes a fan motor 310 and a fan 320 rotated by the fan motor 310, and is disposed inside the base case 150.

The fan motor 310 is disposed above the fan 320, and a motor shaft of the fan motor 310 is coupled to the fan 320 disposed below.

A motor housing 330 in which the fan motor 310 is installed is disposed above the fan 320.

In the present embodiment, the motor housing 330 has a shape surrounding the entire fan motor 310. Since the motor housing 330 covers the entire fan motor 310, it is possible to reduce a flow resistance with respect to the air flowing from the lower side to the upper side.

Unlike the present embodiment, the motor housing 330 may be formed to surround only a lower portion of the fan motor 310.

The motor housing 330 includes a lower motor housing 332 and an upper motor housing 334. At least one of the lower motor housing 332 and the upper motor housing 334 is coupled to the case 100.

In the present embodiment, the lower motor housing 332 is coupled to the case 100.

After the fan motor 310 is installed above the lower motor housing 332, the upper motor housing 334 is covered so that the fan motor 310 is surrounded.

The motor shaft of the fan motor 310 passes through the lower motor housing 332 and is assembled to the fan 320 disposed on the lower side.

The fan 320 may include a hub to which the shaft of the fan motor is coupled, a shroud spaced apart from the hub, and a plurality of blades connecting the hub and the shroud to each other.

The air which has passed through the filter 200 is sucked into the shroud, and is then pressurized and flowed by the rotating blade. The hub is disposed above the blade, and the shroud is disposed below the blade. The hub may be formed in a bowl shape concave downward, and a lower side of the lower motor housing 332 may be partially inserted into the hub.

In the present embodiment, the fan 320 is a mixed flow fan. The mixed flow fan sucks air into an axial center and discharges air in a radial direction, and forms the discharged air so that the discharged air is inclined with respect to the axial direction.

Since the entire air flows from the lower side to the upper side, when air is discharged in the radial direction like a general centrifugal fan, a large flow loss due to the flow direction change occurs. The screw flow fan can minimize air flow loss by discharging air upward in the radial direction.

Meanwhile, a diffuser 340 may be further disposed above the fan 320. The diffuser 340 guides the flow of air caused by the fan 320 in the upward direction.

The diffuser 330 serves to further reduce a radial component in the air flow and reinforce an upward component in the air flow. The motor housing 330 is disposed between the diffuser 330 and the fan 320. In order to minimize an installation height of the motor housing in the up-down direction, a lower end of the motor housing 330 may be inserted into the fan 320 to overlap the fan 320. In addition, an upper end of the motor housing 330 may be inserted into the diffuser 340 to overlap the diffuser 340.

Here, the lower end of the motor housing 330 is disposed higher than the lower end of the fan 320, and the upper end of the motor housing 330 is disposed lower than the upper end of the diffuser 340.

In order to optimize an installation position of the motor housing 330, in the present embodiment, an upper side of the motor housing 330 is disposed inside the tower base 130, and a lower side of the motor housing 330 is disposed inside the base case 150. Unlike the present embodiment, the motor housing 330 may be disposed inside the tower base 130 or the base case 150.

Meanwhile, a suction grill 350 may be disposed inside the base case 150. When the filter 200 is separated, the suction grill 350 prevents a finger of the user from entering the fan 320, and thus, protects the user and the fan 320.

The filter 200 is disposed below the suction grill 350 and the fan 320 is disposed above the suction grill 350. The suction grill 350 has a plurality of through holes formed in the up-down direction so that air can flow.

Inside the case 100, a space below the suction grill 350 is defined as a filter installation space 101. A space between the suction grill 350 and the discharge ports 117 and 127 inside the case 100 is defined as a blowing space 102. Inside the case 100, an inner space between the first tower 110 and the second tower 120 in which the discharge ports 117 and 127 are disposed is defined as a discharge space 103.

Indoor air is introduced into the filter installation space 101 through the suction port 155 and then discharged to the discharge ports 117 and 127 through the blowing space 102 and the discharge space 103.

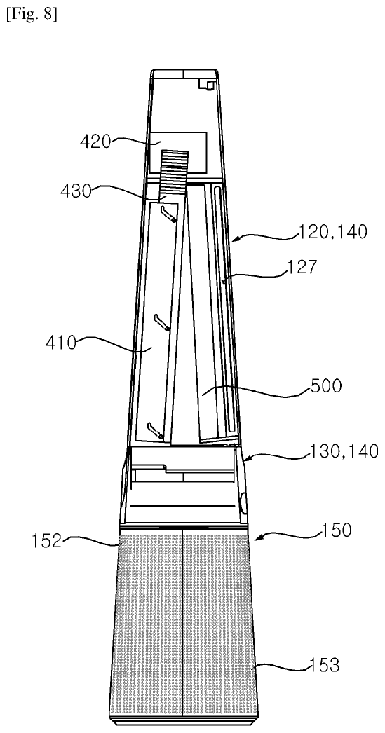

Next, referring to FIG. 5 or 8, the first discharge port 117 and the second discharge port 127 according to the present embodiment are disposed to be elongated in the up-down direction. The first discharge port 117 is disposed between the front end 112 and the rear end 113 of the first tower 110 and is disposed close to the rear end 113. Air discharged from the first discharge port 117 can flow along the first inner wall 115 and can flow toward the front end 112 due to the Coanda effect.

The first discharge port 117 includes a first border 117a forming an edge on an air discharge side (front end in the present embodiment), a second border 117b forming an edge on a side (rear end in the present embodiment) opposite to the air discharge side, an upper border 117c forming an upper edge of the first discharge port 117, and a lower border 117d forming a lower edge of the first discharge port 117.

In the present embodiment, the first border 117a and the second border 117b are disposed parallel to each other. The upper border 117c and the lower border 117d are disposed parallel to each other.

The first border 117a and the second border 117b are disposed to be inclined with respect to a vertical direction V. In addition, the rear end 113 of the first tower 110 is also disposed to be inclined with respect to the vertical direction V.

In the present embodiment, an inclination a1 of each of the first border 117a and the second border 117b with respect to the vertical direction V is 4, and an inclination a2 of the rear end 113 is 3. That is, the inclination a1 of the discharge port 117 is larger than the inclination of the outer surface of the tower.

The second discharge port 127 is symmetrical right and left to the first discharge port 117.

The second discharge port 127 includes a first border 127a forming an edge on an air discharge side (front end in the present embodiment), a second border 127b forming an edge on a side (rear end in the present embodiment) opposite to the air discharge side, an upper border 127c forming an upper edge of the second discharge port 127, and a lower border 127d forming a lower edge of the second discharge port 127.

The first border 127a and the second border 127b are disposed to be inclined with respect to the vertical direction V, and the rear end 113 of the first tower 110 is also disposed inclined with respect to the vertical direction V. In addition, the inclination a1 of the discharge port 127 is larger than the inclination a2 of the outer surface of the tower.

Hereinafter, a heater 500 installed in the air conditioner will be described.

Referring to FIGS. 3 and 6A, the heater 500 is a component which is disposed in the first discharge space 103a or the second discharge space 103b to heat flowing air. The heater 500 heats the flowing air and discharges the heated air to an outside of the air conditioner.

The heater 500 may be disposed in the first tower 110 or the second tower 120 of the air conditioner.

The heater 500 is disposed to be extended in the up-down direction. The heater 500 is disposed in a length direction of the first tower 110 or the second tower 120.

The heater 500 may be disposed in each of the first tower 110 and the second tower 120. The heater 500 disposed in the first tower 110 may be referred to as a first heater 500(501), and the heater 500 disposed in the second tower 120 may be referred to as a second heater 500(502). The first tower 110 and the second tower 120 may be formed symmetrically with respect to a central axis, and the first tower 110 and the second tower 120 may be disposed symmetrically with respect to the central axis.

An upper end of the heater 500 may be disposed below an upper end of the space board 410. A lower end of the heater 500 may be disposed above a lower end of the space board 410.

Referring to FIG. 4, when viewed from the top, the upper end of the heater 500 may be disposed at a center of the first tower 110 or the second tower 120 in the front-rear direction. Referring to FIG. 5, the upper end of the heater 500 is disposed in front of the lower end of the heater 500. In other words, the heater 500 is disposed inclined so that the lower end is disposed behind the upper end.

As will be described later, when the heater 500 is disposed inclined so that the lower end is disposed at the rear of the upper end, a heat-radiating pin 520 extends in a direction (horizontal direction) intersecting an extension direction of the discharge port. Accordingly, it is possible to prevent a decrease in a flow rate of air passing through the heater 500, and the air flowing from the upper side to the lower is converted in a horizontal direction by the direction of the heat-radiating pin 520 to be supplied to the discharge port to reduce air pressure loss.

More specifically, the heater 500 is disposed to be inclined with respect to the vertical direction. The heater 500 is disposed in parallel with the first discharge port 117 or the second discharge port 127. Here, an inclination direction of the heater 500 means an inclination direction of a first heat-radiating tube 511 or a second heat-radiating tube 512 to be described later, and the extension direction of the heater 500 means that an extension direction of the first heat-radiating tube 511 or the second heat-radiating tube 512 to be described later.

The heater 500 may be disposed to be inclined to have an inclination (angle) of a3 with respect to the vertical direction. The first heat-radiating tube 511 or the second heat-radiating tube 512 may be disposed to be inclined to have the inclination (angle) of a3 with respect to the vertical direction.

For example, the heater 500 may be disposed to be inclined within a certain error range based on an angle of 4 with respect to the vertical direction. The second discharge port 127 may be disposed to be inclined to have an inclination of a1 with respect to the vertical direction. For example, the second discharge port 127 may be disposed to be inclined within a certain error range based on an angle of 4 with respect to the vertical direction. Although not illustrated in FIG. 5, it is obvious that the first discharge port 117 may also be disposed to be inclined to have an inclination of a1 with respect to the vertical direction.

The inclination a3 of the heater 500 may correspond to the following values. That is, the inclination a3 may correspond to an inclination between the vertical axis V with respect to the ground and the heat-radiating pin 520, an inclination between the vertical axis with respect to the ground and the heat-radiating pin tube 510, and an inclination between the heat-radiating pin 520 and the ground.

The heater 500 is disposed in parallel with the first discharge port 117 or the second discharge port 127 with respect to the vertical direction. In other words, the inclination a3 of the heater 500 with respect to the vertical direction and the inclination a1 of the first discharge port 117/second discharge port 127 with respect to the vertical direction may be the same as each other. The heater 500 is disposed in parallel with the first discharge port 117 or the second discharge port 127, and thus, an uniform amount of air guided by the heat-radiating pin 520 may flow to the first discharge port 117 or the second discharge port 127.

The heater 500 is disposed inside the tower case 140, and is disposed on an upstream side of the first discharge port 117 or the second discharge port 127. The upstream side means that it is disposed in the air inflow direction based on the flow direction of air. That is, the heater 500 is disposed in the air inflow direction of the first discharge port 117 or the second discharge port 127. More specifically, the heater 500 is disposed in front of the first discharge port 117 or the second discharge port 127.

Referring to FIG. 6B, the heater 500 includes a heat-radiating tube 510 which emits heat and a heat-radiating pin 520 which transfers the heat from the heat-radiating tube 510. In addition, the heater 500 may further include a fastening plate 530.

The heat-radiating tube 510 is a component which receives energy and converts the energy into thermal energy to emit heat. The heat-radiating tube 510 is connected to an electric device to receive electrical energy, and is constituted by a resistor to convert the electrical energy into the thermal energy.

Alternatively, the heat-radiating tube 510 may include a pipe through which a refrigerant flows, and heat the air by exchanging heat between the refrigerant flowing inside and the air flowing outside. In addition, the heat-radiating tube 510 includes a heating element within a range which can be easily changed based on a person skilled in the art.

The heat-radiating tube 510 may be formed in a U-shape. Specifically, the heat-radiating tube 510 includes a first heat-radiating tube 511 and a second heat-radiating tube 512 disposed to be parallel to each other, and a third heat-radiating tube 513 connecting one end of the first heat-radiating tube 511 and one end of the second heat-radiating tube 512 to each other.

The length of each of the first heat-radiating tube 511 and the second heat-radiating tube 512 may be longer than that of the third heat-radiating tube 513. The third heat-radiating tube 513 may have a straight shape or a curved shape. The third heat-radiating tube 513 has a curvature, and the first heat-radiating tube 511 to the third heat-radiating tube 513 are integrally formed with each other and bent to complete the U-shape of the heat-radiating tube 510.

The first heat-radiating tube 511 or the second heat-radiating tube 512 may extend in a first direction. The first heat-radiating tube 510 or the second heat-radiating tube 512 extends to be elongated along the length direction of the first discharge port 117 or the second discharge port 127. That is, the first heat-radiating tube 511, the second heat-radiating tube 512, the first discharge port 117, and the second discharge port 127 may extend in the first direction. Here, the first direction is the up-down direction or a direction having an inclination within 4 with respect to the up-down direction.

When the first heat-radiating tube 511 and the second heat-radiating tube 512 are extended in the length direction of the discharge port, a temperature of the air discharged from the discharge port becomes constant regardless of the upper and lower portions. When the U-shaped heat-radiating tube 510 is used, since the two heat-radiating tubes 510 are coupled to the heat-radiating pin 520, the amount of heat transferred to the heat-radiating pin 520 increases, and a coupling force between the heat-radiating pin 520 and the heat-radiating tube 510 increases.

The fastening plate 530 provides a space in which a protective cover 540 to be described later is coupled. A coupling hole (not illustrated) to which a fastening member passing through the protective cover 540 is coupled may be formed in the fastening plate 530. In addition, the fastening plate 530 fixes the heater 500 to the case.

Specifically, the fastening plate 530 is coupled to the first heat-radiating tube 511 and the second heat-radiating tube 512. The fastening plate 530 has a plate shape and extends in a direction intersecting the extension directions of the first heat-radiating tube 511 and the second heat-radiating tube 512. The fastening plate 530 is located below the heat-radiating pin 520. The fastening plate 530 is coupled to the tower case.

Referring to FIGS. 6B and 6C, the heat-radiating pin 520 is a component which is connected to the heat-radiating tube 510 and transfers heat from the heat-radiating tube 510. Since the heat-radiating pin 520 has a large surface area, the heat received through the heat-radiating tube 510 can be effectively transferred to the flowing air.

The heat-radiating pin 520 changes the air flow direction to guide the air to the first discharge port 117 or the second discharge port 127. The suction port is disposed below, and the first discharge port 117 and the second discharge port 127 are disposed above. Inside the first tower 110 and second tower 120, air forms a flow which ascends from the bottom to the top. The heat-radiating pin 520 change a flow ascending from the bottom to the top into a flow moving from the front to the rear.

A plurality of heat-radiating pins 520 are disposed to be spaced apart from each other in the first direction. The heat-radiating pin 520 is coupled to the first heat-radiating tube 511 and the second heat-radiating tube 512 except for the lower ends of the third heat-radiating tube 513 and the first heat-radiating tube 511 and the lower end of the second heat-radiating tube 512. A pitch of the plurality of heat-radiating pins 520 is not limited.

Preferably, the pitch of the plurality of heat-radiating pins 520 is smaller than the separation distance between the first heat-radiating tube 511 and the second heat-radiating tube 512. If the pitch of the heat-radiating pins 520 is too large, the heat exchange efficiency with air decreases, and if the pitch of the heat-radiating pins 520 is too small, a pressure loss increases while air passes through the heat-radiating pin 520.

The heat-radiating pin 520 may include heat radiating surfaces 523 disposed to face each other, and a pin side surface 525 which connects edges of the two heat-radiating surfaces 523 and has an area smaller than those of the heat-radiating surfaces 523. The heat-radiating surface 523 has the largest area in the heat-radiating pin 520. The heat-radiating surface 523 is a surface which serves as the main heat dissipation in the heat-radiating pin 520.

The heat-radiating pin 520 includes a first tube hole 521 into which the first heat-radiating tube 511 is inserted, and a second tube hole 522 into which the second heat-radiating tube 512 is inserted. The first tube hole 521 and the second tube hole 522 are formed through heat-radiating surfaces 523. The heat-radiating pin 520 may be coupled to the first heat-radiating tube 511 and the second heat-radiating tube 512 inserted into the first tube hole 521 and the second tube hole 522 by an adhesive or a compression method.

A length W22 of the heat-radiating pin 520 may be larger than a distance between the first heat-radiating tube 511 and the second heat-radiating tube 512. The first tube hole 521 and the second tube hole 522 are spaced apart from each other in a length direction of the heat-radiating pin 520. A separation distance between the first tube hole 521 and the second tube hole 522 may be smaller than the length W22 of the heat-radiating pin 520. The separation distance between the first tube hole 521 and the second tube hole 522 may be 30% to 50% of the length W22 of the heat-radiating pin 520. A width W21 of the heat-radiating pin 520 may be 30% to 50% of the length W22 of the heat-radiating pin 520.

Preferably, the length direction of the heat-radiating pin 520 is disposed in the front-rear direction. When the heat-radiating pin 520 is disposed in the front-rear direction, the air moving from the bottom to the top moves from the front to the rear to exchange heat with the heat-radiating pin 520, which will increase heat exchange area and time.

The heat-radiating surface 523 may define a surface intersecting the first direction in which the first heat-radiating tube 511 extends. Preferably, the heat-radiating surface 523 defines a surface perpendicular to the first direction. As another example, the heat-radiating pin 520 may have an inclination less than 45 with respect to a reference surface perpendicular to the first direction.

Specifically, when the first heat-radiating tubes 511 and 520 form an angle of about 4 with respect to the vertical axis V, the heat-radiating surface 523 of the heat-radiating pin 520 may form an angle of about 4 with respect to the ground.

Therefore, the sucked air contacts into contact with each heat-radiating pin 520 while ascending inside the tower case and exchanges heat with the heat-radiating pin 520. Moreover, the direction of the sucked air is changed into in the horizontal direction along the heat-radiating surface 523, and the sucked air is supplied to the discharge ports 117 and 127.

More specifically, one end of the heat-radiating pin 520 is disposed closer to the discharge port discharge ports 117 and 127 than the other end of the heat-radiating pin 520, and the one end of the heat-radiating pin 520 may be positioned higher than the other end of the radiating pin 520. Accordingly, since the air sucked from the bottom to the top is smoothly changed when the direction of the air is changed in the horizontal direction, a pressure loss applied to the air is reduced.

The first discharge port 117 extends to be elongated in the length direction (first direction) of the first tower 110, the second discharge port 127 extends to be elongated in the length direction (first direction) of the second tower 120, the plurality of heat-radiating pins 520 are disposed along the length direction of the first discharge port 117 or the second discharge port 127, and thus, air can be uniformly distributed to each of discharge port discharge port 117 and 127 in the length direction.

The heat-radiating pin 520 may have the inclination less than 45 with respect to the reference surface perpendicular to the first direction. The heat-radiating pin 520 may be formed of a metal material having excellent heat transfer. For example, a material of the heat-radiating pin 520 may be different from a material of the heat-radiating tube 510. The material of the heat-radiating pin 520 may include aluminum, and the heat-radiating tube 510 may include an insulation material.

The present disclosure may further include the protective cover 540 protecting the heater 500.

Referring to FIGS. 6D and 6E, the protective cover 540 prevents external contact with the heater 500, thereby preventing the heater 500 from being damaged. The protective cover 540 fixes the heater 500 to the case and prevents the heat radiated from the heater 500 from being transferred to the case. In addition, the protective cover 540 allows air flowing inside the case to flow through the heater 500.

The protective cover 540 may be formed to be spaced apart from the heat-radiating pins 520 to surround at least the heat-radiating pins 520. In addition, the protective cover 540 includes a cover inlet 544 into which air flows and a cover discharge port 545 through which air is discharged, and the cover inlet 544 and the cover discharge port 545 can be positioned to face each other.

A line connecting a center of the cover inlet 544 and a center of the cover discharge port 545 may extend in a direction intersecting the first direction. Specifically, the line connecting the center of the cover inlet 544 and the center of the cover discharge port 545 may be parallel to the front-rear direction or may be parallel to the length direction of the heat-radiating pin 520.

For example, the protective cover 540 may include a first side cover plate 541 and a second side cover plate 542 which are disposed to face each other, and a third side cover plate 543 connecting one end of the first side cover plate 541 and one end of a second side cover plate 542 to each other.

At least the heat-radiating pins 520 are located between the first side cover plate 541 and the second side cover plate 542. Preferably, the heat-radiating pins 520 and the heat-radiating tube 510 are located between the first side cover plate 541 and the second side cover plate 542. The cover inlet 544 and the cover discharge port 545 are defined between the first side cover plate 541 and the second side cover plate 542.

The first side cover plate 541 and the second side cover plate 542 are disposed parallel to the length direction of the heat-radiating pin 520 and extend in the up-down direction. Preferably a length of each of the first side cover plate 541 and the second side cover plate 542 is longer than the length of the heater 500.

More specifically, in the protective cover 540, the first side cover plate 541 and the second side cover plate 542 extends to be elongated in the up-down direction, and the upper end of the first side cover plate 541 and the upper end of the second side cover plate 542 are connected to each other by the third side cover plate 543.

The lower end of the first side cover plate 541 and the lower end of the second side cover plate 542 are coupled to the fastening plate 530 of the heater 500. The upper end or the lower end of the first side cover plate 541 and the second side cover plate 542 includes a fastening hole through a fastening member (not illustrated) which fastens the first side cover plate 541 and the second side cover plate 542 to the tower case is coupled.

A right-left direction of the heat-radiating pin 520 is covered with the first side cover plate 541 and the second side cover plate 542, an upward direction of the heat-radiating pin 520 is covered with the third side cover plate 543, a downward direction of the heat-radiating pin 520 is covered with the fastening plate 530, and thus, the cover inlet 544 and the cover discharge port 545 in the front-rear direction of the heat-radiating pin 520 are defined.

Accordingly, the protective cover 540 protects the heat-radiating pin 520 and does not interfere with the air flowing through the heat-radiating pin 520.

Preferably, the protective cover 540 is formed of a material having excellent heat resistance and heat insulation so as to prevent a short circuit of the electrically driven heater 500, as well as external physical shock, and to prevent the heat of the heater 500 from moving to the case.

In addition, the protective cover 540 may have a composite material or a multi-layer structure to provide the heat resistance and heat insulation. For example, the protective cover 540 may include a first protective cover 540a which is a heat-resistant material, and the second protective cover 540b which is disposed between the first protective cover 540a and the heater 500 and is an insulation material.

The first protective cover 540a may include SUS, and the second protective cover 540b may include mica or PPS/PPA.

A heater according to another embodiment of the present disclosure may further include top heat-radiating members 551, 552, and 553.

Referring to FIG. 6F, the top heat-radiating members 551, 552, and 553 are coupled to the third heat-radiating tube 513 to dissipate heat from the third heat-radiating tube 513 and exchange heat with air. The top heat-radiating members 551, 552, and 553 may be detachably coupled to the third heat-radiating tube 513.

Since the third heat-radiating tube 513 is bent, the heat-radiating pin 520 inserted into the first heat-radiating tube 511 and the second heat-radiating tube 512 cannot be coupled to the third heat-radiating tube 513. Therefore, the top heat-radiating members 551, 552, 553 transfer heat from the third heat-radiating tube 513 to the air.

The top heat-radiating member 551, 552, and 553 may include a connector 551 into which at least a portion of the third heat-radiating tube 513 is inserted, and a plurality of top heat-radiating pins 553 which are connected to the connector 551 to have a surface area larger than that of the connector 551. The plurality of top heat-radiating pins 553 may be connected by a pin connecting member 553.

The connector 551 may be coupled to the third heat-radiating tube 513 in a force fitting manner. Specifically, preferably, the connector 551 has a cross section of ⅔ circle. The top heat-radiating pin 520 may extend in the front-rear direction.

Hereinafter, a cover separation unit 600 for separating the cover 153 from the base case 150 will be described in detail.

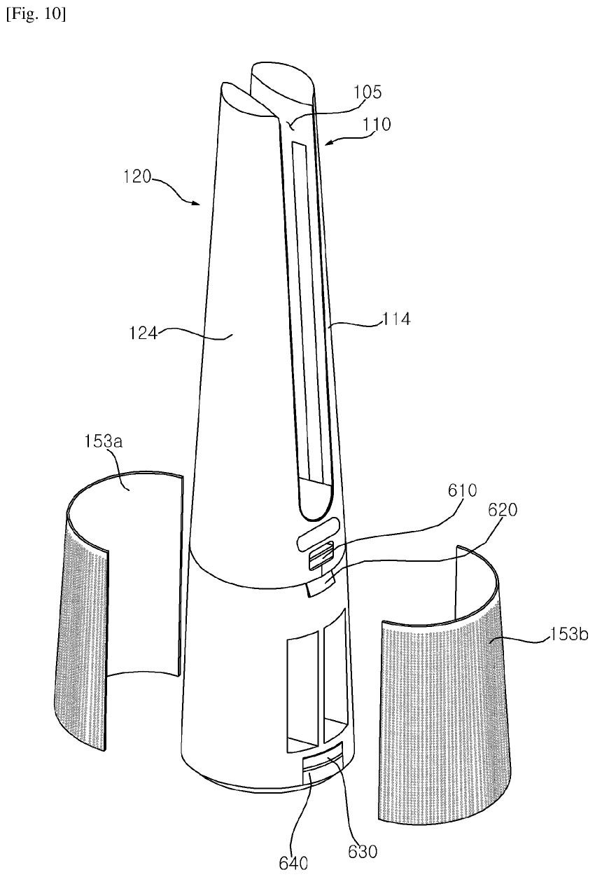

Referring to FIGS. 9 and 10, the cover 153 of the present disclosure is coupled to the case 100 without a gap for an aesthetic feeling to the user. Specifically, the cover 153 is magnetically coupled to the case 100, and a magnet (not illustrated) may be installed on the cover 153 and the case 100. Hereinafter, a direction to be described refers to a direction in a state in which the cover 153 is coupled to the case 100 unless otherwise specified.

In addition, the cover 153 has a shape surrounding the entire outer surface (in detail, outer peripheral surface) of the base case 150. Therefore, the cover 153 is formed in a cylindrical shape and has a shape corresponding to the outer peripheral surface of the base case 150. In addition, the cover 153 may be separated into two pieces for convenience of separation and to reduce a gap during the coupling.

Specifically, the cover 153 may include a front cover 153a which covers a front surface of the base case 150 and a rear cover 153b which covers the rest of the surface except the front surface of the base case 150. Each of the front cover 153a and the rear cover 153b has a semi-cylindrical shape. Therefore, the cover 153 shields both the filter insertion port 154 and the suction port 155 formed in the base case 150, and thus, provides excellent aesthetic feeling to the user.

Further, the outer surface of the cover 153 coincides with a surface or line extending the outer surface of the tower case 140. Therefore, when the cover 153 is coupled to the base case 150, the cover 153 has a sense of unity with the tower case 140, and there is no gap. In this case, the aesthetic feeling given to the user is improved. However, there is no space for the hand of the user to enter, and thus, it is difficult for the user to separate the cover 153 from the base case 150.

The present disclosure provides a cover separation unit 600 for the user to easily separate the cover 153 from the base case 150.

The cover separation unit 600 is installed in the case 100 to separate the cover 153 from the base case 150. For example, the cover separation unit 600 may include a lever 610 and an upper cover pusher 620. For another example, the cover separation unit 600 may include a lever 610, an upper cover pusher 620, a slider 630, and a lower cover pusher 640 to simultaneously separate the top and bottom of the cover 153.

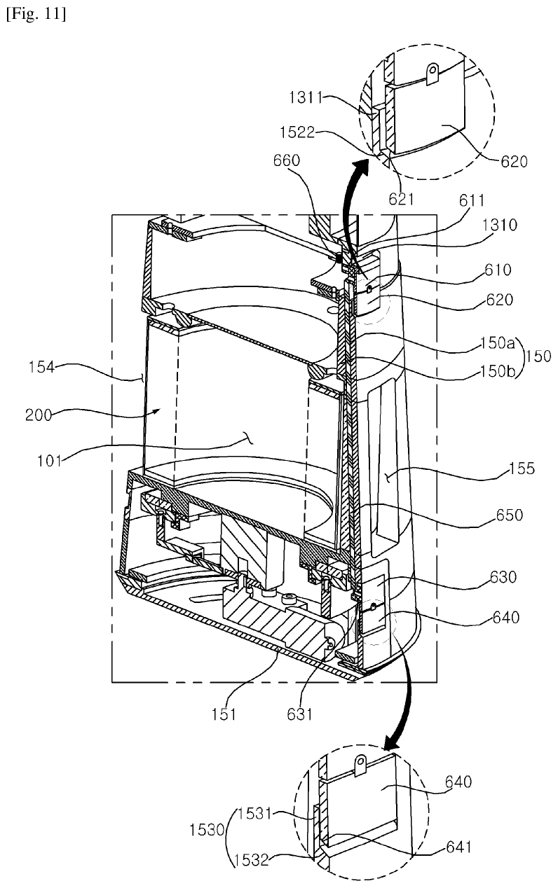

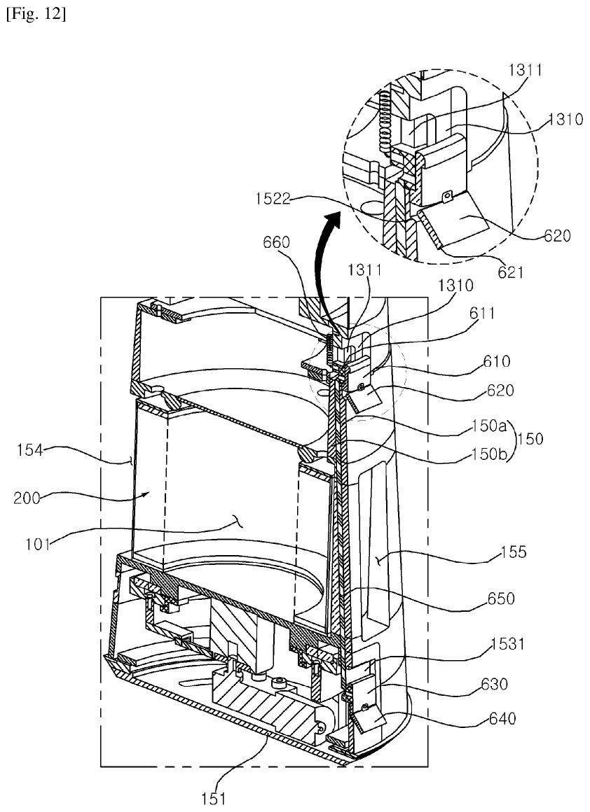

Referring to FIGS. 11 and 12, the lever 610 is installed in the case 100 and slides along the outer surface of the case 100. The lever 610 may be installed in the base case 150 or the tower case 140. In the present embodiment, the cover 153 covers the entire base case 150, and the lever 610 is installed in the tower case 140 and slides along the outer surface of the tower case 140.

The lever 610 transmits an external force to the upper cover pusher 620 or/and the lower cover pusher 640. At least a portion of the lever 610 is exposed to the outer surface of the case 100. In the present embodiment, at least a portion of the lever 610 is exposed to the outer surface of the tower case 140. The lever 610 may be disposed above the cover 153.

The lever 610 is exposed to one surface of the tower case 140 and is moved up and down by an external force. Therefore, the user can operate the lever 610 without excessively bowing a waist of the user, and since the lever 610 moves along the outer surface of the case 100, when the lever 610 moves, the lever 610 does not protrude outward of the case 100. Accordingly, a possibility that the lever 610 is damaged due to the lever 610 protruding outward of the case 100 while the lever 610 is used is reduced.

The lever 610 may be accommodated in the lever receiving groove 1310 formed in the case 100. The lever receiving groove 1310 may be formed in the tower case 140 or may be formed in the base case 150.

In the present embodiment, the outer peripheral surface of the tower case 140 is recessed in a center direction, and thus, the lever receiving groove 1310 is formed. In addition, the lever receiving groove 1310 may communicate with a pusher receiving groove 1521 to be described later. That is, a lower portion of the lever receiving groove 1310 is open to communicate with the pusher receiving groove 1521. The lever receiving groove 1310 accommodates the lever 610 and provides a space in which the lever 610 moves.

A guide slit 1311 is formed in the lever receiving groove 1310. The guide slit 1311 guides the lever 610 and prevents the lever 610 from being separated from the case 100. The lever 610 may further include a holder 611.

One end of the holder 611 is connected to the lever 610 through the guide slit 1311, and the other end of the holder 611 is located inside the tower case 140 and has a width wider than a width of the guide slit 1311. Accordingly, even if the lever 610 is moved up and down, the lever 610 is prevented from being separated from the case 100.

The cover separation unit 600 further includes a return spring 660 which provides a restoring force to the lever 610. The return spring 660 provides an upward restoring force to the lever 610. Specifically, one end of the return spring 660 is connected to the case 100, and the other end thereof is connected to the lever 610. More specifically, one end of the return spring 660 is connected to the inner surface of the tower case 140, and the other end thereof is connected to the holder 611.

The upper cover pusher 620 is rotatably coupled to the lever 610 and is guided to the outer surface of the case 100 to push the cover 153. Accordingly, when an external force is applied to the lever 610, the cover 153 is separated from the case 100 by the upper cover pusher 620.

The upper cover pusher 620 being rotatably coupled to the lever 610 includes the upper cover pusher 620 being hinge-coupled to the lever 610 to be rotated, and the upper cover pusher 620 being connected to one end of the lever 610 in a bendable manner to be rotated. In addition, the upper cover pusher 620 being rotatably coupled to the lever 610 includes the upper cover pusher 620 being formed of a flexible material and one end of the upper cover pusher 620 moving in an outer surface direction while the entire upper cover pusher 620 being bent. In the present embodiment, the pusher of the cover 153 is hinge-coupled to a lower end of the lever 610.

The upper cover pusher 620 may be disposed in a coupling region of the base case 150 in which the cover 153 is coupled to the base case 150. Here, the coupling region means a position horizontally overlapping with the cover 153 in the base case 150. The coupling region may be a portion of the base case 150 or may be the entire base case 150.

The upper cover pusher 620 is located between the cover 153 and the base case 150.

When the cover 153 is coupled to the base case 150, the upper cover pusher 620 is not exposed to the outside by the cover 153. The upper cover pusher 620 is located in the pusher receiving groove 1521 formed in the base case 150 to be described later.

Therefore, in a state in which the cover 153 is coupled to the base case 150, the upper cover pusher 620 is covered with the cover 153, and thus, the aesthetic feeling given to the user can be improved. In addition, since there is no need for a separate space for the upper cover pusher 620 to rotate, there is also an advantage of implementing a slim product.

An upper rotation guide 1520 guides the upper cover pusher 620 so that the upper cover pusher 620 rotates in one direction when the upper cover pusher 620 is moved along the outer surface of the base case 150. In addition, the upper rotation guide 1520 accommodates the upper cover pusher 620.

The upper rotation guide 1520 may include an upper guide surface 1522 which extends in a direction intersecting the outer surface (outer peripheral surface) of the base case 150 and guides the upper cover pusher 620. The upper guide surface 1522 may extend in a direction intersecting the up-down direction of the outer peripheral surface of the base case 150. Specifically, the upper guide surface 1522 may have an inclination angle greater than 0 with respect to the outer surface of the base case 150. The upper guide surface 1522 may be inclined downward from an inside of the base case 150 toward an outside thereof.

In this case, a lower surface of the upper cover pusher 620 may be inclined downward from the inside to the outside to correspond to the upper guide surface 1522. The lower surface of the upper cover pusher 620 may have a constant inclination angle in the up-down direction. Accordingly, when the upper cover pusher 620 moves downward due to interference between the lower surface of the upper cover pusher 620 and the upper guide surface 1522, the lower end of the upper cover pusher 620 protrudes outward.

At least a portion of the upper guide surface 1522 vertically overlaps the upper end of the upper cover pusher 620. At least a portion of the upper guide surface 1522 vertically overlaps the upper end of the upper cover pusher 620 in a state where the filter is coupled.

The upper rotation guide 1520 is formed in the base case 150. Specifically, the upper rotation guide 1520 is disposed in a region horizontally overlapping the cover 153 in the base case 150. Accordingly, when the cover 153 is coupled to the base case 150, the upper rotation guide 1520 is not exposed to the outside by the cover 153.

More specifically, the base case 150 includes an inner base case 150a and an outer base case 150b which is disposed to surround at least a portion of the inner base case 150a, and the upper guide surface 1522 is formed on an outer surface of the outer base case 150b.

The upper rotation guide 1520 may further include an upper pusher receiving groove 1521 accommodating the upper cover pusher 620. The upper pusher receiving groove 1521 may accommodate a portion of the lever 610 when the lever 610 moves downward.

The upper pusher receiving groove 1521 accommodates the upper cover pusher 620 when the lever 610 is not operated, and guides the movement of the upper cover pusher 620 when the lever 610 moves downward to guide the movement of the lever 610.

In the present embodiment, the upper pusher receiving groove 1521 is formed by the outer peripheral surface of the outer base case 150b being recessed inward. That is, the upper pusher receiving groove 1521 is open outward in the outer base case 150b. In addition, the upper pusher receiving groove 1521 is open in the up direction and communicates with the lower portion of the lever receiving groove 1310 so as to accommodate and guide the lever 610 when the lever 610 moves downward. The upper pusher receiving groove 1521 and the lever receiving groove 1310 are located so that at least a portion thereof overlap each other vertically.

The upper guide surface 1522 is formed on one surface of the upper pusher receiving groove 1521. The upper guide surface 1522 is formed on a lower surface of the upper pusher receiving groove 1521. The upper cover pusher 620 is guided along the upper guide surface 1522, and thus, the upper cover pusher 620 is separated from the pusher receiving groove 1521 to the outside.

The slider 630 is spaced apart from the upper cover pusher 620 and installed to be slid on the case 100, and is connected to the lever 610. The slider 630 is moved while being constrained by the lever 610. The slider 630 is installed to be slid on the base case 150. The slider 630 transmits the external force transmitted from the lever 610 to the lower cover pusher 640.

The slider 630 may be accommodated in a lower rotation guide 1530 formed in the case 100. As the slider 630 moves within the lower rotation guide 1530, a movement direction of the slider 630 is guided by the lower rotation guide 1530.

The slider 630 may be positioned below the upper cover pusher 620. The slider 630 may be positioned between the base case 150 and the cover 153. Therefore, there is an advantage that the slider 630 is not visible from the outside in a state where the cover 153 is coupled to the case 100.

A slide slit 1534 is formed in the lower rotation guide 1530. The slide slit 1534 guides the slider 630 and prevents the slider 630 from being separated from the case 100.

The slider 630 may further include a slide holder 631. One end of the slide holder 631 is connected to the slider 630 through the slide slit 1534, and the other end of the slide holder 631 is located inside the base case 150 and has a width wider than a width of the slide slit 1534. Accordingly, even when the slider 630 is moved up and down, the slider 630 is prevented from being separated from the case 100.

The slider 630 and the lever 610 are connected to each other by a connection link 650. One end of the connection link 650 is connected to the holder 611, and the other end of the connection link 650 is connected to the slide holder 631. The connection link 650 is constrained by the movement of the lever 610 and moves together with the lever 610.

The connection link 650 may be located inside the case 100. In the present embodiment, the connection link 650 is located in a space between the inner base case 150a and the outer base case 150b, and may be guided by the inner base case 150a and the outer base case 150b.

The lower cover pusher 640 is rotatably coupled to the slider 630 and is guided to the outer surface of the case 100 to push the cover 153. Accordingly, when an external force is applied to the slider 630, the cover 153 is separated from the case 100 by the lower cover pusher 640.

The lower cover pusher 640 being rotatably coupled to the slider 630 includes the lower cover pusher 640 being hinge-coupled to the slider 630 to be rotated and the lower cover pusher 640 being connected to one end of the slider 630 in a bendable manner to be rotated. In addition, the lower cover pusher 640 being rotatably coupled to the slider 630 includes the lower cover pusher 640 being formed of a flexible material and one end of the lower cover pusher 640 moving in an outer surface direction while the entire lower cover pusher 640 being bent. In the present embodiment, the pusher of the cover 153 is hinge-coupled to a lower end of the slider 630.

The lower cover pusher 640 may be disposed in a coupling region of the base case 150 in which the cover 153 is coupled to the base case 150. Here, the coupling region means a position horizontally overlapping with the cover 153 in the base case 150. The coupling region may be a portion of the base case 150 or may be the entire base case 150.

The lower cover pusher 640 is located between the cover 153 and the base case 150.

When the cover 153 is coupled to the base case 150, the lower cover pusher 640 is not exposed to the outside by the cover 153. The lower cover pusher 640 is located in a lower pusher receiving groove 1531 formed in the base case 150 to be described later.

Accordingly, in a state in which the cover 153 is coupled with the base case 150, the lower cover pusher 640 is covered with the cover 153, and thus, an aesthetic feeling given to the user can be improved. Moreover, since there is no need for a separate space in which the lower cover pusher 640 rotates, there is also an advantage of implementing a slim product.

The lower cover pusher 640 may be positioned below the upper cover pusher 620.

When the lever 610 is operated, the upper and lower portions of the cover 153 are simultaneously separated by the upper cover pusher 620 and the lower cover pusher 640, and thus, the cover 153 is stably separated.

The lower rotation guide 1530 guides the lower cover pusher 640 so that the lower cover pusher 640 rotates in one direction when the lower cover pusher 640 is moved along the outer surface of the base case 150. In addition, the lower rotation guide 1530 accommodates the lower cover pusher 640.

The lower rotation guide 1530 may include a lower guide surface 1532 which has an inclination with respect to the outer surface (outer peripheral surface) of the base case 150 and guides the lower cover pusher 640.

The lower guide surface 1532 may extend in a direction intersecting the up-down direction of the outer peripheral surface of the base case 150. The lower guide surface 1532 may extend in the direction intersecting the up-down direction. Specifically, the lower guide surface 1532 may have an inclination which is not parallel to the outer surface of the base case 150. The lower guide surface 1532 may be inclined downward from the inside of the base case 150 toward the outside thereof.

In this case, a lower surface 641 of the lower cover pusher 640 may be inclined downward from the inside to the outside to correspond to the lower guide surface 1532. Accordingly, when the lower cover pusher 640 moves downward due to interference between the lower surface of the lower cover pusher 640 and the lower guide surface 1532, the lower end of the lower cover pusher 640 protrudes outward.

At least a portion of the lower guide surface 1532 vertically overlaps the upper end of the lower cover pusher 640. At least a portion of the lower guide surface 1532 vertically overlaps the upper end of the lower cover pusher 640 in a state where the cover 153 is coupled.

The lower rotation guide 1530 is formed in the base case 150. Specifically, the lower rotation guide 1530 is disposed in a region horizontally overlapping the cover 153 in the base case 150. Accordingly, when the cover 153 is coupled to the base case 150, the lower rotation guide 1530 is not exposed to the outside by the cover 153.

More specifically, the base case 150 includes the inner base case 150a and the outer base case 150b disposed to surround at least a portion of the inner base case 150a, and the lower guide surface 1532 is formed on the outer surface of the outer base case 150b.

The lower rotation guide 1530 may further include a lower pusher receiving groove 1531 accommodating the lower cover pusher 640. The lower pusher receiving groove 1531 may accommodate a portion of the slider 630 when the slider 630 moves downward.

The lower pusher receiving groove 1531 accommodates the lower cover pusher 640 and the slider 630 when the slider 630 is not operated, and guides movements of the lower cover pusher 640 and the slider 630 when the slider 630 moves downward.

In the present embodiment, the lower pusher receiving groove 1531 is formed by the outer peripheral surface of the outer base case 150b being recessed in the inner direction. That is, the lower pusher receiving groove 1531 is open outward in the outer base case 150b. In addition, the lower pusher receiving groove 1531 is open in the down direction and communicates with the lower portion of the slider 630 receiving groove so as to accommodate and guide the slider 630 when the lever 610 moves downward. The lower pusher receiving groove 1531 and the slider 630 receiving groove are located so that at least a portion thereof overlaps each other vertically.

The lower guide surface 1532 is formed on one surface of the lower pusher receiving groove 1531. The lower guide surface 1532 is formed on a lower side of the lower pusher receiving groove 1531. The lower cover pusher 640 is guided along the lower guide surface 1532, and thus, the lower cover pusher 640 is separated from the pusher receiving groove 1521 to the outside.

The location of the cover separation unit 600 is not limited. Preferably, since it is common for the user to place a rear of the air conditioner 1 toward the wall, the cover separation unit 600 is disposed at the rear of the air conditioner 1.

Specifically, the cover separation unit 600 is disposed at a position where the cover separation unit 600 overlaps at least a portion of the blowing space 105 vertically. The lever 610 is positioned to vertically overlap at least a portion of the blowing space 105. The lever 610 is disposed below the blowing space 105. In addition, the upper cover pusher 620, the lower cover 153 pusher, and the slider 630 may be disposed at positions vertically overlapping the blowing space 105.

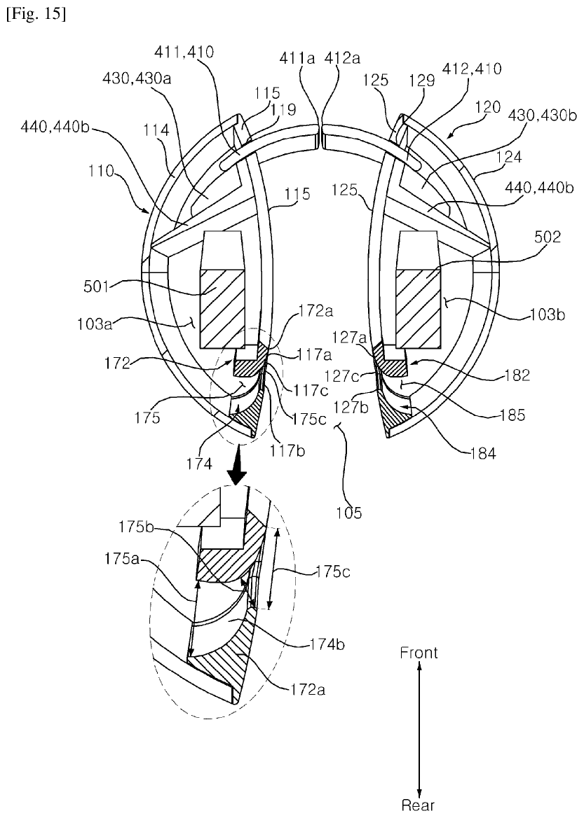

FIG. 14 is a plan cross-sectional view taken along line IX-IX of FIG. 3, and FIG. 15 is a bottom cross-sectional view taken along line IX-IX of FIG. 3.

Referring to FIG. 5, 14 or 15, the first discharge port 117 of the first tower 110 is disposed toward the second tower 120, and the second discharge port 127 of the second tower 120 is disposed toward the first tower (110).

The air discharged from the first discharge port 117 causes air to flow along the inner wall 115 of the first tower 110 through the Coanda effect. The air discharged from the second discharge port 127 causes air to flow along the inner wall 125 of the second tower 120 through the Coanda effect.

The present embodiment further includes a first discharge case 170 and a second discharge case 180.

The first discharge port 117 is formed in the first discharge case 170, and the first discharge case 170 is assembled to the first tower 110. The second discharge port 127 is formed in the second discharge case 180, and the second discharge case 180 is assembled to the second tower 120.

The first discharge case 170 is installed to penetrate the inner wall 115 of the first tower 110, and the second discharge case 180 is installed to penetrate the inner wall 125 of the second tower 120.

A first discharge opening 118 in which the first discharge case 170 is installed is formed in the first tower 110, and a second discharge opening 128 in which the second discharge case 180 is installed is formed in the second tower 120.

The first discharge case 170 forms the first discharge port 117, and includes a first discharge guide 172 which is disposed on an air discharge side of the first discharge port 117, and a second discharge guide 174 which forms the first discharge port 117 and is disposed on a side opposite to the air discharge side of the first discharge port 117.

Outer surfaces 172a and 174a of the first discharge guide 172 and the second discharge guide 174 provide a portion of the inner wall 115 of the first tower 110.

An inside of the first discharge guide 172 is disposed toward the first discharge space 103a, and an outside thereof is disposed toward the blowing space 105. An inside of the second discharge guide 174 is disposed toward the first discharge space 103a, and an outside thereof is disposed toward the blowing space 105.

The outer surface 172a of the first discharge guide 172 may have a curved surface.

The outer surface 172a may provide a surface continuous with the first inner wall 115. In particular, the outer surface 172a forms a curved surface continuous with the outer surface of the first inner wall 115.

The outer surface 174a of the second discharge guide 174 may provide a surface continuous with the first inner wall 115. The inner surface 174b of the second discharge guide 174 may be formed as a curved surface. In particular, the inner surface 174b may form a curved surface continuous with the inner surface of the first outer wall 115, and accordingly, the air in the first discharge space 103a can be guided to the first discharge guide 172 side.

The first discharge port 117 is formed between the first discharge guide 172 and the second discharge guide 174, and air in the first discharge space 103a is discharge to the blowing space 105 blown through the first discharge port 117.

Specifically, air in the first discharge space 103a is discharged between the outer surface 172a of the first discharge guide 172 and the inner surface 174b of the second discharge guide 174, and a gap between the outer surface 172a of the first discharge guide 172 and the inner surface 174b of the second discharge guide 174 is defined as a discharge gap 175. The discharge gap 175 forms a predetermined channel.

The discharge gap 175 is formed so that a width of an intermediate portion 175b is narrower than those of an inlet 175a and an outlet 175c. The intermediate portion 175b is defined as the shortest distance between the second border 117b and the outer surface 172a.

A cross-sectional area gradually narrows from the inlet of the discharge gap 175 to the intermediate portion 175b, and the cross-sectional area increases again from the intermediate portion 175b to the outlet 175c. The intermediate portion 175b is located inside the first tower 110. When viewed from the outside, the outlet 175c of the discharge gap 175 may be viewed as the discharge port 117.

In order to induce the Coanda effect, a curvature radius of the inner surface 174b of the second discharge guide 174 is larger than a curvature radius of the outer surface 172a of the first discharge guide 172.

A center of curvature of the outer surface 172a of the first discharge guide 172 is located in front of the outer surface 172a and is formed inside the first discharge space 103a. A center of curvature of the inner surface 174b of the second discharge guide 174 is located on the side of the first discharge guide 172 and is formed inside the first discharge space 103a.

The second discharge case 180 forms the second discharge port 127 and includes a first discharge guide 182 which is disposed on an air discharge side of the second discharge port 127 and a second discharge guide 184 which forms the second discharge port 127 and is disposed on a side opposite to the air discharge of the second discharge port 127.

A discharge gap 185 is formed between the first discharge guide 182 and the second discharge guide 184. Since the second discharge case 180 is symmetrical right and left with respect to the first discharge case 170, detailed descriptions thereof are omitted.

Meanwhile, the air conditioner 1 may further include an airflow converter 400 which changes the air flow direction in the blowing space 105. The airflow converter 400 is a component which opens the blowing space 105 or closes the blowing space 105 to change the direction of air flowing through the blowing space 105.

Of course, the airflow converter 400 may partially open the blowing space 105 or partially close the blowing space 105 to change the direction of air flowing through the blowing space 105. In the blowing space 105 of the present embodiment, the airflow converter 400 may convert a horizontal airflow flowing through the blowing space 105 into an ascending airflow.

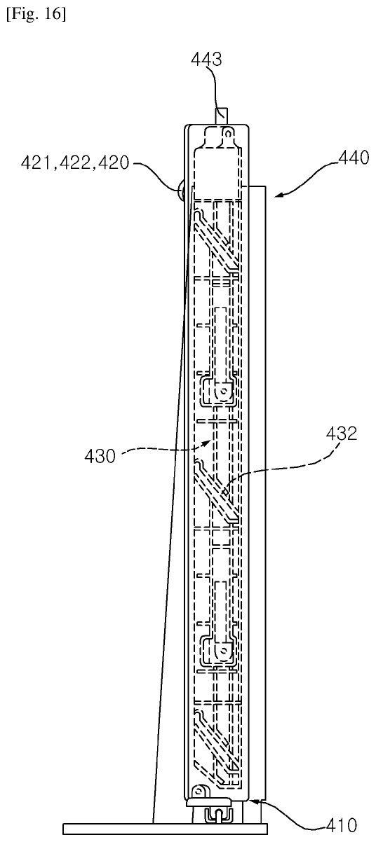

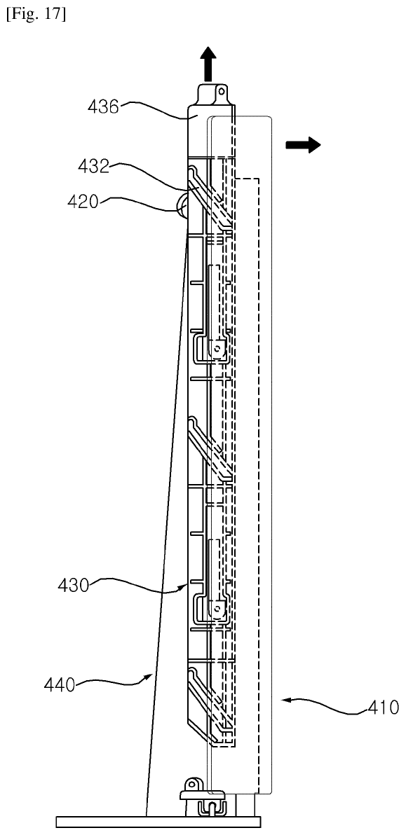

FIGS. 16 and 17 are perspective views of the airflow converter 400. More specifically, FIG. 16 illustrates the airflow converter 400 which opens the front of the blowing space 105 and implements a front discharge airflow. In FIGS. 1 to 6A, the airflow converter 400 is illustrated as a box, and the airflow converter 400 is disposed above the first tower 110 or the second tower 120.

FIG. 17 illustrates the airflow converter 400 which closes the front of the blowing space 105 and implements the ascending airflow, and referring to FIG. 6A, the airflow converter 400 includes a first airflow converter 401 disposed in the first tower 110 and a second airflow converter 402 disposed in the second tower 120. The first airflow converter 401 and the second airflow converter 402 are symmetrical right and left and have the same configuration. Hereinafter, the first airflow converter 401 will be mainly described, and descriptions of the second airflow converter 402 having the same configuration as the first airflow converter 401 will be omitted.

The airflow converter 400 includes a space board 410 which is disposed in the tower case 140 and reciprocates inside the blowing space 105 and the tower case 140, a guide motor 420 which provides a driving force to move the space board 410, and a board guider 430 which is installed in the tower case 140 and guides the movement of the space board 410.

15 to 17, the space board 410 is disposed in at least one of the first tower 110 or the second tower 120, and moves between the inside of the tower and the blowing space 105 to selectively change a discharge area in front of the blowing space 105. The space board 410 is exposed to the front of the blowing space 105 through board slits 119 and 129.

The space board 410 may be concealed inside the tower, and may protrude from the tower when the guide motor 420 is operated to shield the blowing space 105. In the present embodiment, the space board 410 includes the first space boards 410 and 411 disposed in the first tower 110 and the second space boards 410 and 412 disposed in the second tower 120.

For this, referring to FIG. 15, the board slit 119 penetrating through the inner wall 115 of the first tower 110 is formed, and the board slit 129 penetrating through the inner wall 125 of the second tower 120 is formed.

The board slit 119 formed in the first tower 110 is referred to as a first board slit 119, and the board slit formed in the second tower 120 is referred to as a second board slit 129. The first board slit 119 and the second board slit 129 are disposed symmetrically right and left. The first board slit 119 and the second board slit 129 are formed to be elongated in the up-down direction (second direction). The first board slit 119 and the second board slit 129 may be disposed to be inclined with respect to the vertical direction (V).

The front end 112 of the first tower 110 is formed to have an inclination of 3, and the first board slit 119 is formed to have an inclination of 4. The front end 122 of the second tower 120 is formed to have an inclination of 3, and the second board slit 129 is formed to have an inclination of 4.

The space board 410 may be formed in a flat or curved plate shape. The space board 410 may be formed to be elongated in the up-down direction, and may be disposed to be biased forward with respect to the center of the blowing space 105. The space board 410 may include a curved surface which is convex in the radial direction. The space board 410 may block the horizontal airflow flowing into the blowing space 105 and change the direction to the upward direction.

In the present embodiment, an inner end 411a of the first space boards 410 and 411 and an inner end 412a of the second space boards 410 and 412 abut on each other or are close to each other to form an ascending airflow. Unlike the present embodiment, one space board 410 may be in close contact with the opposite tower to form the ascending airflow.

When the airflow converter 400 forms the ascending airflow, the inner end 411a of the first space boards 410 and 411 may close the first board slit 119, and the inner end 412a of the second space boards 410 and 412 may close the second board slit 129.

When the airflow converter 400 forms the horizontal airflow, the inner end 411a of the first space boards 410 and 411 may pass through the first board slit 119 and protrude into the blowing space 105, the inner end 412a of the second space boards 410 and 412 may pass through the second board slit 129 and protrude into the blowing space 105.

In the present embodiment, the first space boards 410 and 411 and the second space boards 410 and 412 protrude into the blowing space 105 by rotating operation. Unlike the present embodiment, at least one of the first space boards 410 and 411 and the second space boards 410 and 412 may be linearly moved in a slide manner and exposed to the blowing space 105. The first space boards 410 and 411 and the second space boards 410 and 412 move along the first direction (horizontal direction).

When viewed from a top, each of the first space boards 410 and 411 and the second space board 410 are formed in an arc shape. Each of the first space boards 410 and 411 and the second space boards 410 and 412 forms a predetermined curvature radius, and the center of curvature thereof is located in the blowing space 105.

When the space board 410 is concealed inside the tower, preferably, a volume inside the space board 410 in the radial direction is larger than a volume outside the radial direction.

The space board 410 may be formed of a transparent material.

The guide motor 420 is a component which provides a driving force to the space board 410. The guide motor 420 is disposed in at least one of the first tower 110 and the second tower 120. The guide motor 420 is disposed above the space board 410.

The guide motor 420 includes a first guide motor 421 for providing a rotational force to the first space boards 410 and 411, and a second guide motor 422 for providing a rotational force to the second space boards 410 and 412.

The first guide motor 421 may be disposed on each of an upper side and a lower side, and when it is necessary to distinguish the first guide motor 421, the first guide motor 421 may be divided into an upper first guide motor 421 and a lower first guide motor 421.

The second guide motor 422 may also be disposed on each of an upper side and a lower side, and it is necessary to distinguish the second guide motor 422, the second guide motor 422 may be divided into an upper second guide motor 422 and a lower second guide motor 422.

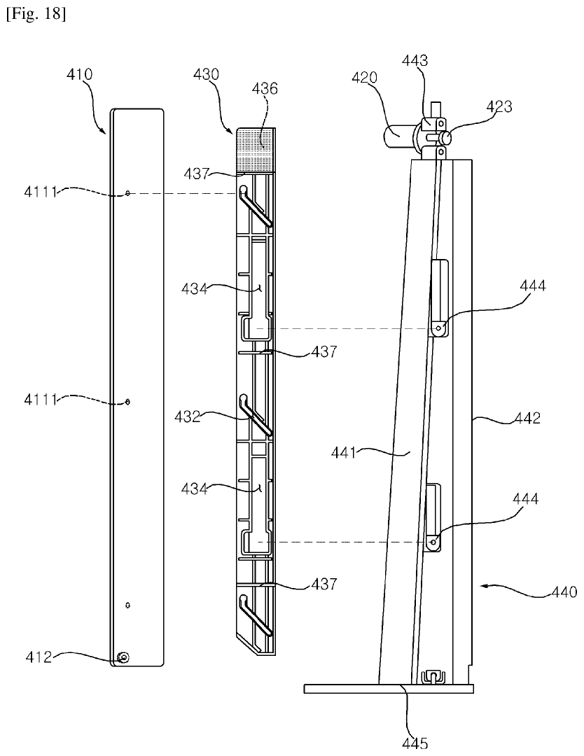

In particular, referring to FIG. 18, the guide motor 420 may be fastened to the tower case 140. The tower case 140 may include a guide body 440 on which the guide motor 420 is installed. In the present embodiment, the guide motor 420 is fastened to the guide body 440. The guide body 440 may be integrally formed with the tower case 140, or may be configured separately for convenience of assembly.

A pinion gear 423 is shaft-coupled to the guide motor 420. The pinion gear 423 is coupled to a shaft (not illustrated) of the guide motor 420. When the guide motor 420 is operated, the pinion gear 423 rotates.

A rotation axis of the pinion gear 423 may be disposed in a direction intersecting the length direction of the space board 410. Preferably, the rotation axis of the pinion gear 423 is disposed parallel to the horizontal direction.

The pinion gear 423 is gear-coupled to a rack 436 formed on the board guider 430.

When the pinion gear 423 rotates in the horizontal direction, the rack 436 moves up and down, and the board guide 430 connected to the rack 436 is raised and lowered.

The board guider 430 is a component which transmits the driving force of the guide motor 420 to the space board 410. The board guider 430 is disposed in front of the guide motor 420 and disposed behind the space board 410. The board guider 430 is connected to the space board 410 and moves in a direction intersecting the moving direction of the space board 410. The board guider 430 is raised or lowered in the up-down direction.

The board guider 430 disposed in the first tower 110 is defined as a first board guider 430a, and the board guider 430 disposed in the second tower 120 is defined as a second board guider 430b.

The board guider 430 may be disposed parallel to the space board 410. The board guider 430 may be disposed in parallel with the first board slit 119 or the second board slit 129.

A front surface of the board guider 430 may have a curved surface. The front surface of the board guider 430 is adjacent to a rear surface of the space board 410. When the rear surface of the space board 410 is formed in an arc shape, the front surface of the board guider 430 is formed in a curved surface so that the space board 410 may slide along the front surface of the board guider 430.

The rear surface of the board guider 430 may have a flat surface. The rear surface of the board guider 430 is adjacent to the front surface of an airflow converter first cover 441. The board guider 430 may slide along the airflow converter first cover 441.

An upper end of the board guider 430 is disposed above the space board 410. When a plate shielding the guide motor 420 from the discharge spaces 103a and 103b is formed, the upper end of the space board 410 may be disposed lower than the plate, and the upper end of the board guider 430 may be disposed above the plate.

The board guider 430 may have a first slit 432 formed therein. A first protrusion 4111 of the space board 410 is inserted into the first slit 432, and thus, moves the space board 410 when the board guider 430 moves.

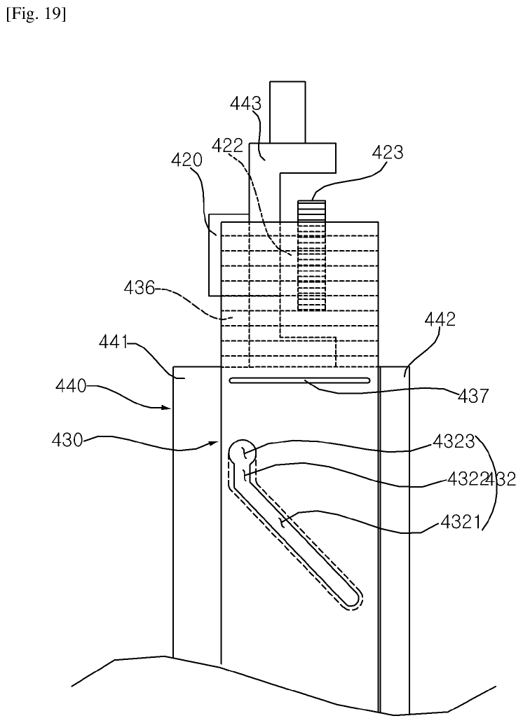

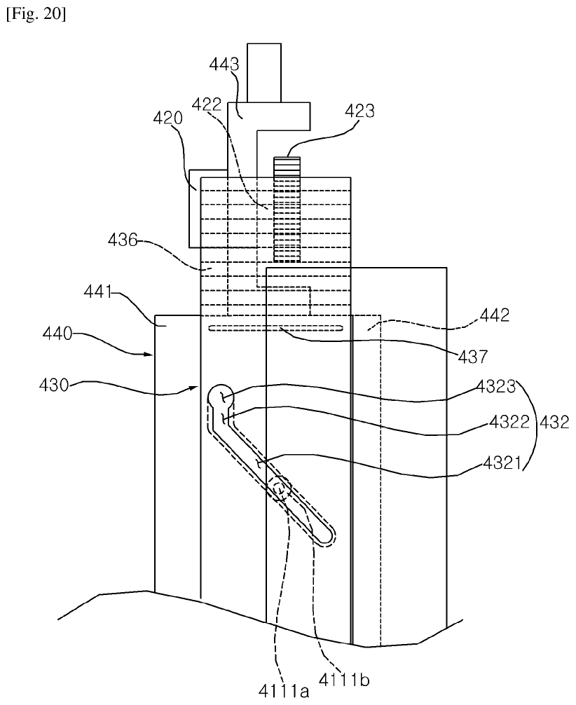

Referring to FIGS. 19 and 20, the first slit 432 is formed by opening the board guide 430 to guide the movement of the space board 410. The first protrusion 4111 is formed to protrude from one side of the space board 410, and at least a portion of the first protrusion 4111 is inserted into the first slits 43, and slides along the first slits 432.

A left end (refer to FIG. 19) of the first slit 432 is disposed close to a left end of the board guide 430, and a right end of the first slit 432 is disposed at a right end of the board guide 430.

In the first slit 432, a portion relatively close to the blowing space 105 may have a height lower than that of a portion relatively far from the blowing space 105. Specifically, the lower end of the first slit 432 is disposed closer to the blowing space 105 than the upper end of the first slit 432. For example, referring to FIG. 19, the lower end of the first slit 432 formed on the first board guides 430 and 430a is disposed on a right side of the upper end of the first slit 432. Likewise, although not illustrated, the lower end of the second slits 434 formed on the second board guides 430 and 430b is disposed on a left side of the upper end of the second slits 434.

The first slit 432 includes a slit inclined portion 4321. The slit inclined part 4321 may include an inclination downwardly inclined toward the blowing space 105. For example, referring to FIG. 19, the first slits 432 formed on the first board guide 430a are inclined downward in a right direction. Likewise, although not illustrated, the first slits 432 formed on the second board guider 430b are inclined downward in a left direction. Preferably, the slit inclined portion 4321 may have an inclination angle of 40 to 60 based on the vertical direction.

When the slit inclined part 4321 is inclined downward in a direction of the blowing space 105, a detent torque of the guide motor 420 generated due to the own weight of the space board 410 in a state where power of the guide motor 420 is turned off is reduced.

A position of the slit inclined portion 4321 of the first slit 432 is moved up and down as the board guider 430 is raised or lowered. When the board guider 430 is raised, the first protrusion 4111 is directed toward the lower end of the slit inclined portion 4321 of the first slit 432. Conversely, when the board guider 430 is lowered, the first protrusion 4111 is directed toward the upper end of the slit inclined portion 4321 of the first slit 432.

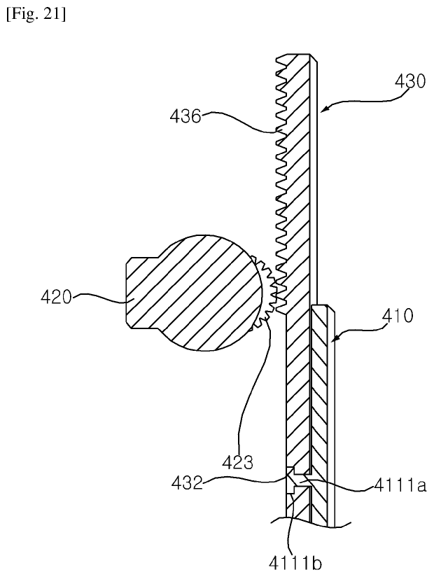

Referring to FIGS. 19 and 21, the slit inclined portion 4321 of the first slit 432 may form a stepped portion. The slit inclined portion 4321 of the first slit 432 may have a width of a front end smaller than that of a rear end.

When the width of the front end is smaller than the width of the rear end, when the first protrusion 4111 moves along the slit inclined portion 4321, separation of the first protrusion 4111 is prevented.

The first protrusion 4111 forms a locking stepped portion 4111b to correspond to the stepped portion of the slit inclined portion 4321 of the first slit 432. That is, the locking stepped portion 4111b of the first protrusion 4111 is disposed at the rear end of the slit inclined portion 4321 of the first slit 432. Accordingly, the first protrusion 4111 is not separated from the slit inclined portion 4321 of the first slit 432.

The first slits 432 include a vertical portion 4322. A lower end of the vertical portion 4322 is connected to an upper end of the slit inclined portion 4321. The vertical portion 4322 extends in the length direction (vertical direction) of the board guider 430.

The vertical portion 4322 of the first slit 432 functions as a stopper. That is, the maximum upward movement distance of the first protrusion 4111 is the upper end of the slit inclined portion 4321, and thus, the first protrusion 4111 does not slide along the vertical portion 4322.

The vertical portion 4322 of the first slits 432 may form a stepped portion. In the vertical portion 4322 the first slits 432, a width of a front end may be narrower than a width of a rear end. The first protrusion 4111 forms a locking stepped portion 4111b to correspond to the stepped portion of the vertical portion 4322 of the first slit 432. That is, the locking stepped portion 4111b of the first protrusion 4111 is disposed at the rear end of the vertical portion 4322 of the first slit 432. Accordingly, the first protrusion 4111 is not separated from the slit inclined portion 4321 of the first slit 432.

The first slit 432 includes a first protrusion insertion portion 4323 which is disposed at the upper end of the vertical portion 4322 and through which the first protrusion 4111 is inserted into the first slit 432.

The first protrusion insertion portion 4323 may be formed in a shape corresponding to a cross-sectional shape of the first protrusion 4111. A diameter of the first protrusion insertion portion 4323 may be larger than a diameter of the first protrusion 4111. More specifically, the diameter of the first protrusion insertion portion 4323 is larger than a diameter of the locking stepped portion 4111b of the first protrusion.

The first protrusion 4111 is inserted into the first protrusion insertion portion 4323.

The first protrusion 4111 descends along the vertical portion 4322 and the space board 410 is fastened to the board guider 430. The first protrusion 4111 slides down or slides up along the slit inclined portion 4321, and the space board 410 moves.

A plurality of first slits 432 may be formed. Three first slits 432 are formed in the board guider 430. A second slit 434 is formed between the first slits 432. The number of the first slits 432 is not limited, and may be changed within a range which can be easily adopted by a person skilled in the art.

Referring to FIG. 18, the second slit 434 may be formed on the board guider 430.

The second slit 434 extends in the length direction (vertical direction) of the board guider 430. The second slit 434 is formed by opening the board guider 430 in the horizontal direction.

The second slit 434 is disposed between one first slits 432 and the other first slits 432. The second slits 434 and the first slits 432 are alternately disposed. By disposing the second slits 434 and the first slits 432 alternately, a force may be distributed and a bending stress of the board guider 430 may be canceled.

A body protrusion 444 of the guide body 440 is inserted into the second slit 434, and the board guide 430 slides along the body protrusion 444.

The body protrusion 444 of the guide body 440 protrudes in a direction intersecting the length direction of the guide body 440. Specifically, the body protrusion 444 protrudes from the guide body 440 in the horizontal direction.

More specifically, the body protrusion 444 is formed on a front surface of the first cover 441. The body protrusion 444 is formed to protrude forward from the first cover 441. The body protrusion 444 has a side surface extending in the length direction of the first tower 110 or the second tower 120. Referring to FIG. 18, the body protrusion 444 extends in the up-down direction.

The board guider 430 may have the rack 436 formed therein. The rack 436 is connected to the pinion gear 423 to move the board guider 430 when the guide motor 420 is operated. The rack 436 transmits the rotational force of the guide motor 420 to the board guider 430 in a linear motion. The rack 436 is disposed on a surface of the board guider 430 opposite to a surface facing the space board 410. Specifically, the rack 436 may be disposed on a rear surface of an upper portion of the board guider 430.

The airflow converter 400 includes the guide motor 420, and the guide body 440 in which the board guide 430 is installed. The guide body 440 is disposed behind the board guider 430. The guide body 440 includes the first cover 441, a second cover 442, and a motor support plate 443.

The first cover 441 supports a rear surface of the board guider 430 and guides the sliding of the board guider 430. A left end of the first cover 441, that is, an outer end of the first cover 441 is disposed on the outer wall of the first tower 110. A right end of the first cover 441, that is, an inner end of the first cover 441 is disposed on the inner wall of the first tower 110.

The outer end of the second cover 442 is in contact with the inner surface of the board guider 430. Accordingly, the board guider 430 may slide along the outer surface of the second cover 442. The motor support plate 443 is disposed on an upper end of the first cover 441, and one surface of the plate 443 supports the guide motor 420 and the other side thereof supports the board guide 430.

The motor support plate 443 may be formed to protrude upward from the upper end of the first cover 441. The motor support plate 443 is disposed on an outer side of the second cover 442. An upper end of the motor support plate 443 is disposed above the motor. More specifically, the upper end of the motor support plate 443 is disposed above the pinion gear 423.

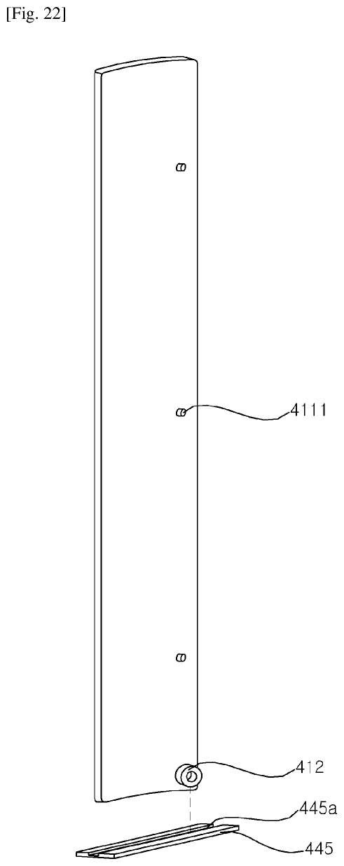

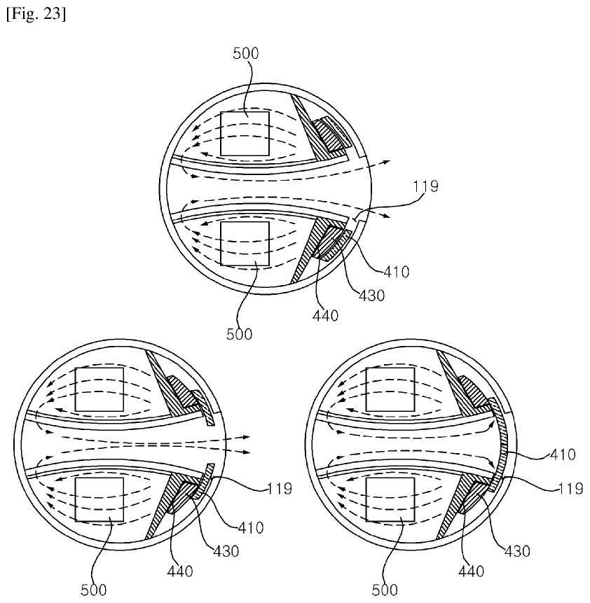

As illustrated in FIG. 22, the guide body 440 may include a rail 445 which guides a roller 412 to be described later.

The first protrusion 4111 is formed on the space board 410. More specifically, the first protrusion 4111 is formed on the rear surface of the space board 410. Referring to FIG. 22, a first protrusion 4111 is formed adjacent to one end of the space board 410 in the width direction. However, the present invention is not limited thereto, and the position of the first protrusion 4111 may be changed within a range which can be easily adopted by a person skilled in the art.

The first protrusion 4111 may form the locking stepped portion 4111b. Referring to FIG. 21, the locking stepped portion 4111b of the first protrusion is formed to protrude radially outward from an end portion of the first protrusion 4111. The locking stepped portion 4111b of the first protrusion is caught by the stepped portion of the slit inclined portion 4321 or the vertical portion 4322 of the first slit 432, and thus, is not separated.

When the board guider 430 and the first slit 432 is raised or lowered, the first protrusion 4111 and the space board 410 is introduced or protrude. When the board guider 430 is raised, the first protrusion 4111 is located at the lower end of the slit inclined portion 4321 of the first slit 432. When the first protrusion 4111 is located at the lower end of the slit inclined portion 4321, the space board 410 moves in the circumferential direction, and is introduced into the tower case 140 through the first board slit 119. When the board guider 430 is lowered, the first protrusion 4111 is located at the upper end of the slit inclined portion 4321 of the first slit 432. When the first protrusion 4111 is located at the upper end of the slit inclined portion 4321, the space board 410 moves in the circumferential direction, and protrudes outward of the tower case 140 through the first board slit 119.

The board guider 430 includes a second slits 434 formed through one side. The guide body 440 is formed to protrude from one side, and includes the body protrusion 444 in which at least a portion of the guide body 440 is inserted into the second slits 434.

Referring to FIG. 18, the airflow converter 400 includes a friction reduction protrusion 437 which separates the board guider 430 and the space board 410 from each other to prevent a surface contact. The friction reduction protrusion 437 separates the space board 410 and the board guider 430 from each other in the horizontal direction.

The friction reduction protrusion 437 may be formed in at least one of the board guider 430 and the space board 410. The friction reduction protrusion 437 may protrude in the horizontal direction from the board guider 430 and the space board 410. Hereinafter, a description will be made based on the fact that the friction reduction protrusion 437 is formed on the board guide 430, but this description may be applied as it is to the friction reduction protrusion 437 formed on the space board 410.

The friction reducing protrusion 437 is formed on the board guide 430, protrudes from a surface facing the space board 410, and may come into contact with the space board 410. Specifically, the friction reduction protrusion 437 is formed to protrude forward from a front surface 438 which is the surface facing the space board 410 in the board guide 430.

As another example, the friction reducing protrusion 437 is formed on the space board 410, protrudes from a surface facing the board guide 430, and may come into contact with the space board 410. Specifically, the friction reduction protrusion 437 is formed to protrude rearward from the rear surface facing the board guide 430 in the space board 410.

Since the space board 410 reciprocates in the horizontal direction (first direction), the friction reduction protrusion 437 extends in the first direction. That is, the friction reduction protrusion 437 has the longest length in the first direction. A width of the friction reduction protrusion 437 in the second direction (vertical direction) is smaller than the length of the friction reduction protrusion 437 in the first direction, and is smaller than the width of the board guider 430. If the width of the friction reduction protrusion 437 is too wide, the friction reduction effect cannot be expected, and thus, preferably, the width is 5 mm or less.

Therefore, the friction reduction protrusion 437 reduces the friction between the space board 410 and the board guider 430 which moves in the first direction. However, if only one friction reduction protrusion 437 is disposed, the movement of the space board 410 becomes unstable. Accordingly, a plurality of friction reduction protrusions 437 are disposed in a second direction intersecting the first direction. More preferably, three friction-reducing protrusions 437 may be disposed on upper, intermediate, and lower portions of the board guider 430.

Referring to FIGS. 18 and 22, the airflow converter 400 may further include the roller 412 which separates the tower case 140 and the space board 410 from each other to prevent the surface contact between the tower case 140 and the space board 410.

The roller 412 may be installed in any one of the tower case 140 and the space board 410. In the present embodiment, the roller 412 is installed in the space boards 410. The roller 412 may be located in a lower portion of the space board 410. A rotation axis of the roller 412 may extend in the horizontal direction. More specifically, the rotation axis of the roller 412 extends in the front-rear direction.

The roller 412 is installed on the lower portion of the rear surface of the space board 410, and the roller 412 is supported by the upper surface of the tower case 140. The roller 412 slides the tower case 140 while supporting the weight of the space board 410. Specifically, the roller 412 is supported by the guide body 440 of the tower case 140. The roller 412 may guide the guide body 440 by the rail 445.

When the roller 412 moves in the tower case 140 while supporting the space board 410 in the vertical direction, the roller 412 can reduce the friction between the tower case 140 and the space board 410 while supporting the weight of the space board 410. In addition, the roller 412 stably maintains the space board 410 when the space board 410 moves.

In particular, even when the space board 410 protrudes toward the blowing space 105, the roller 412 can be disposed to be biased to one side in the width direction of the space board 410 so that the roller 412 is supported by the tower case 140. Specifically, the roller 412 may be located at one end far from the blowing space 105 side of both ends in the width direction of the space board 410.

Although not illustrated in the drawings, the airflow converter 400 may further include a guide pin which separates the tower case 140 and the space board 410 and is provided in any one of the tower case 140 and the space board 410.

The guide pin may be installed on one of the tower case 140 and the space board 410.

In the present embodiment, the guide pin is installed on the space board 410. The guide pin may be located in a lower portion of the space board 410. The guide pin is formed in a circular column extending in the horizontal direction. The guide pin extends in the front-rear direction.

When the guide pin slides on the tower case 140 while supporting the space board 410 in the vertical direction, it is possible to reduce the friction between the tower case 140 and the space board 410 while supporting the weight of the space board 410. The guide pin may be located at one end far from the blowing space 105 side of both ends of the space board 410 in the width direction.

The airflow converter 400 is disposed in front of the first discharge port 117 or the second discharge port based on the air discharge direction. Air is discharged forward from the first discharge port 117 or the second discharge port. As air passes through the first inner wall 115 or the second inner wall 125, the Coanda effect is generated. The airflow converter 400 is disposed in the first inner wall 115 or the second inner wall 125 to selectively change the wind direction. The airflow converter 400 may generate wide-area wind, concentrated wind, or ascending airflow according to a degree of protrusion.

A driving method of the airflow converter 400 is as follows.

Referring to FIGS. 16 and 17, when the guide motor 420 is operated, the pinion gear 423 rotates, the rack 436 meshing with the pinion gear 423 moves, and the board guider 430 is raised or lowered.

When the board guider 430 is raised, the positions of the first slits 432 and the second slits 434 also increase. The second slits 434 slide downward along the body protrusion 444. As the position of the first slit 432 increases, the first protrusion 4111 gradually moves to the right, and the space board 410 passes through the board slit and protrudes into the blowing space 105.

That is, the blowing space 105 is closed by the space board 410. The air discharged through the blowing space 105 forms an ascending airflow.

When the board guider 430 is lowered, the positions of the first slits 432 and the second slits 434 also decrease. The second slits 434 is raised slidably along the body protrusion 444. As the position of the first slit 432 decreases, the first protrusion 4111 gradually moves to the left, and the space board 410 is introduced into the tower case 140 through the board slit. That is, the blowing space 105 is opened by the space board 410. The air discharged through the blowing space 105 is discharged forward and spreads to the left and right to form the wide-area wind.

When the board guider 430 is raised or lowered and is located in the intermediate, the space board 410 penetrates the board slit to close a portion of the blowing space 105. That is, the blowing space 105 is partially opened by the space board 410. The air discharged through the blowing space 105 is intensively discharged forward to form the concentrated wind.

Referring to FIGS. 14 and 15, the first tower 110 is disposed toward the blowing space 105 and includes the first inner wall 115 on which the first discharge port 117 is formed. The second tower 120 is disposed toward the blowing space 105 and includes the second inner wall 125 on which the second discharge port is formed. The heater 500 is disposed to be spaced apart from the inner surface of at least one of the first inner wall 115 and the second inner wall 125. A space through which air can flow is formed between the heater 500 and the first inner wall 115, and air flows in the space. A space through which air can flow is formed between the heater 500 and the second inner surface, and air flows in the space. Air flows between the heater 500 and the inner surface, and thus, forms a wall of air. Therefore, the heat emitted from the heater 500 cannot be transferred to the first inner wall 115 or the second inner wall 125, and thus, the first inner wall 115 and the second inner wall 125 are prevented from being overheated.

Referring to FIGS. 14 and 15, the first tower 110 includes the first outer wall 114 formed on the outer side of the first inner wall 115. The second tower 120 includes the second outer wall 124 formed on the outer side of the second inner wall 125. The heater 500 is disposed to be spaced apart from the inner surface of the first outer wall 114 or the second outer wall 124. A space through which air can flow is formed between the heater 500 and the inner surface of the first outer wall 114, and the air flows in the space. A space through which air can flow is formed between the heater 500 and the inner surface of the second outer wall 124, and air flows in the space. Air flows between the heater 500 and the inner surface of the outer wall, and thus, forms a wall of air. Therefore, the heat emitted from the heater 500 cannot be transferred to the first outer wall 114 or the second outer wall 124, and thus, the first outer wall 114 and the second outer wall 124 are prevented from being overheated.

Referring to FIGS. 14 and 15, the heater 500 is disposed closer to the first inner wall 115 than the first outer wall 114. The heater 500 is disposed closer to the second inner wall 125 than the second outer wall 124. Air discharged from the first discharge port 117 flows through the first inner wall 115 at a high speed, and air discharged from the second discharge port flows through the second inner wall 125 at a high speed. As air flows to the first inner wall 115 and the second inner wall 125 at a high speed, forced convection is generated, and the first inner wall 115 and the second inner wall 125 can be cooled more quickly. However, air flows to the first outer wall 114 and the second outer wall 124 at a slow speed due to the indirect Coanda effect. Accordingly, a cooling rate of the first outer wall 114 is slower than that of the first inner wall 115, and a cooling rate of the second outer wall 124 is slower than that of the second inner wall 125. Therefore, by disposing the heater 500 closer to the first inner wall 115 or the second outer wall 124, overheating of the tower case 140 can be more efficiently prevented.

Referring to FIG. 5, the lower end of the heater 500 is disposed closer to a rear lower end of the first tower 110 or the second tower 120 than a front lower end thereof. Therefore, a cross-sectional area of the discharge space 103 is larger in the lower portion than in the upper portion.

The amount of air flowing from the lower end of the first tower or the second tower 120 is maximum, and as it goes to the upper portion, the air passes through the heater 500 and is discharged into the blowing space 105, and the amount of air flowing to the upper end of the first tower 110 or second tower 120 is minimal. The lower end of the heater 500 may be disposed closer to the rear lower end than the front lower end of the first tower 110 or the second tower 120 to form a discharge space 103 suitable for the air flow rate. Therefore, it is possible compensate for a pressure difference to prevent a pressure loss and improve efficiency.

The heater 500 further includes a flow path shielding member 540 for shielding air from flowing between the heat-radiating pin 530 and the first discharge port 117 or the second discharge port. Referring to FIG. 5, the flow path shielding member 540 is disposed at the lower end of the heater 500 and extends toward the lower end of the first discharge port 117 or the second discharge port.

The flow path shielding member 540 is disposed inside the tower case 140. A lower end of the flow path shielding member 540 is disposed above the suction grill.

The flow path shielding member 540 is inclined so that a rear end thereof is disposed above a front end thereof.

The flow path shielding member 540 extends to the rear end of the first tower 110 or the second tower 120.

The lower end of the first discharge port 117 or the second discharge port is disposed above the flow path shielding member 540.

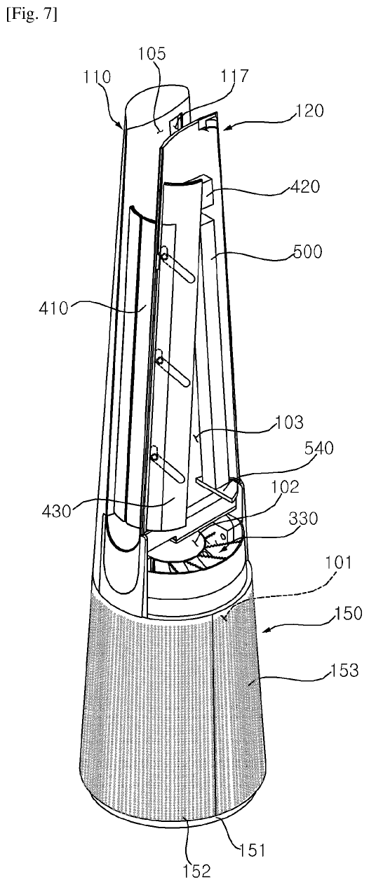

As illustrated in FIG. 7, the flow path shielding member 540 extends to the left or right from the front end of the lower horizontal plate 513 and extends to the rear. Therefore, the flow path shielding member 540 may be formed in a semicircular shape. Alternatively, the flow path shielding member 540 may be formed to have the same width as that of the lower horizontal plate 513 as illustrated in FIG. 5, and may extend to the rear end.

The flow path shielding member 540 prevents the air flowing through the first discharge space 103a or the second discharge space 103b from being directly discharged to the first discharge port 117 or the second discharge port without passing through the heater 500. More specifically, the flow path shielding member 540 shields the rear lower end, the left lower end, and the right lower end of the heater 500, and the inner surface of the first tower 110, and the rear lower end, the left lower end, and the right lower end of the heater 500, and the inner surface of the second tower 120. Accordingly, the air flow directly discharged from the rear lower end, the left lower end, and the right lower end of the heater 500 to the first discharge port 117 or the second discharge port is blocked, and thus, efficiency is improved.

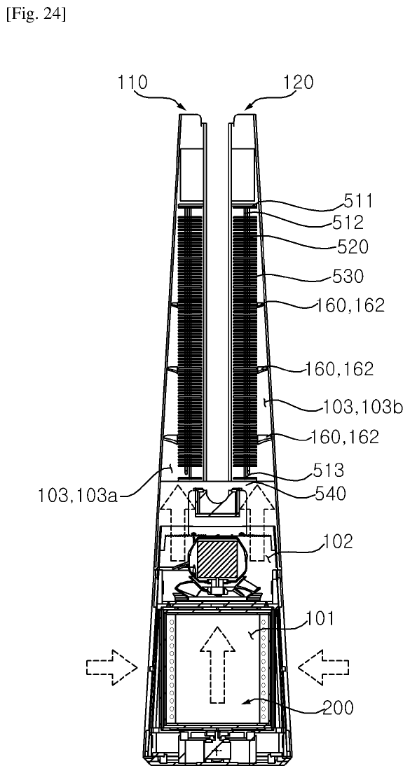

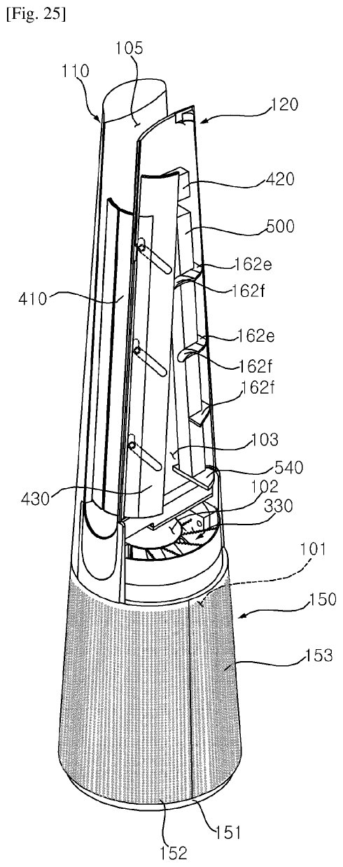

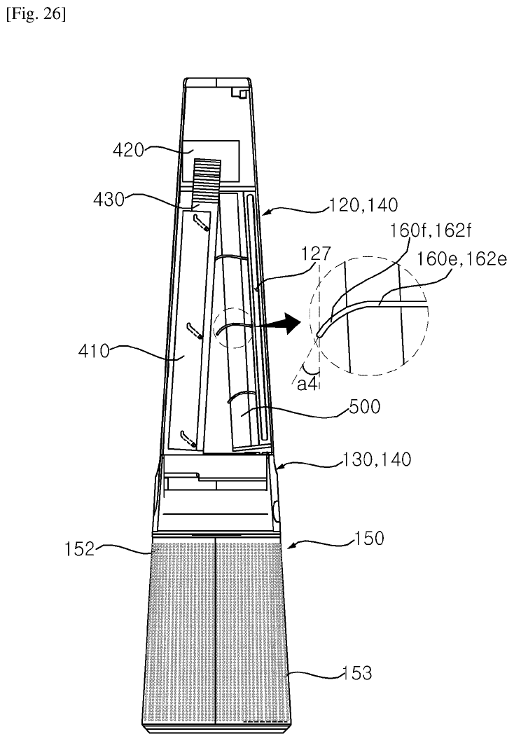

An air conditioner according to another embodiment of the present disclosure with reference to FIGS. 24 to 26 may further include an air guide 160 for guiding air of which the direction has been changed to the first discharge port 117 or the second discharge port in addition to the heater 500.

The air guide 160 is a component for converting the flow direction of air in the discharge space 103 to the horizontal direction. A plurality of air guides 160 may be disposed.

The air guide 160 converts the air flowing from the lower side to the upper side in the horizontal direction, and the converted air flows to the discharge ports 117 and 127.

When it is necessary to distinguish the air guide 160, the air guide disposed inside the first tower 110 is referred to as a first air guide 161, and the air guide disposed inside the second tower 120 is referred to as a second air guide 162.

An outer end of the first air guide 161 is coupled to the outer wall of the first tower 110. An inner end of the first air guide is adjacent to the first heater 501.

The first air guide 161 has a front end close to the first discharge port 117. The front end of the first air guide may be coupled to the inner wall adjacent to the first discharge port 117. A rear end of the first air guide is spaced apart from the rear end of the first tower 110.

In order to guide the air flowing from the lower side to the first discharge port 117, the first air guide 161 is formed in a curved surface convex from the lower side to the upper side, and the rear end of the first air guide 161 is disposed lower than the front end thereof.

The first air guide 161 may be divided into a curved portion 161f and a flat portion 161e.

The rear end of the flat portion 161e of the first air guide 161 is close to the first discharge guide. The flat portion 160e of the first air guide may extend forward, and more specifically, may extend horizontally with respect to the ground.

The rear end of the curved portion 161f of the first air guide is disposed on the flat portion of the first air guide. The curved portion 160f of the first air guide extends forward and downward while forming a curved surface. The front end of the curved portion 160f of the first air guide is disposed lower than the rear end thereof. The front end and the rear end of the curved portion 160f of the first air guide may have a horizontal distance of 10 mm to 20 mm from the ground. The horizontal distance between the front and rear ends of the curved portion 160f of the first air guide from the ground is defined as a curvature length. That is, the curvature length of the curved portion of the first air guide may be between 10 mm and 20 mm.

An entrance angle a4 of the front end of the curved portion 160f of the first air guide may be 10. The entrance angle a4 is defined as an angle between a vertical line with respect to the ground and a tangent line of the front end of the curved portion 160f of the first air guide.

At least a portion of the right end of the first air guide 161 is adjacent to the outside of the heater 500, and the remaining portion is coupled to the inner wall of the first tower 110. The left end of the first air guide 161 may be in close contact with or coupled to the outer wall of the first tower 110.

Accordingly, the air moving upward along the discharge space 103 flows from the rear end of the first air guide 161 to the front end thereof. In other words, the air which has passed through the fan device 300 is raised and flows to the rear by being guided by the first air guide 161.

The second air guide 162 is symmetrical right and left with the first air guide 161.

An outer end of the second air guide 162 is coupled to the outer wall of the second tower 120. An inner end of the second air guide 162 is adjacent to the second heater 502.

The second air guide 162 has a front end close to the second discharge port 127. The front end of the second air guide 162 may be coupled to an inner wall adjacent to the second discharge port. A rear end of the second air guide 162 is spaced apart from the rear end of the second tower 120.

In order to guide the air flowing from the lower side to the second discharge port 127, the second air guide 162 is formed in a convex curved surface from the lower side to the upper side, and the rear end of the second air guide 162 is disposed lower than the front end thereof.

The second air guide 162 may be divided into a curved portion 162f and a flat portion 162e.

The rear end of the flat portion 162e of the second air guide is close to the second discharge guide. The flat portion of the second air guide may extend forward, and more specifically, may extend horizontally with respect to the ground.

The rear end of the curved portion 162f of the second air guide is disposed on the front end of the flat portion 162e of the second air guide. The curved portion 162f of the second air guide extends forward and downward while forming a curved surface. The front end of the curved portion 162f of the second air guide is disposed lower than the rear end. The front end and the rear end of the curved portion 162f of the second air guide may have a horizontal distance of 10 mm to 20 mm from the ground. The horizontal distance between the front and rear ends of the curved portion 162f of the second air guide from the ground is defined as a curvature length. That is, the curvature length of the curved portion 162f of the second air guide may be between 10 mm and 20 mm.

The entrance angle a4 of the front end of the curved portion 162f of the second air guide may be 10. The entrance angle (a4) is defined as an angle between the vertical line with respect to the ground and the tangent line of the front end of the curved portion of the second air guide.

At least a portion of the left end of the second air guide 162 is adjacent to the outside of the second heater 502, and the remaining portion is coupled to the inner wall of the second tower 120. The right end of the second air guide 162 may be in close contact with or coupled to the outer wall of the second tower 120.

Accordingly, the air moving upward along the discharge space 103 flows from the rear end of the second air guide 162 to the front end thereof. In other words, the air which has passed through the fan device 300 is raised and flows to the rear by being guided by the second air guide 162.

When the air guide 160 is installed, the direction of the air ascending in the vertical direction is changed in the horizontal direction. Accordingly, there is an advantage in that air having a uniform flow rate can be discharged from the air discharge port formed to be elongated up and down. In addition, there is an effect that air can be discharged horizontally.

When the entrance angle a4 of the air guide 160 is large or the curvature length is long, there is a problem that the air guide 160 is a resistance to the air ascending in the vertical direction and noise increases. Conversely, if the curvature length of the air guide is short, the air guide does not serve to guide air and cannot discharge air horizontally. Therefore, when the air guide is disposed at the entrance angle a4 or formed with the curvature length according to the present disclosure, there is an effect of increasing air volume and reducing noise.

FIGS. 33 and 34 are graphs for explaining a difference in effect between the air guide according to the present disclosure and the related art.

FIG. 33 illustrates the air volume discharged compared to the rotational speed of the fan according to the inlet angle a4 of the air guide. Although not mentioned in FIG. 33, the curvature length of the curved portion of the air guide may affect the air volume. There is no large difference when the rotational speed of the fan is low. However, when the rotational speed of the fan increases, a difference in the discharged air volume between the example and the comparative example appears. For example, when the rotation speed of the fan is 2500 RPM, the flow rate discharged from the air purifier according to the prior art is about 13.4CMM, but the flow rate discharged from the air purifier having the air guide according to the present disclosure is approximately 14CMM. According to the present disclosure when the fan is based on the same RPM, the air volume is increased by about 4% compared to the related art.

FIG. 34 illustrates the noise generated compared to the air volume of the fan according to the inlet angle a4 of the air guide. Although not mentioned in FIG. 34, the curvature length of the curved portion of the air guide may affect the noise. There is no large difference when the discharged air volume is low. However, when the air volume increases, there is a difference in the noise generated. For example, when the air volume is 10.0CMM, the noise generated by the air purifier according to the related art is about 40.5 dB, but the noise generated by the air purifier having the air guide according to the present disclosure is about 40 dB. Based on the same air volume, according to the present disclosure, there is an effect of reducing the generated noise by about 0.5 dB compared to the related art.

The airflow converter 400 may be disposed above the heater 500. More specifically, the guide motor 420 may be disposed above the heater 500. The guide motor 420 generates the driving force, the space board 410 changes the discharged air, and the board guider 430 transmits the driving force of the guide motor 420 to the space board 410. The space board 410 and the board guider 430 may be disposed in front of the heater 500, but the guide motor 420 is disposed above the heater 500. Accordingly, a space can be efficiently utilized, and the guide motor 420 is prevented from interfering with the air flow inside the discharge space 103. The guide motor 420 is a component which generates heat, and has a disadvantage in that the guide motor 420 is vulnerable to heat. Accordingly, by disposing the guide motor 420 above the heater 500, the guide motor 420 is not disposed on the air flow path, and convection of the heat of the heater 500 to the guide motor 420 can be prevented.

Hereinafter, the air flow flowing around the heater viewed from the top will be described with reference to FIG. 24. The air passing through the fan device 300 ascends in front of the heater. The flow direction of the air ascending from the front of the heater is changed to the rear. Most of the air is heated through the heater, and warm air is discharged into the blowing space. Some air flows through the space between the heater and the outer walls 114 and 124. This air forms an air curtain between the heater and the outer wall, and prevents the convection of the heat from the heater to the outer wall. Some other air flows into the space between the heater and the inner wall. This air forms an air curtain between the heater and the inner wall, and prevents the convection of the heat from the heater to the inner wall.

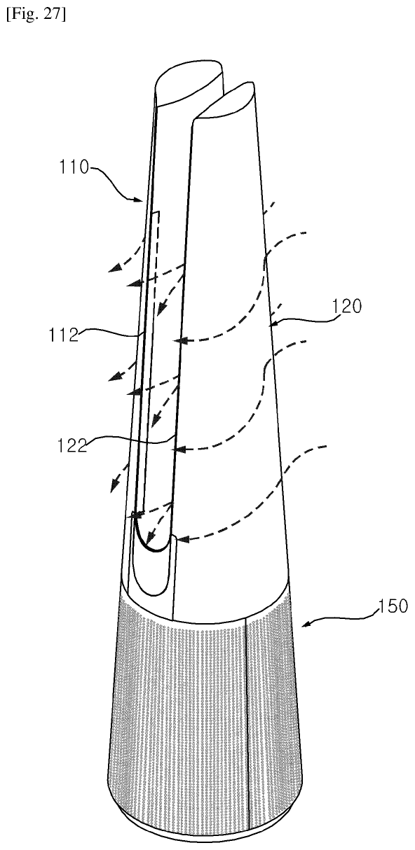

FIG. 27 is an exemplary diagram illustrating the horizontal airflow of the air conditioner according to the first embodiment of the present disclosure.

Referring to FIG. 27, when the horizontal airflow is provided, the first space board 411 is concealed inside the first tower 110, and the second space board 412 is concealed in the second tower 120.

The discharged air of the first discharge port 117 and the discharged air of the second discharge port 127 are joined to each other in the blowing space 105, and pass through the front ends 112 and 122 to flow forward.

In addition, the air behind the blowing space 105 may be guided into the blowing space 105 and then flow forward.

Also, the air around the first tower 110 may flow forward along the first outer wall 114, and the air around the second tower 120 may flow forward along the second outer wall 124.

Since the first discharge port 117 and the second discharge port 127 are formed to be elongated in the up-down direction and are disposed symmetrically right and left, the air flowing to the upper side of the first discharge port 117 and the second discharge port 127 and the air flowing from the lower side thereof may be formed more uniformly.

In addition, the air discharged from the first discharge port and the second discharge port merge in the blowing space 105, and thus, straightness of the discharged air is improved and the air can flow to a farther place.

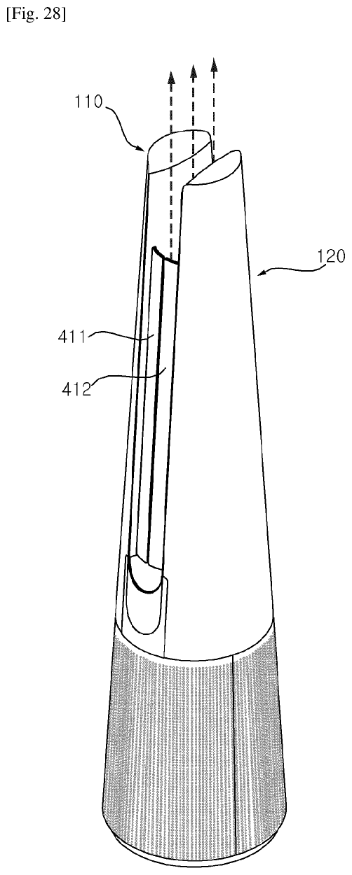

FIG. 28 is an exemplary diagram illustrating the ascending airflow of the air conditioner according to the first embodiment of the present disclosure.

Referring to FIG. 28, when the ascending airflow is provided, the first space board 411 and the second space board 412 protrude to the blowing space 105 and block the front of the blowing space 105.

As the front of the blowing space 105 is blocked by the first space board 411 and the second space board 412, the air discharged from the discharge ports 117 and 127 ascends along the rear surfaces of the first space board 411 and the second space board 412 and is discharged to the top of the blowing space 105.

By forming the ascending airflow in the air conditioner 1, it is possible to prevent the discharged air from flowing directly to the user. In addition, when circulating indoor air, the air conditioner 1 can be operated as the ascending airflow.

For example, when an air conditioner and an air conditioner are used at the same time, the convection of indoor air can be promoted by operating the air conditioner 1 as the ascending airflow, and indoor air can be cooled or heated more quickly.

Hereinafter, the fan 320 for air conditioner for reducing the noise and sharpness of the noise will be described in detail.

Referring to FIG. 29, the fan 320 of the present disclosure includes a hub 328 which is connected to the rotation axis Ax, a plurality of blades 325 which are installed at a predetermined interval on the outer peripheral surface of the hub 328, and a shroud 32 which is spaced apart from the hub 328 to surround the hub 328 and connected to one end of each of the plurality of blades 325.

The fan 320 may further include a back plate 324 provided with the hub 328 for coupling the rotation center axis. Depending on an embodiment, the back plate 324 and the shroud 32 may be omitted. The hub 328 has a cylindrical shape of which an outer peripheral surface is parallel to the rotation axis Ax.

The plurality of blades 325 extending from the back plate 324 may be provided. The blade 325 may extend so that an outline of the blade 325 is curved.

The blade 325 constitutes a rotating blade of the fan 320 and performs a function of transferring kinetic energy of the fan 320 to a fluid. The plurality of blades 325 may be provided at predetermined intervals, and may be disposed in a radial shape on the back plate 324. One end of each of the plurality of blades 325 is connected to the outer peripheral surface of the hub 328.

In addition, the shroud 32 is connected (coupled) to one end of the blade 325. The shroud 32 is formed in a position opposite to the back plate 324 and may be formed in a circular ring shape. The shroud 32 and the hub 328 share the rotation axis Ax as the center.

The shroud 32 has a suction end portion 321 into which a fluid is introduced and a discharge end portion 323 through which the fluid is discharged. The shroud 32 may be formed to be curved so that a diameter thereof decreases from the discharge end portion 323 toward the suction end portion 321.

That is, the fan 32 may include a connection portion 322 connecting the suction end portion 321 and the discharge end portion 323 in a curved manner. The connection portion may be rounded to have a curvature so that an inner cross-sectional area of the shroud 32 is widened.

The shroud 32 may form a movement passage of a fluid together with the back plate 324 and the blade 325. In a moving direction of the fluid, it can be seen that the fluid introduced in a direction of the central axis flows in the circumferential direction of the fan 320 by the rotation of the blade 325.

That is, the fan 320 may discharge the fluid in the radial direction of the fan 320 by increasing the flow velocity by centrifugal force.

The shroud 32 coupled to the end portion of the blade 325 may be formed to be spaced apart from the back plate 324 by a predetermined interval. The shroud 32 is provided to have a surface facing parallel to the back plate 324.

Hereinafter, the blade 325 and a notch 40 formed in the blade 325 will be described in detail.

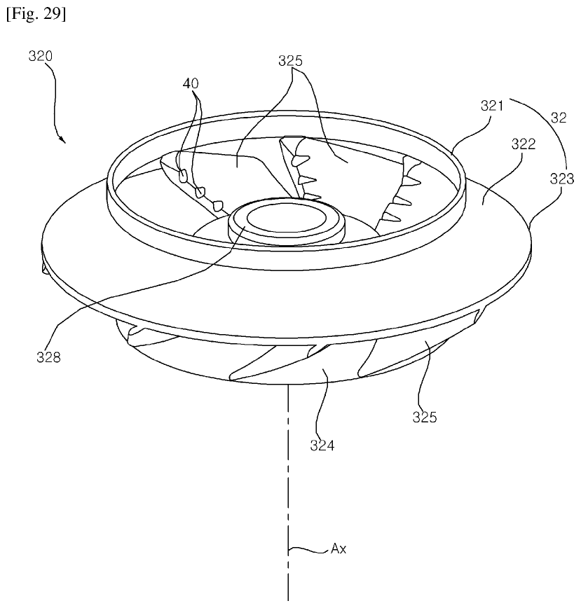

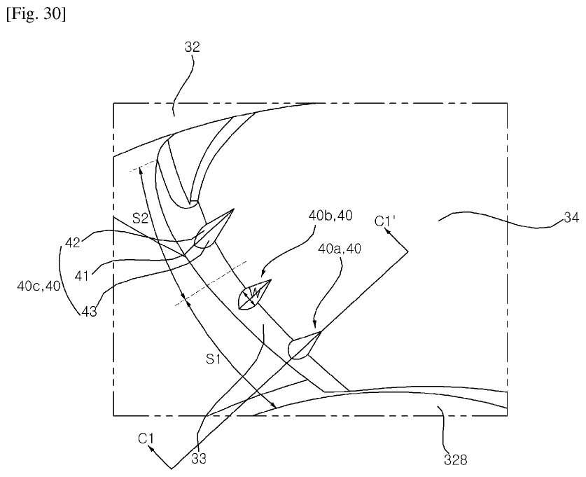

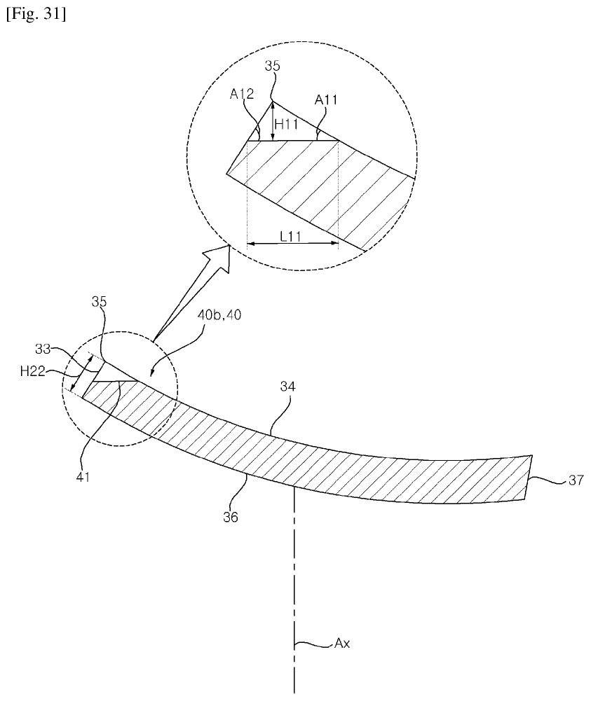

Referring to FIGS. 30 and 31, each blade 325 includes a leading edge 33 which defines one surface in a direction in which the hub 328 is rotated, a trailing edge which defines one surface in a direction opposite to the leading edge 33, a negative pressure surface 34 which connects an upper end of the edge 37 and an upper end of the leading edge 33 to each other and has an area larger than those of the leading edge 33 and the trailing edge 37, and a pressure surface 36 which connects a lower end of the leading edge 33 and a lower end of the trailing edge 37 to each other and faces the negative pressure surface 34.

That is, in each blade 325, the plate-shaped negative pressure surface 34 and pressure surface 36 define a widest upper and lower surfaces, respectively, both ends in the length direction form both side surfaces of the blade 325, and both ends in a width direction (right-left direction in FIG. 31) intersecting the length direction form the leading edge 33 and the trailing edge 37. Areas of the trailing edge 37 and the leading edge 33 is smaller than those of the negative pressure surface 34 and the pressure surface 36.

The leading edge 33 is located above the trailing edge 37 (based on FIG. 31).

Each blade 325 include a plurality of notches 40 to reduce the noise generated from the fan and the sharpness of the noise.

Each notch 40 may be formed over a portion of the leading edge 33 and a portion of the negative pressure surface 34. In addition, a corner 35 where the leading edge 33 and the negative pressure surface 34 meet is recessed in a downward direction, and thus, the notch 40 may be formed. That is, each notch 40 is formed over the intermediate portion and the upper end portion of the leading edge 33 and a partial region adjacent to the leading edge 33 on the negative pressure surface 34.

The cross-sectional shape of the notch 40 is not limited and may have various shapes.

However, preferably, the cross-sectional shape of the notch 40 has a U shape or a V shape in order to increase the efficiency of the fan and reduce the noise of the fan. The shape of the notch 40 will be described later.

A width W of the notch 40 may be expanded from the bottom to the top. The width

W of the notch 40 may be gradually expanded or stepwise toward the top.

A direction of the notch 40 may be a tangential direction of an arbitrary circumference centered on the rotation axis Ax. Here, the direction of the notch 40 means the direction of the length L11 of the notch 40. That is, the same cross-sectional shape of the notch 40 extends in the tangential direction of the circumference.

The notch 40 may be formed along an arc of an arbitrary circumference centered on the rotation axis Ax of the fan 320. That is, the notch 40 may have a curved shape. Specifically, the same cross-sectional shape of the notch 40 is formed along the circumference.

A depth H11 of the notch 40 may decrease as it is far away from a point where the leading edge 33 and the negative pressure surface 34 meet. The depth H11 of the notch 40 is high at the center and decreases toward both ends in the length direction.

Hereinafter, the shape of each notch 40 will be described in detail. In the present embodiment, the cross-sectional shape of the notch 40 is a V shape.

Specifically, the notch 40 may include a first inclined surface 42, a second inclined surface 43 which faces the first inclined surface 42 and is connected to a lower end of the first inclined surface 42, and a bottom line 41 which is defined to be connected to the first inclined surface 42 and the second inclined surface 43.

A separation distance between the first inclined surface 42 and the second inclined surface 43 may increase as it goes upward. The separation distance between the first inclined surface 42 and the second inclined surface 43 may increase gradually or stepwise. Each of the first inclined surface 42 and the second inclined surface 43 may be flat or curved. Each of the first inclined surface 42 and the second inclined surface 43 may have a triangular shape.

The bottom line 41 may extend in a tangential direction of an arbitrary circumference centered on the rotation axis Ax. As another example, the bottom line 41 may extend along an arbitrary circumference centered on the rotation axis Ax. That is, the bottom line 41 may form an arc centered on the rotation axis Ax.

The bottom line 41 is the same as a length L11 of the notch 40. The direction of the bottom line 41 means the direction of the notch 40. The direction of the bottom line 41 may be a direction for reducing flow separation occurring in the leading edge 33 and the negative pressure surface 34 and reducing air resistance.

Specifically, the bottom line 41 may have an inclination of 0 degrees to 10 with respect to a horizontal plane perpendicular to the rotation axis Ax. Preferably, the bottom line 41 may be parallel to a horizontal plane perpendicular to the rotation axis Ax. Therefore, it is possible to reduce the resistance by the notch 40 while the blade 325 rotates.

The length L11 of the bottom line 41 may be longer than a height H22 of the leading edge 33. If the length L11 of the bottom line 41 is too short, the flow separation occurring on the negative pressure surface 34 cannot be reduced, and if the length L11 of the bottom line 41 is too long, the efficiency of the fan decreases.

The length L11 (the length L11 of the bottom line 41) of the notch 40 may be greater than the depth H11 of the notch 40 and the width W of the notch 40. Preferably, the length L11 of the notch 40 may be 5 mm to 6.5 mm, the depth H11 of the notch 40 may be 1.5 mm to 2.0 mm, and the width W of the notch 40 may be 2.0 mm to 2.2 mm.

The length L11 of the notch 40 is 2.5 to 4.33 times the depth H11 of the notch 40, and the length L11 of the notch 40 is 2.272 times to 3.25 times the width W of the notch 40.

One end of the bottom line 41 is located on the leading edge 33 and the other end of the bottom line 41 is located on the negative pressure surface 34. Preferably, a position of a point where one end of the bottom line 41 is located at the leading edge 33 is an intermediate height of the leading edge 33.

A separation distance between the corner 35 and the point where the one end of the bottom line 41 is located at the leading edge 33 may be smaller than a separation distance between the point where the other end of the bottom line 41 is located on the negative pressure surface 34 and the corner 35.

Preferably, a position of a point where the other end of the bottom line 41 is located on the negative pressure surface 34 is between ⅕ points and 1/10 points in the width of the negative pressure surface 34.

An angle A11 formed by the bottom line 41 and the negative pressure surface 34 and an angle A12 formed by the bottom line 41 and the leading edge 33 are not limited. Preferably, the angle A11 formed by the bottom line 41 and the negative pressure surface 34 is smaller than the angle A12 formed by the bottom line 41 and the leading edge 33.

Preferably, three notches 40 are provided. The notch 40 may include a first notch 40, a second notch 40 which is located further away from the hub 328 than the first notch 40, and a third notch 40 which is located further away from the second notch 40. Preferably, a separation distance between the notches 40 is 6 mm to 10 mm. The separation distance between the notches 40 may be larger than the depth H11 of the notch 40 and the width W of the notch 40.

The leading edge 33 is divided into a first region S1 adjacent to the hub 328 and a second region S2 adjacent to the shroud 32, and two of the three notches 40 may be located in the first area S1, and the remaining notch 40 may be located in the second area S2.

Specifically, the first notch 40 and the second notch 40 may be located in the first region S1, and the third notch 40 may be located in the second region S2. More specifically, the separation distance at the hub 328 of the first notch 40 may be 19% to 23% of the length of the leading edge 33, and the separation distance at the hub 328 of the second notch 40 may be 40% to 44% of the length of the leading edge 33, and the separation distance at the hub 328 of the first notch 40 may be 65% to 69% of the length of the leading edge 33.

Of the plurality of notches 40, the notch 40 spaced farthest from the hub 328 may have the longest length. Specifically, the length L11 of the third notch 40 may be greater than the length L11 of the second notch 40, and the length L11 of the second notch 40 may be greater than the length L11 of the first notch 40.

According to the shapes, disposition, and number of the notches 40, it is possible to reduce the flow separation occurring in the blades 325 of the fan, and consequently, it is possible to reduce the noise caused by the fan.

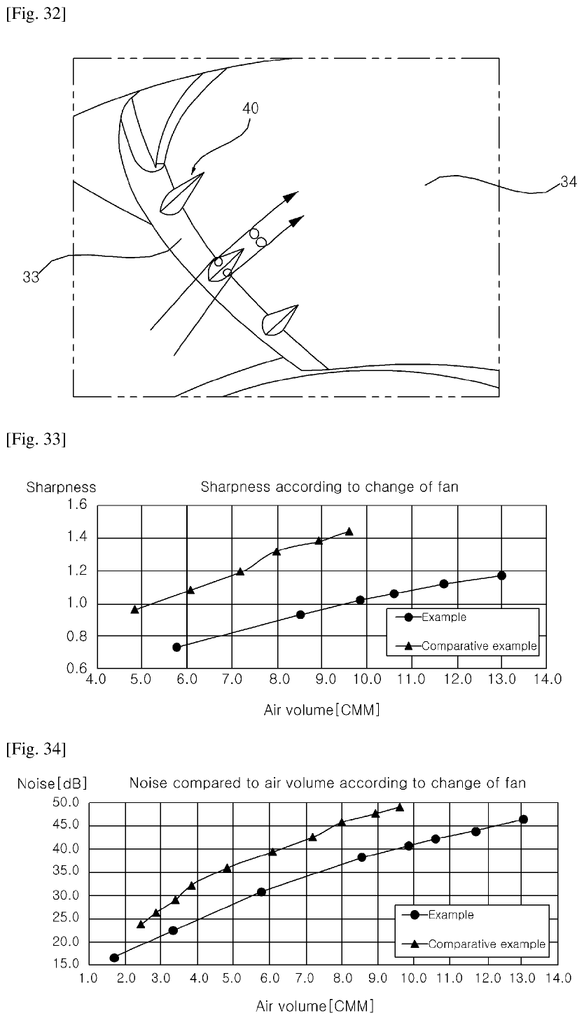

Referring to FIG. 32, in some fluid passing through the leading edge 33, the flow of the fluid passing through the notch 40 causes a turbulence and flows along the blade surface and are mixed with the fluid passing through the leading edge 33. Accordingly, the fluid flows along the surface in a state where the flow separation does not occur on the surface of the blade, and thus, the reduction in noise is improved.

Referring to FIGS. 33 and 34, it can be seen that the noise and sharpness are significantly reduced in the embodiment when the noise and sharpness of a general fan (comparative example) and the embodiment are tested in the same environment.

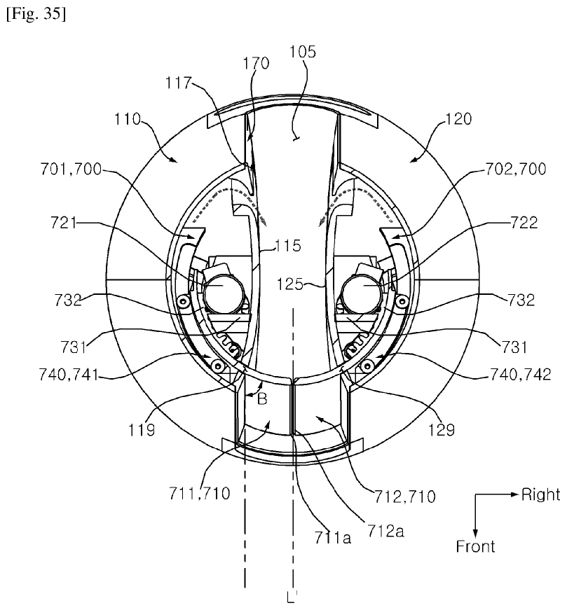

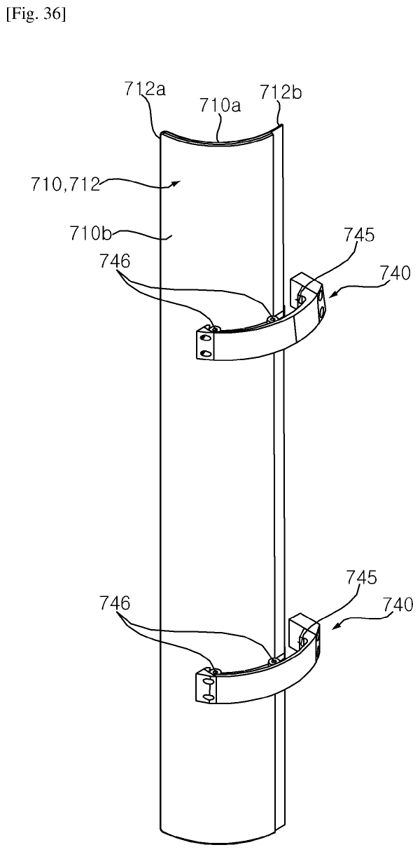

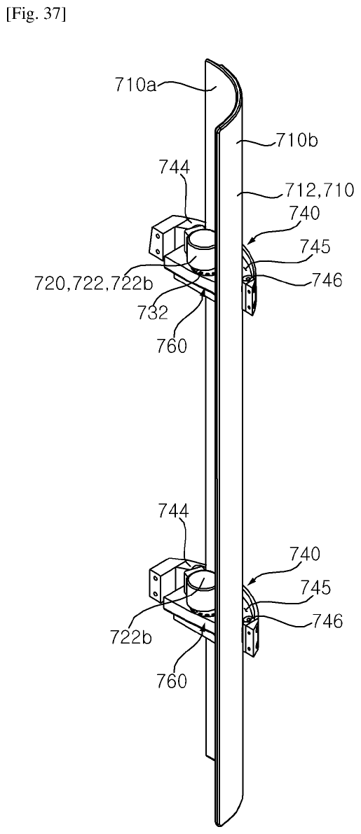

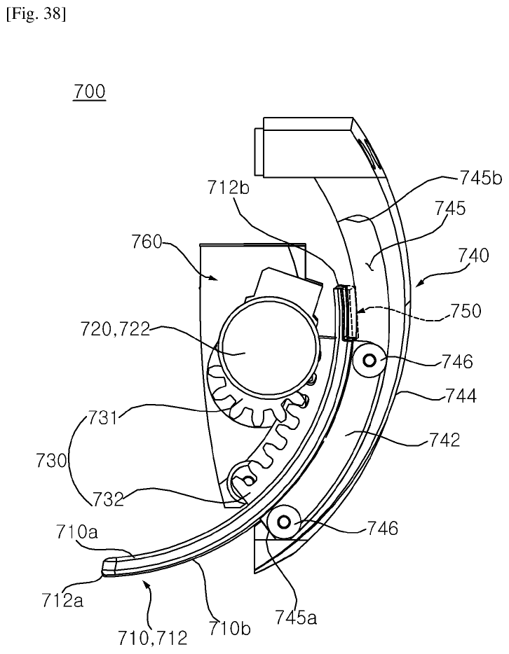

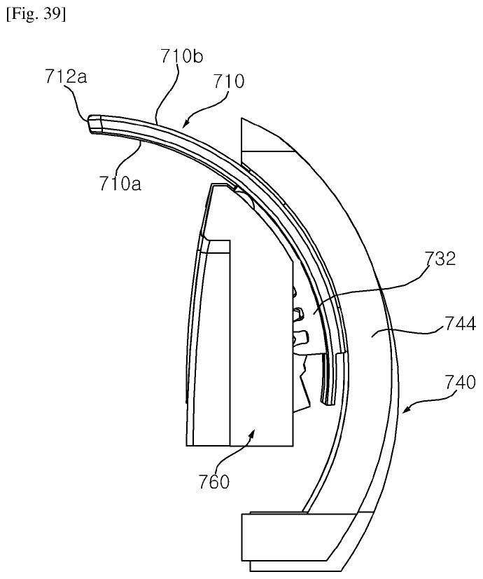

An airflow converter 700 of another embodiment capable of forming the ascending airflow will be described with reference to FIGS. 35 to 39. In the present embodiment, the airflow converter 700 is mainly described in terms of differences from the embodiments of FIGS. 16 to 22, and configurations without special description are regarded as the same as those of the embodiment of FIGS. 16 to 22.

In the present embodiment, the airflow converter 700 may convert the horizontal airflow flowing through the blowing space 105 into the ascending airflow.

The airflow converter 700 includes a first airflow converter 701 disposed in the first tower 110 and a second airflow converter 702 disposed in the second tower 120. The first airflow converter 701 and the second airflow converter 702 are symmetrical right and left and have the same configuration as each other.

The airflow converter 700 includes a guide board 710 which is disposed in the tower and protrudes to the blowing space 105, a guide motor 720 which provides a driving force to move the guide board 710, a power transmission member 730 which provides the driving force of the guide motor 720 to the guide board 710, and a board guide 740 which is disposed inside the tower to guide the movement of the guide board 710.

The guide board 710 may be concealed inside the tower, and may protrude to the blowing space 105 when the guide motor 720 is operated. The guide board 710 includes a first guide board 711 disposed in the first tower 110 and a second guide board 712 disposed in the second tower 120.

In the present embodiment, the first guide board 711 is disposed inside the first tower 110 and may selectively protrude to the blowing space 105. Similarly, the second guide board 712 is disposed inside the second tower 120 and may selectively protrude to the blowing space 105.

To this end, a board slit 119 penetrating through the inner wall 115 of the first tower 110 is formed, and a board slit 129 penetrating through the inner wall 125 of the second tower 120 is formed, respectively.

The board slit 119 formed in the first tower 110 is referred to as a first board slit 119, and the board slit formed in the second tower 120 is referred to as a second board slit 129.

The first board slot 119 and the second board slits 129 are disposed symmetrically right and left. The first board slot 119 and the second board slits 129 are formed to be elongated in the up-down direction. The first board slot 119 and the second board slits 129 may be disposed to be inclined with respect to the vertical direction V.

An inner end 711a of the first guide board 711 may be exposed to the first board slit 119, and an inner end 712a of the second guide board 712 may be exposed to the second board slit 129.

Preferably, the inner ends 711a and 712a do not protrude from the inner walls 115 and 125. When the inner ends 711a and 712a protrude from the inner walls 115 and 125, an additional Coanda effect may be induced.

When the vertical direction is 0, the front end 112 of the first tower 110 is formed at a first inclination, and a first board slit 119 is formed at a second inclination. The front end 122 of the second tower 120 is also formed at a first inclination, and the second board slit 129 is formed at a second inclination.

The first inclination may be formed between the vertical direction and the second inclination, and the second inclination should be larger than the horizontal direction. The first inclination and the second inclination may be the same as each other, or the second inclination may be greater than the first inclination.

Based on the vertical direction, the boards slit 119 and 129 may be disposed to be more inclined than the front end 112 and 122.

The first guide board 711 is disposed parallel to the first board slit 119, and the second guide board 712 is disposed parallel to the second board slit 129.

The guide board 710 may be formed in a flat or curved plate shape. The guide board 710 may be formed to extend long in an up-down direction, and may be disposed in front of the blowing space 105.

The guide board 710 may block the horizontal airflow flowing into the blowing space 105 and can convert the direction of the airflow to upward.

In the present embodiment, the inner end 711a of the first guide board 711 and the inner end 712a of the second guide board 712 may abut on each other or close to each other to form the ascending airflow. Unlike the present embodiment, one guide board 710 may be in close contact with the opposite tower to form the ascending airflow.

When the airflow converter 700 is not operated, the inner end 711a of the first guide board 711 may close the first board slit 119, and the inner end 712a of the second guide board 712 may close the second board slit 129.

When the airflow converter 700 is operated, the inner end 711a of the first guide board 711 may pass through the first board slit 119 and protrude to the blowing space 105, and the inner end 712a of the second guide board 712 may penetrate through the second board slit 129 and protrude to the blowing space 105.

Since the first guide board 711 closes the first board slit 119, leakage of air in the first discharge space 103a can be prevented. Since the second guide board 712 closes the second board slit 129, leakage of air in the second discharge space 103b can be prevented.

In the present embodiment, the first guide board 711 and the second guide board 712 are rotated so as to protrude to the blowing space 105. Unlike the present embodiment, at least one of the first guide board 711 and the second guide board 712 may be linearly moved in a slide manner to protrude to the blowing space 105.

When viewed from a top view, each of the first guide board 711 and the second guide board 712 is formed in an arc shape. Each of the first guide board 711 and the second guide board 712 forms a predetermined curvature radius, and a center of the curvature is located in the blowing space 105.

When the guide board 710 is concealed inside the tower, preferably, a volume inside the guide board 710 in a radial direction is larger than a volume outside the guide board 710 the radial direction.

The guide board 710 may be formed of a transparent material. A light-emitting member 750 such as an LED may be disposed in the guide board 710, and the entire guide board 710 may emit light through light generated from the light-emitting member 750. The light-emitting member 750 may be disposed in the discharge space 103 inside the tower, and may be disposed on the outer end 712b of the guide board 710.

A plurality of light-emitting members 750 may be disposed along the length direction of the guide board 710.

The guide motor 720 includes a first guide motor 721 which provides a rotational force to the first guide board 711 and a second guide motor 722 which provides a rotational force to the second guide board 712.

The first guide motor 721 may be disposed on an upper side and a lower side in the first tower, respectively, and if it is necessary to distinguish the first guide motor, the first guide motor may be divided into an upper first guide motor 721 and a lower first guide motor 721. The upper first guide motor is disposed lower than the upper end 111 of the first tower 110, and the lower first guide motor is disposed higher than the fan 320.

The second guide motor 722 may also be disposed on an upper side and a lower side in the second tower, and if it is necessary to distinguish the second guide motor 722, the second guide motor 722 may be divided into an upper second guide motor 722a and a lower second guide motor 722b. The upper second guide motor is disposed lower than the upper end 121 of the second tower 120, and the lower second guide motor is disposed higher than the fan 320.

In the present embodiment, the rotation shafts of the first guide motor 721 and the second guide motor 722 are disposed in the vertical direction, and a rack-pinion structure is used to transmit the driving force. The power transmission member 730 includes a driving gear 731 coupled to a motor shaft of the guide motor 720 and a rack 732 coupled to the guide board 710.

The driving gear 731 is a pinion gear and is rotated in the horizontal direction. The rack 732 is coupled to the inner surface of the guide board 710. The rack 732 may be formed in a shape corresponding to the guide board 710. In the present embodiment, the rack 732 is formed in an arc shape. The teeth of the rack 732 are disposed toward the inner wall of the tower.

The rack 732 is disposed in the discharge space 103 and may be turned together with the guide board 710.

The board guider 740 may guide the turning motion of the guide board 710. The board guider 740 may support the guide board 710 when the guide board 710 is turned.

In the present embodiment, the board guider 740 is disposed on the opposite side of the rack 732 based on the guide board 710. The board guider 740 may support a force applied from the rack 732. Unlike the present embodiment, a groove corresponding to a turning radius of the guide board may be formed in the board guide 740, and the guide board may be moved along the groove.

The board guider 740 may be assembled to the outer walls 114 and 124 of the tower.

The board guider 740 may be disposed outside the guide board 710 in the radial direction, and thus, it is possible to minimize a contact with air flowing through the discharge space 103.

The board guider 740 includes a movement guider 742, a fixed guider 744, and a friction reduction member 746. The movement guide 742 may be coupled to a structure which moves together with the guide board. In the present embodiment, the movement guide 742 may be coupled to the rack 732 or the guide board 710, and may be rotated together with the rack 732 or the guide board 710.

In the present embodiment, the movement guide 742 is disposed on an outer surface 710b of the guide board 710. When viewed from the top view, the movement guide 742 is formed in an arc shape, and is formed to have the same curvature as the guide board 710.

A length of the movement guide 742 is shorter than a length of the guide board 710.

The movement guide 742 is disposed between the guide board 710 and the fixed guide 744. A radius of the movement guide 742 is larger than the radius of the guide board 710 and smaller than the radius of the fixed guide 744.

When the movement guider 742 moves, the movement may be restricted due to mutual engagement with the fixed guider 744. The fixed guide 744 is disposed radially outward from the movement guide 742 and may support the movement guide 742.

The fixed guide 744 is formed with a guide groove 745 into which the movement guide 742 is inserted and moved. The guide groove 745 is formed to correspond to a rotation radius and a curvature of the movement guide 742.

The guide groove 745 is formed in an arc shape, and at least a portion of the movement guide 742 is inserted into the guide groove 745. The guide groove 745 is formed to be concave in the downward direction. The movement guide 742 is inserted into the guide groove 745, and the guide groove 745 may support the movement guide 742.

When the movement guider 742 rotates, the movement guider 742 is supported by a front end 745a of the guide groove 745 to limit the rotation of the movement guider 742 in one direction (direction protruding into the blowing space).

When the movement guider 742 rotates, the movement guider 742 is supported by the rear end 745b of the guide groove 745 to limit the rotation of the movement guider 742 in the other direction (the direction to be stored inside the tower).

In addition, the friction reduction member 746 reduces a friction between the movement guider 742 and the fixed guider 744 when the movement guider 742 moves.

In the present embodiment, a roller is used as the friction reduction member 746, and rolling friction is provided between the movement guider 742 and the fixed guider 744. A shaft of the roller is formed in an up-down direction, and is coupled to the movement guide 742.

It is possible to reduce the friction and the operating noise by the friction reduction member 746. At least a portion of the friction reduction member 746 protrudes outward in the radial direction of the movement guide 742.

The friction reduction member 746 may be formed of an elastic material, and may be elastically supported by the fixed guide 744 in the radial direction.

That is, instead of the movement guide 742, the friction reduction member 746 elastically supports the fixed guide 744, and when the guide board 710 rotates, can reduce the friction and operating noise.

In the present embodiment, the friction reduction member 746 is in contact with the front end 745a and the rear end 745b of the guide groove 745.

Meanwhile, a motor mount 760 for supporting the guide motor 720 and fixing the guide motor 720 to the tower may be further disposed.

The motor mount 760 is disposed under the guide motor 720 and supports the guide motor 720. The guide motor 720 is assembled to the motor mount 760.

In the present embodiment, the motor mount 760 is coupled to the inner walls 114 and 125 of the tower. The motor mount 760 may be manufactured integrally with the inner walls 114 and 124.

<Another Example of Air Guide>

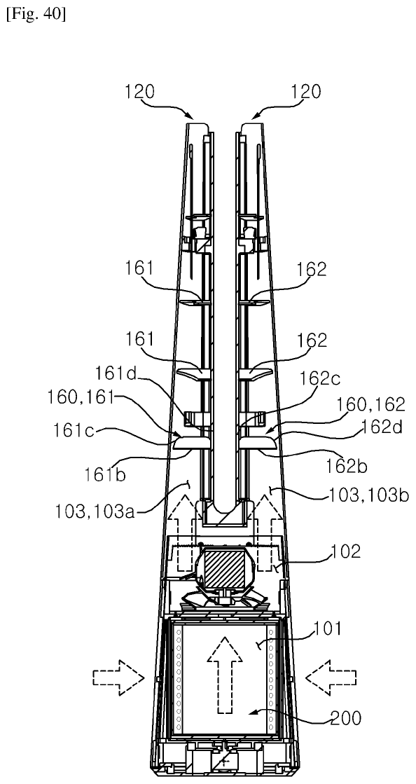

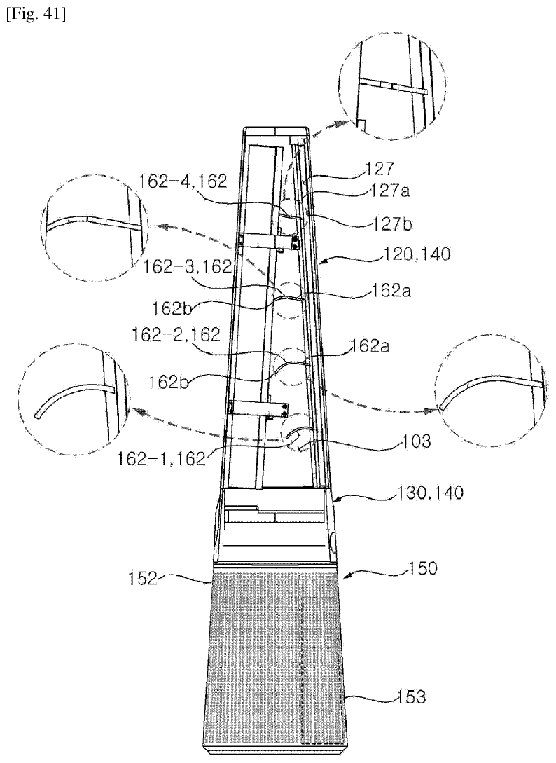

Referring to FIGS. 40 and 41, the air guide 160 for converting the flow direction of air into the horizontal direction is disposed in the discharge space 103. A plurality of air guides 160 may be disposed.

The air guide 160 converts the direction of the air flowing from the lower side to the upper side to a horizontal direction, and the converted air flows to the discharge ports 117 and 127.

When it is necessary to distinguish the air guides, the air guide located inside the first tower 110 is referred to as a first air guide 161, and the air guide located inside the second tower 120 is referred to as a second air guide 162.

A plurality of first air guides 161 are disposed, and the plurality of first air guides 161 are disposed in the up-down direction. A plurality of second air guides 162 are disposed, and the plurality of second air guides 162 are disposed in an up-down direction.

When viewed from the front, the first air guide 161 may be coupled to the inner wall and/or the outer wall of the first tower 110. When viewed from the side, a rear end 161a of the first air guide 161 is close to the first discharge port 117, and a front end 161b thereof is spaced apart from the front end of the first tower 110.

In order to guide the air flowing from the lower side to the first discharge port 117, at least one of the plurality of first air guides 161 may be formed in a curved surface convex from the lower side to the upper side.

At least one of the plurality of first air guides 161 may have the front end 161b disposed lower than the rear end 161a, and thus, it is possible guide the air to the first discharge port 117 while minimizing the resistance of the air flowing from the lower side.

At least a portion of a left end 161c of the first air guide 161 may be in close contact with or coupled to a left wall of the first tower 110. At least a portion of the right end 161d of the first air guide 161 may be in close contact with or coupled to a right wall of the first tower 110.

Accordingly, the air moving upward along the discharge space 103 flows from the front end of the first air guide 161 to the rear end thereof. The second air guide 162 is symmetrical left and right with respect to the first air guide 161.

When viewed from the front, the second air guide 162 may be coupled to the inner wall and/or the outer wall of the second tower 110. When viewed from the side, a rear end 162a of the second air guide 162 is close to the second discharge port 127, and a front end 162b thereof is spaced apart from the front end of the second tower 120.

In order to guide the air flowing from the lower side to the second discharge port 127, at least one of the plurality of second air guides 162 may be formed in a curved surface convex from the lower side to the upper side.

At least one of the plurality of second air guides 162 may have a front end 162b disposed lower than a rear end 162a, and thus, it is possible guide the air to the second discharge port 127 while minimizing the resistance of the air flowing from the lower side.

At least a portion of a left end 162c of the second air guide 162 may be in close contact with or coupled to the left wall of the second tower 120. At least a portion of the right end 162d of the second air guide 162 may be in close contact with or coupled to the right wall of the first tower 110.

In the present embodiment, four second air guides 162 are disposed, and are referred to as a 2-1 air guide 162-1, a 2-2 air guide 162-2, a 2-3 air guide 162-3, a 2-4 air guide 162-4 from the lower side to the upper side.

In the 2-1 air guide 162-1 and the 2-2 air guide 162-2, the front end 162b is disposed lower than the rear end 162a and guides the air toward the rear upper side.

Meanwhile, in the 2-3 air guide 162-3 and the 2-4 air guide 162-4, the rear end 162a is disposed lower than the front end 162b and guides the air toward the rear lower side.

The disposition of the air guides is to allow the discharged air to converge to the middle of the height of the blowing space 105, and thus, it is possible to increase a reach distance of the discharged air.

The 2-1 air guide 162-1 and the 2-2 air guide 162-2 are each formed in a curved surface convex upward, and the 2-1 air guide 162-1 disposed on the lower side is 2-2 may be formed to be more convex than the air guide (162-2).

The 2-3 air guide 162-3 disposed on the lower side of the 2-3 air guide 162-3 and the 2-4 air guide 162-4 is convex upward, but the 2-4 air guide 162-4 is formed in a flat plate shape.

The 2-2 air guide 162-2 disposed on the lower side forms a curved surface more convex than the 2-3 air guide 162-3. That is, the curved surfaces of the air guides may be gradually flattened from the lower side to the upper side.

The 2-4 air guide 162-4 disposed on the uppermost side has a rear end 162a lower than the front end 162b and has a flat shape. Since the configuration of the first air guides 161 is symmetrical to the configuration of the second air guides 162, detailed descriptions thereof are omitted.

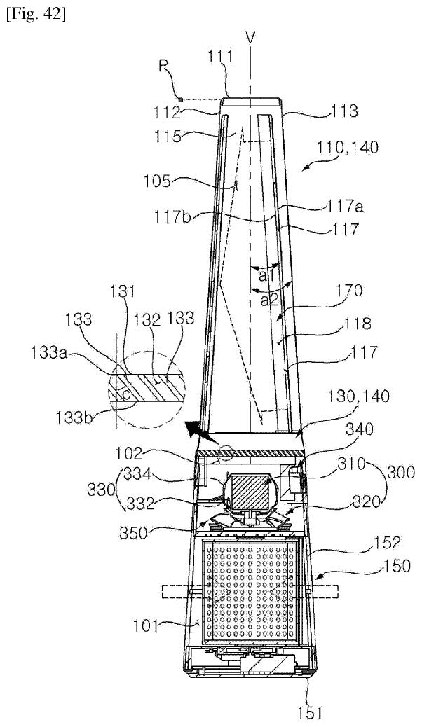

Referring to FIG. 42, FIG. 42 illustrates an air conditioner according to still another embodiment of the present disclosure.

Referring to FIG. 42, a third discharge port 132 penetrating the upper surface 131 of the tower base 130 in an up-down direction may be formed. A third air guide 133 for guiding filtered air is further disposed in the third discharge port 132.

The third air guide 133 is disposed to be inclined in the up-down direction. An upper end 133a of the third air guide 133 is disposed in the front, and a lower end 133b is disposed in the rear. That is, the upper end 133a is disposed in front of the lower end 133b.

The third air guide 133 includes a plurality of vanes disposed in a front-rear direction.

The third air guide 133 is disposed between the first tower 110 and the second tower 120, is disposed below the blowing space 105, and discharges the air toward the blowing space 105. The inclination of the third air guide 133 with respect to the vertical direction is defined as an air guide angle C.

The air conditioner according to the present disclosure has one or more of the following effects.

According to the present disclosure, by using the heater, it is possible to control the temperature of the air discharged through the discharge port to the desired temperature by the user and guide the air flowing in the case to the discharge port through the heat-radiating pin, and thus, a separate guide can be omitted within the case.

In addition, according to the present disclosure, since the plurality of heat-radiating pins are connected to two heat-radiating tubes, the heat-radiating pins are firmly fixed, and there is a strong resistance against external shock, heat and oxidation.

In addition, according to the present disclosure, since the plurality of heat-radiating pins are arranged in the length direction of the heat-radiating tube, the space occupied by the heater is small, and the heat transfer between the heat-radiating tube and the heat-radiating pin is excellent.

In addition, according to the present disclosure, it is possible to tightly couple the cover and the main body to each other without a gap, aesthetics of the user can be improved in a state where the cover and the main body are coupled to each other. Moreover, when the cover and the main body are separated from each other, an external force is applied to the cover separation unit so that the main body and the cover can be easily separated from each other.

In addition, according to the present disclosure, the air discharged from the first tower and the air discharged from the second tower induce the Coanda effect, and then, are joined to each other and discharged. Therefore, it is possible to increase the straightness and the reach distance of the discharged air.

Effects of the present disclosure are not limited to the effects mentioned above, and other effects not mentioned will be clearly understood by those skilled in the art from descriptions of claims.

<Heater Structure>

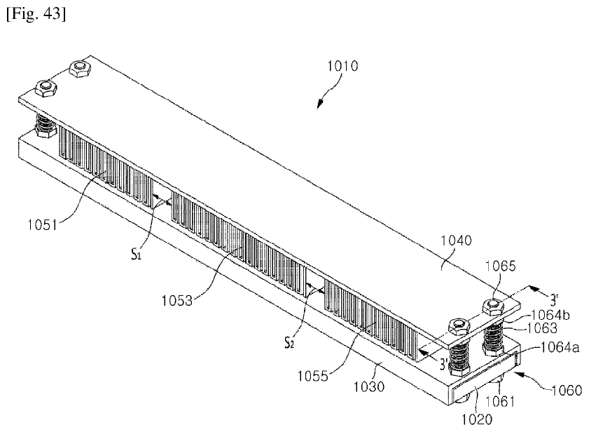

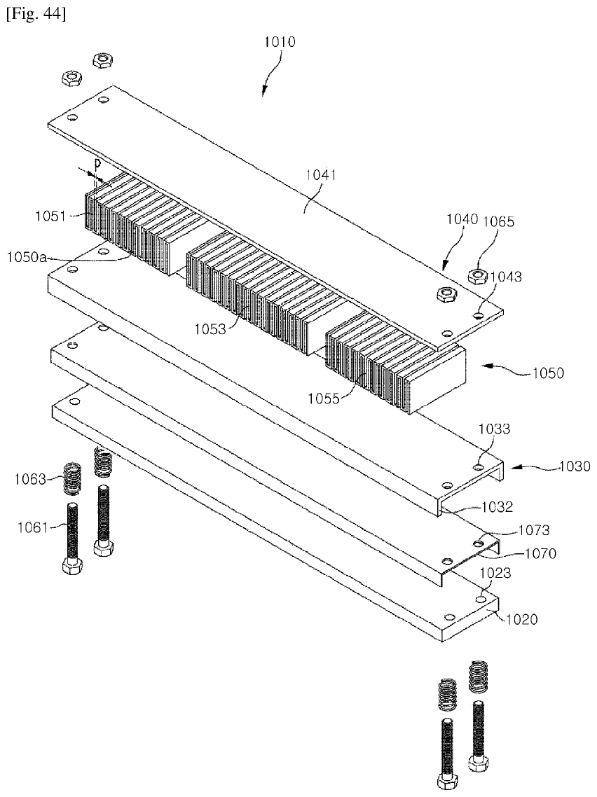

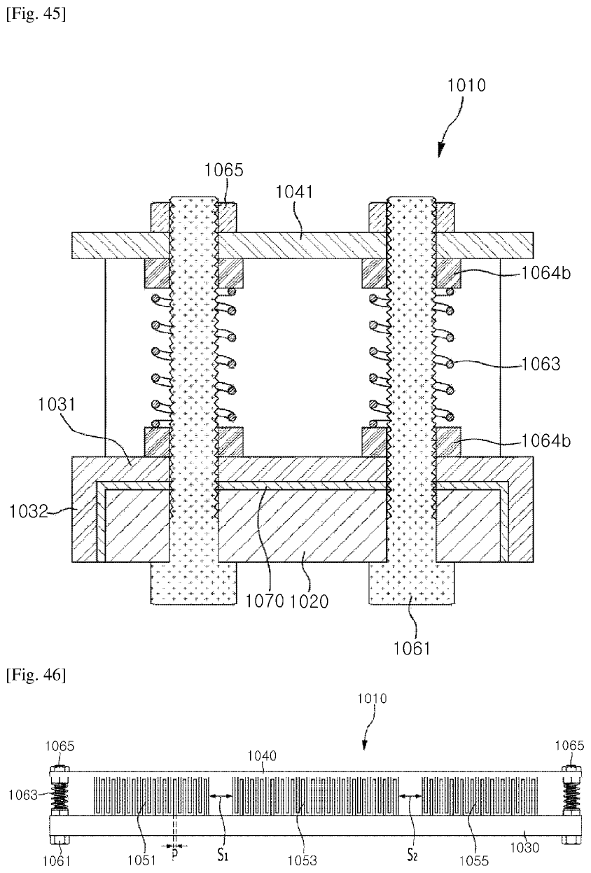

Referring to FIGS. 43 to 46, a heater assembly 1010 according to an embodiment of the present disclosure includes first and second heat-radiating plates 1030 and 1040 which are disposed spaced apart from each other, and a heating pin which is provide between the first and second heat-radiating plates 1030 and 1040.

The first heat-radiating plate 1030 may have an approximately quadrangular plate shape. Specifically, the first heat-radiating plate 1030 includes a first heat-radiating plate main body 1031 having a first coupling surface to which one end of the heating fin 1050 is coupled.

The first through hole 1033 through which the fastening member 1061 passes is formed in the first heat-radiating plate main body 1031. A plurality of first through holes 1033 may be formed, and the plurality of first through holes 1033 may be formed adjacent to four corners of the first heat-radiating plate main body 1031.

The first heat-radiating plate 1030 further includes two bent portions 1032 bent and extended from both side ends of the heat-radiating plate main body 1031. The first heat-radiating plate 1030 may have a shape of “i” by the heat-radiating plate main body 1031 and the tow bent portions 1032.

The second heat-radiating plate 1040 may have an approximately quadrangular plate shape. Specifically, the first heat-radiating plate 1040 includes a second heat-radiating plate main body 1041 having a second coupling surface to which the other end of the heating fin 1050 is coupled.

A second through hole 1043 to which the fastening member 1061 is coupled is formed in the second heat-radiating plate main body 1041. A plurality of second through holes 1043 may be formed, and the plurality of second through holes 1043 may be formed adjacent to four corner sides of the second heat-radiating plate main body 1041.

The heater assembly 1010 further includes a heating element 1020 coupled to the first and second heat-radiating plates 1030 and 1040. The heating element 1020 may be provided to be adhesively attached to the first heat-radiating plate 1030.

Specifically, the heating element 1020 may be disposed in the “i” shape of the first heat-radiating plate 1030, that is, a recessed space defined by the first heat-radiating plate main body 1031 and the bent portions 1032. The heating element 1020 may have a thin hexahedral shape.

For example, the heating element 1020 may be a planar heater. Compared with a PTC heater, the planar heater has a high heating rate and low thermal resistance, and thus, stability of the heater operation can be improved by improving electrical efficiency and constant supply of inrush current.

The heating element 1020 may include a heating resistor and an electrode connecting both ends of the heating resistor to each other. For example, the heating resistor may be configured to have a paste composition including silver and at least one selected from carbon nanotubes and carbon fibers.

As another example, the heating resistor may be configured to have a paste composition including at least one selected from carbon nanotubes and carbon fibers and silver, and further including at least one selected from ruthenium and palladium.

A heater hole 1023 to which the fastening member 1061 is coupled is formed in the heating element 1020. A plurality of heater holes 1023 may be formed, and the plurality of heater holes 1023 may be formed adjacent to four corners of the heating element 1020.

An adhesive portion 1070 may be provided between the heating element 1020 and the first heat-radiating plate 1030. That is, the heating element 1020 may be adhered to the first heat-radiating plate 1030 by the bonding portion 1070.

The adhesive part 1070 may be configured to remove a gap between the heating element 1020 and the first heat-radiating plate 1030 to increase a contact area, and improve heat conduction performance from the heating element 1020 toward the first heat-radiating plate 1030. For example, the adhesive part 1070 may be constituted by a grease (10 grease) or a thermally conductive adhesive (10 thermal bond).

The adhesive part 1070 is configured by applying the grease (10 grease) or a thermally conductive adhesive (10 thermal bond), and then by drying them, and is configured to have the shape of the surface in which the heating element 1020 and the first heat-radiating plate 1030 are in contact with each other, that is, the “=” shape.

The fastening member 1061 may pass through the heating element 1020 and the adhesive portion 1070 and may be inserted into the first heat-radiating plate 1030. Accordingly, an adhesion hole 1073 through which the fastening member 1061 passes may be formed in the adhesion portion 1070. A plurality of adhesion holes 1073 may be formed, and the plurality of adhesion holes 1073 may be formed adjacent to four corners of the adhesion portion 1070.

The heating fins 1050 are provided between the first and second heat-radiating plates 1030 and 1040, and a separation distance between the first and second heat-radiating plates 1030 and 1040 may correspond to a height of the heating fins 1050.

The heating pin 1050 may be composed of a wavy fin in which a thin pin is bent or curved a plurality of times to form a corrugated portion 1050a.

In the drawings, it is illustrated that the corrugated portion 1050a is constituted by repeating a portion bent in a “¬” shape in a zigzag shape. However, unlike this, the corrugated portion may be constituted by repeating a portion bent in a triangular shape in a zigzag shape, or a portion curved in a wavy shape in a zigzag shape.

The heating pin 1050 may be configured to include a plurality of corrugated pins. Specifically, the heating pin 1050 includes a first corrugated pin 1051 which has the plurality of corrugated portions 1050a, a second corrugated pin 1053 which is provided adjacent to one side of the first corrugated pin 1051 and has the plurality of corrugated portions 1050a, and a third corrugated pin 1055 which is provided adjacent to one side of the second corrugated pin 1053 and has the plurality of corrugated portions 1050a.

The corrugated portion 1050a provided in each of the first to third corrugated pins 1051, 1053, and 1055 may be configured to have a set pitch 10P. In addition, the first to third corrugated fins 1051, 1053, and 1055 may be disposed to be spaced apart from each other in a length direction (right-left direction based on FIG. 43) of the first and second heat-radiating plates 1030 and 1040.

For example, the first and second corrugated pins 1051 and 1053 may be disposed to be spaced apart by a first set distance S1, and the second and third corrugated pins 1053 and 1055 may be disposed to be spaced apart by a second set distance S2. The first set distance S1 or the second set distance S2 may be formed larger than the set pitch P. In addition, the first and second set distances S1 and S2 may be formed to have the same value.

Since the first to third corrugated pins 1051, 1053, and 1055 are disposed to be spaced apart from each other, it is possible to prevent a flow resistance of air from increasing when the air passes through the heater assembly 1010.

The heater assembly 1010 further includes a fastening device 1060 which couples the first and second heat-radiating plates 1030 and 1040, the heating pin 1050, and the heating element 1020 to each other. A coupling state of the heater assembly 1010 may be firmly maintained by the fastening device 1060.

The fastening device 1060 includes the fastening member 1061 coupled to the first and second heat-radiating plates 1030 and 1040 and the heating element 1020. The fastening member 1061 can be inserted into the first through hole 1033 of the first heat-radiating plate 1030, the second through hole 1043 of the second heat-radiating plate 1040, and the heater hole 1023 of the heating element 1020.

Specifically, the fastening member 1061 passes through the heater hole 1023 of the heating element 1020 and extends toward the first heat-radiating plate 1030 side, and passes through the first through hole 1033 of the first heat-radiating plate 1030 and extends toward the second heat-radiating plate 1040 side. In addition, the fastening member 1061 may be coupled to the second through hole 1043 of the second heat-radiating plate 1040.

Since the fastening member 1061 is provided at a position spaced apart from the outside of the heating pin 1050, when the fastening member 1061 is fastened to the first and second heat-radiating plates 1030 and 1040 and the heating element 1020, the fastening member 1061 may not interfere with the heating pin 1050. That is, an area of the first and second heat-radiating plates 1030 and 1040 or an area of the heating element 1020 may be larger than an area occupied by the heating fin 1050.

The fastening member 1061 may include a bolt or rivet.

When the fastening member 1061 is constituted by a bolt, threads may be formed in the through holes 1033 and 43 of the first and second heat-radiating plates 1030 and 1040 and the heater hole 1023 of the heating element 1020. In addition, the fastening device 1060 may further include a nut 1065 coupled to the bolt 1061. The nut 1065 may be provided in the second heat-radiating plate main body 1041 and fastened to the bolt 1061 which has passed the second through hole 1043.

The fastening device 1060 further includes a spring 1063 provided between the first and second heat-radiating plates 1030 and 1040. For example, the spring 1063 may be constituted by a tension coil spring.

The spring 1063 is provided to wind the outer peripheral surface of the bolt 1061.

That is, since the bolt 1061 is inserted into the spring 1063 to support the spring 1063, it is possible to prevent unwanted lateral deformation when the spring 1063 is deformed.

The fastening device 1060 further includes spring fixing portions 1064a and 1064b for fixing the spring 1063. The spring fixing portions 1064a and 1064b include a first fixing portion 1064a provided in the first heat-radiating plate 1030 and a second fixing portion 1064b provided in the second heat-radiating plate 1040.

The first fixing portion 1064a may be provided on a first coupling surface of the first heat-radiating plate main body 1031 and coupled to one end portion of the spring 1063. In addition, the second fixing portion 1064b may be provided on a second coupling surface of the second heat-radiating plate main body 1041 and coupled to the other end of the spring 1063.

An assembly process of the heater assembly 1010 using the fastening device 1060 will be described briefly.

The heating pin 1050 is disposed between the first and second heat-radiating plates 1030 and 1040, and both ends of the spring 1063 are fixed to the first and second fixing portions 1064a and 1064b. In this case, the first and second heat-radiating plates 1030 and 1040 are subjected to force in a direction close to each other by the restoring force of the spring 1063. Accordingly, the heating fins 1050 may be in close contact with the first and second heat-radiating plates 1030 and 1040.

The plurality of fastening members 1061 may pass through the first heat-radiating plate 1030 and the heating element 1020 and may be inserted into the second heat-radiating plate 1040 to be fastened. Further, the nut 1065 may be provided in the second heat-radiating plate 1040 and may be fastened to the fastening member 1071.

According to this assembly, components of the heater assembly 1010, that is, the first heat-radiating plate 1030 to which the hating element 1020 is coupled, the heating pin 1050, and the second heat-radiating plate 1040 are firmly fastened, and the coupled state of the components may be maintained by the fastening force of the fastening member 1061 and the restoring force of the spring 1063.

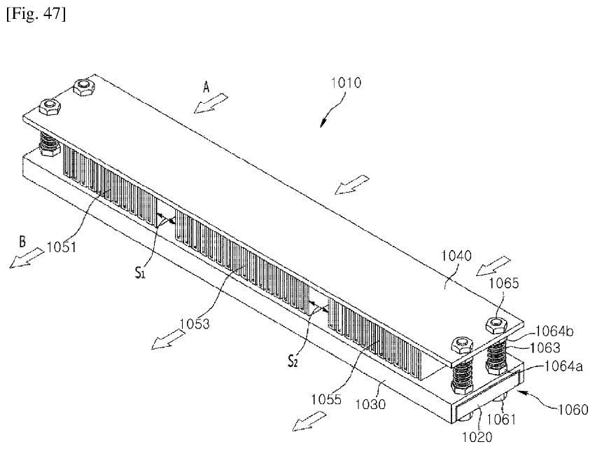

FIG. 47 is a perspective view illustrating a flow of air in the heater assembly according to the embodiment of the present disclosure.

Referring to FIG. 47, the heater assembly 1010 according to the embodiment of the present disclosure may be installed in a device for generating an air flow, for example, an air purifier.

Air may be introduced from one side (A, inlet side) of the heater assembly 1010 and heated, and then discharged to the other side (B, outlet side).

The heating pin 1050 may include a heat exchange surface extending in a direction in which air flows, and may be bent in a direction perpendicular to the flow direction of the air to form the plurality of corrugation portions 1050a. Air may flow through a space forming the pitch P between the plurality of corrugated portions 1050a and spaced spaces S1 and S2 between the first to third corrugated pins 1051, 1053, and 1055.

Therefore, it is possible to improve heat exchange performance while reducing the flow resistance of the flow.

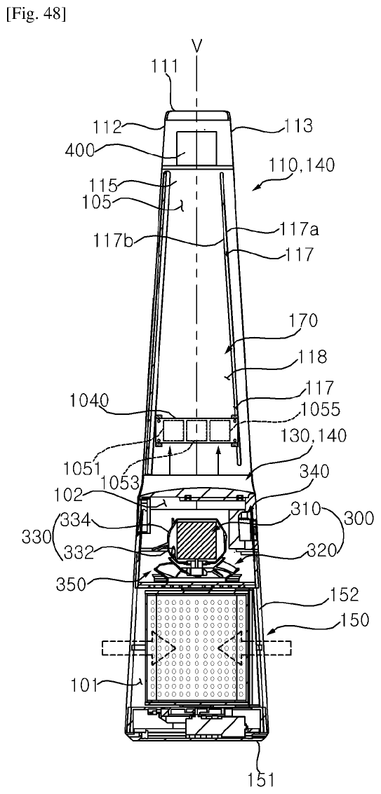

FIG. 48 is a view illustrating a configuration of an air purifier having the heater assembly according to the embodiment of the present disclosure.

The heater assembly 1010 may be provided inside the air conditioner.

The heater assembly 1010 is a component which is disposed in the first discharge space 103a or the second discharge space 103b to heat the flowing air. The heater assembly 1010 may be disposed in the first tower 110 or the second tower 120 of the air conditioner. The heater assembly 1010 may be disposed in the tower base 130.

The heater assembly 1010 may be disposed such that the inflow direction of the air faces downward and the discharge direction faces upward. In this case, a heat exchange surface of the heating pin 1050 extends in the up-down direction, and the plurality of corrugations 1050a may be formed to extend in the front-rear direction. Further, the first to third corrugated pins 1051, 1053, and 1055 spaced apart from each other may be aligned in the front-rear direction.

The air conditioner according to the present disclosure has one or more of the following effects.

According to the present disclosure, by using the heater, it is possible to control the temperature of the air discharged through the discharge port to the desired temperature by the user and guide the air flowing in the case to the discharge port through the heat-radiating pin, and thus, a separate guide can be omitted within the case.

In addition, according to the present disclosure, since the plurality of heat-radiating pins are connected to two heat-radiating tubes, the heat-radiating pins are firmly fixed, and there is a strong resistance against external shock, heat and oxidation.

In addition, according to the present disclosure, since the plurality of heat-radiating pins are arranged in the length direction of the heat-radiating tube, the space occupied by the heater is small, and the heat transfer between the heat-radiating tube and the heat-radiating pin is excellent.

Moreover, according to the present disclosure, it is possible to tightly couple the cover and the main body to each other without a gap, aesthetics of the user can be improved in a state where the cover and the main body are coupled to each other. Moreover, when the cover and the main body are separated from each other, an external force is applied to the cover separation unit so that the main body and the cover can be easily separated from each other.

In addition, according to the present disclosure, the air discharged from the first tower and the air discharged from the second tower induce the Coanda effect, and then, are joined to each other and discharged. Therefore, it is possible to increase the straightness and the reach distance of the discharged air.

By disposing the heat-radiating pin between the first and second heat-radiating plates, the heat-radiating pin is prevented from being exposed to the outside, and accordingly, a highly reliable heater assembly which is not deformed even by an external shock can be provided.

In addition, since the heat-radiating pin is constituted by a wavy fin forming a corrugated portion, it is easy to manufacture the heat-radiating pin and increase heat dissipation performance thereof.

A person skilled in the art to which the present disclosure belongs can understand that the present disclosure can be implemented in other concrete forms without changing a technical idea or essential features. Therefore, it should be understood that the embodiments described above are illustrative and non-limiting in all respects. A scope of the present disclosure is indicated by the scope of claims to be described later rather than the detailed description above, and the meaning and scope of the claims and any changes or modifications derived from the concept of equivalent should be interpreted as being included in the scope of the present disclosure.

1. An air conditioner comprising:
a base case configured to include a suction port through which air is sucked and accommodate a filter therein;
a tower case configured to be disposed above the base case and to include a discharge port through which the air sucked from the suction port is discharged; and
a heater configured to be disposed inside the tower case to heat the air, wherein the heater includes
a heat-radiating tube configured to include a first heat-radiating tube and a second heat-radiating tube disposed to be parallel to each other, and a third heat-radiating tube configured to connect one end of the first heat-radiating tube and one end of the second heat-radiating tube to each other, and
a plurality of heat-radiating pins configured to be coupled to the first heat-radiating tube and the second heat-radiating tube, and
the first heat-radiating tube extends in a first direction, and the heat-radiating pin forms a heat-radiating surface intersecting the first direction.

2. The air conditioner of claim 1, wherein the third heat-radiating tube has a curvature.

3. The air conditioner of claim 1, wherein the heat-radiating pin includes a first tube hole into which the first heat-radiating tube is inserted, and a second tube hole into which the second heat-radiating tube is inserted.

4. The air conditioner of claim 1, wherein the heat-radiating surface of the heat-radiating pin is a widest surface of the heat-radiating pin.

5. The air conditioner of claim 1, wherein the heat-radiating surface of the heat-radiating pin defines a surface perpendicular to the first direction.

6. The air conditioner of claim 1, wherein the heat-radiating pins are arranged to be spaced apart from each other in the first direction.

7. The air conditioner of claim 1, wherein a pitch of the plurality of heat-radiating pins is smaller than a separation distance between the first heat-radiating tube and the second heat-radiating tube.

8. The air conditioner of claim 1, wherein the discharge port extends in the first direction, and
the heat-radiating pin changes a direction of the sucked air to guide the air to the discharge port.

9. The air conditioner of claim 1, wherein a material of the heat-radiating pin and a material of the heat-radiating tube are different from each other.

10. The air conditioner of claim 1, wherein the heater further includes a top heat-radiating member coupled to the third heat-radiating tube.

11. The air conditioner of claim 10, wherein the top heat-radiating member includes a connector into which at least a portion of the third heat-radiating tube is inserted, and a plurality of top heat-radiating pins configured to be connected to the connector and to have a large surface area than that of the connector.

12. The air conditioner of claim 1, further comprising:
a protective cover configured to prevent a heater from coming into contact with an outside and causes air to flow to the heater.

13. The air conditioner of claim 12, wherein the protective cover is formed to be spaced from the heat-radiating pin to surround at least the heat-radiating pin, and includes a cover inlet into which air flows and a cover discharge port through which air inside the cover is discharged.

14. The air conditioner of claim 13, wherein a line connecting a center of the cover inlet and a center of the cover discharge port to each other extends in a direction intersecting the first direction.

15. The air conditioner of claim 12, wherein the protective cover includes a first protective cover which is formed of a heat-resistant material and a second protective cover which is disposed between the first protective cover and the heater and formed of an insulation material.

16. The air conditioner of claim 12, wherein the heater further includes a fastening plate to which the protective cover is coupled, and
the fastening plate is coupled to the first heat-radiating tube and the second heat-radiating tube.

17. The air conditioner of claim 16, wherein the fastening plate is coupled to the tower case.

18. The air conditioner of claim 1, wherein one end of the heat-radiating pin is disposed closer to the discharge port than the other end of the heat-radiating pin, and
the one end of the heat-radiating pin is located higher than the other end of the heat-radiating pin.

19. An air conditioner comprising:
a base case configured to include a suction port through which air is sucked and accommodate a filter therein;
a tower case configured to be disposed above the base case and to include a first tower and a second tower which each have an air flow path therein and are formed to be spaced apart from each other;
a blowing space configured to be formed between the first tower and a second tower;
a first discharge port configured to be formed in the first tower and to discharge the sucked air to the blowing space;
a second discharge port configured to be formed in the second tower and to discharge the sucked air to the blowing space; and
a heater configured to be disposed inside the tower case and to be disposed adjacent to at least one of the first discharge port and the second discharge port,
wherein the heater includes
a heat-radiating tube configured to include a first heat-radiating tube and a second heat-radiating tube disposed to be parallel to each other, and a third heat-radiating tube configured to connect one end of the first heat-radiating tube and one end of the second heat-radiating tube to each other, and
a plurality of heat-radiating pins configured to be coupled to the first heat-radiating tube and the second heat-radiating tube, and
the first heat-radiating tube extends in a first direction, and the plurality of heat-radiating pins form a heat-radiating surface intersecting the first direction.

20. An air conditioner comprising:
a base case configured to include a suction port through which air is sucked and accommodate a filter therein;
a tower case configured to be disposed above the base case and to include a first tower and a second tower which each have an air flow path therein and are formed to be spaced apart from each other;
a blowing space configured to be formed between the first tower and a second tower;
a first discharge port configured to be formed in the first tower and to discharge the sucked air to the blowing space;
a second discharge port configured to be formed in the second tower and to discharge the sucked air to the blowing space; and
a heater configured to be disposed inside the tower case and to be disposed adjacent to at least one of the first discharge port and the second discharge port,
wherein the heater includes
a heat-radiating tube configured to include a first heat-radiating tube and a second heat-radiating tube disposed to be parallel to each other, and a third heat-radiating tube configured to connect one end of the first heat-radiating tube and one end of the second heat-radiating tube to each other, and
a plurality of heat-radiating pins configured to be coupled to the first heat-radiating tube and the second heat-radiating tube, and
the first discharge port and the second discharge port extend in a first direction, and the heat-radiating pin has an inclination smaller than 45 with respect to a reference surface perpendicular to the first direction.
